(19) United States
(12) Patent Application Publication
(10) Pub. No.: US 2024/0192163 A1
(43) Pub. Date: Jun. 13, 2024

(54) SENSOR DEVICE WITH FUNCTIONALIZED FLUID CAVITY

(71) Applicant: TEXAS INSTRUMENTS INCORPORATED, Dallas, TX (US)

(72) Inventor: Sebastian MEIER, Muenchen (DE)

(21) Appl. No.: 18/517,365

(22) Filed: Nov. 22, 2023

Related U.S. Application Data
(60) Provisional application No. 63/432,349, filed on Dec. 13, 2022.

(51) Int. Cl. B01L 3/00; G01N 27/414

(52) U.S. Cl. CPC B01L 3/502715; G01N 27/4148; B01L 2200/12; B01L 2200/16; B01L 2300/0645; B01L 2300/0663; B01L 2300/161

(57) ABSTRACT

In examples, an integrated circuit comprises a semiconductor die including a semiconductor substrate, a dielectric layer on the semiconductor substrate, and a metallization structure in the dielectric layer, in which the semiconductor substrate includes sensor circuitry coupled to the metallization structure, the dielectric layer having a sensing side facing away from the semiconductor substrate. The IC includes an insulation layer on the sensing side and a sensor terminal on the sensing side and coupled to the metallization structure. The IC device includes a restriction structure including an opening, in which the restriction structure encapsulates a fluid cavity on the sensing side and the sensor terminal is in the fluid cavity. The fluid cavity contains a functionalization material, configured to interact with a fluid in the fluid cavity to produce a signal detectable by the sensor circuitry via the sensor terminal.

### CROSS-REFERENCE TO RELATED APPLICATIONS

The present application is related to U.S. patent application Ser. No. 18/066,206, which was filed Dec. 14, 2022, titled “INTEGRATED CIRCUIT FLUID SENSOR,” and the present application claims priority to U.S. Provisional Patent Application No. 63/432,349, which was filed Dec. 13, 2022, titled “MICROCAVITY FUNCTIONALIZATION,” all of which are hereby incorporated herein by reference in their entireties.

### BACKGROUND

A fluid sensor can detect properties of a fluid by generating an electrical signal representing the presence of a specific substance, such as ions, in the fluid. The electrical signal can indicate the presence and/or quantity of the substance in the fluid. Fluid sensors can have various applications. For example, a fluid sensor can detect the activity of acidic ions (e.g., hydrogen ions) in a fluid to support a pH measurement of the fluid. As another example, a fluid sensor can detect changes in the concentration of particular ionic species to support detection or monitoring of a chemical reaction. As another example, electrochemical fluid sensors can measure electrical potentials, currents, and impedance of a fluid. Fluid sensors can support various chemical and biomedical analyses, such as mass spectrometry, electrophoresis, deoxyribonucleic acid (DNA) analysis, etc.

### SUMMARY

In examples, an integrated circuit (IC) device comprises a semiconductor die including a semiconductor substrate, a dielectric layer on the semiconductor substrate, and a metallization structure in the dielectric layer, in which the semiconductor substrate includes sensor circuitry coupled to the metallization structure, the dielectric layer having a sensing side facing away from the semiconductor substrate. The IC device includes an insulation layer on the sensing side and a sensor terminal on the sensing side and coupled to the metallization structure. The IC device includes a restriction structure including an opening, in which the restriction structure is on the sensing side and encapsulates a fluid cavity on the sensing side, the sensor terminal is in the fluid cavity, and the restriction structure is configured to allow a fluid to enter the fluid cavity and reach the sensor terminal through the opening. The fluid cavity contains a functionalization material, the functionalization material configured to interact with the fluid to produce a signal, the sensor circuitry configured to detect the signal via the sensor terminal.

In examples, a method for manufacturing an integrated circuit (IC) device comprises providing an IC device. The IC device comprises a semiconductor die including a semiconductor substrate, a dielectric layer on the semiconductor substrate, and a metallization structure in the dielectric layer, in which the semiconductor substrate includes sensor circuitry coupled to the metallization structure, the dielectric layer having a sensing side facing away from the semiconductor substrate. The IC device also comprises an insulation layer on the sensing side and a sensor terminal on the sensing side and coupled to the metallization structure. The IC device also comprises a restriction structure including an opening, in which the restriction structure is on the sensing side and encapsulates a fluid cavity on the sensing side, the sensor terminal is in the fluid cavity, and the restriction structure is configured to allow a fluid to enter the fluid cavity and reach the sensor terminal through the opening. The method comprises forming a functionalization material in the fluid cavity, the functionalization material configured to interact with the fluid to produce a signal detectable by the sensor terminal.

### BRIEF DESCRIPTION OF THE DRAWINGS

FIG. 1 is a schematic of an example fluid analytic system.

FIG. 2A and FIG. 2B are schematics of an example fluid sensor.

FIG. 3A and FIG. 3B are schematics illustrating example interface circuits of a fluid sensor.

FIG. 4 is a schematic illustrating an example integrated circuit fluid sensor.

FIGS. 5A, 5B, 5C and 6 are schematics illustrating example mechanisms to provide fluid to the example fluid sensor of FIG. 4.

FIG. 7A and FIG. 7B include graphs representing example outputs of the fluid sensor of FIG. 4 in measuring a diffusion time.

FIG. 8 is a schematic illustrating a plan view of an example integrated circuit fluid sensor that supports diffusion time measurement of different fluids.

FIG. 9 includes graphs representing example outputs of the fluid sensor of FIG. 8.

FIG. 10 is a schematic illustrating an example fluid sensor including a reference electrode.

FIG. 11 is a schematic illustrating an example fluid sensor including an integrated electrode in a fluidic structure.

FIG. 12 is a schematic illustrating an example fluid sensor including an integrated electrode external to a fluidic structure.

FIG. 13 is a schematic illustrating an example fluid sensor to support differential sensing.

FIGS. 14A, 14B, and 14C are schematics illustrating example operations of the fluid sensor of FIG. 13 in performing differential sensing.

FIG. 15 includes graphs representing example outputs of the fluid sensor of FIG. 13.

FIGS. 16 and 17 are schematics illustrating example integrated circuit fluid sensors.

FIGS. 18A, 18B, 19A, and 19B are schematics illustrating example integrated circuit fluid sensors having a reservoir.

FIGS. 20A, 20B, and 20C are schematics illustrating example operations of the fluid sensor of FIG. 18.

FIG. 21 is a schematic illustrating an example fluid sensor including multiple sensor terminals in a fluid cavity.

FIG. 22 includes graphs representing example outputs of the fluid sensor of FIG. 21.

FIGS. 23 and 24 are schematics illustrating example fluid sensors including multiple sensor terminals in a fluid cavity.

FIGS. 25, 26A, 26B, 26C, 27, and 28 are schematics illustrating techniques to selectively restrict the flow of particles in a fluid cavity.

FIGS. 29, 30, 31A, 31B 31C, 31D, 31E, 31F, and 32 are schematics illustrating example fluid sensors including multiple openings extending to a fluid cavity.

FIGS. 33A, 33B, 33C, and 34 are schematics of a fluid sensor including a valve.

FIGS. 35, 36, 37, 38, 39, and 40 are schematics illustrating example valves that can be part of the fluid sensor of FIGS. 33 and 34 and their operations.

FIG. 41 is a schematic of an example fluid sensor configured as a mixer.

FIGS. 42A, 42B, and 42C are schematics illustrating example operations of fluid sensor of FIG. 41.

FIGS. 43A, 43B, 43C, 43D, 43E, and 43F are schematics of an example fluid sensor configured as a mixer.

FIG. 44 includes schematics of example fluid sensors to measure liquid junction potential.

FIGS. 45A and 45B are schematics of example fluid sensors to reduce liquid junction potentials in the fluid measurement.

FIGS. 46A and 46B are schematics of example fluid sensors configured as liquid junction battery.

FIGS. 47, 48A, 48B, 48C, 48D, 48E, 48F, 49A, 49B, 49C, 49D, and 49E illustrate example methods of fabricating an integrated circuit fluid sensor.

FIG. 50 is a flow diagram depicting an example process for sensing substances in functionalized fluid cavities.

FIG. 51 includes a flow diagram depicting an example process for sensing substances in functionalized fluid cavities.

FIG. 52 is a cross-sectional diagram of an example sensor device having a fluid cavity that is being functionalized.

FIG. 53 is a cross-sectional diagram of an example sensor device having a functionalized fluid cavity.

FIG. 54 includes flow diagrams depicting example processes for fabricating a sensor device having a functionalized fluid cavity and operating the sensor device.

FIG. 55 includes flow diagrams depicting example processes for fabricating a sensor device having a functionalized fluid cavity and operating the sensor device.

FIG. 56 is a cross-sectional diagram of an example sensor device having a fluid cavity that is being functionalized.

FIG. 57 is a cross-sectional diagram of an example sensor device having a functionalized fluid cavity.

FIG. 58 includes flow diagrams depicting example processes for fabricating a sensor device having a functionalized fluid cavity and operating the sensor device.

FIG. 59 is a cross-sectional diagram of an example sensor device having a fluid cavity that is being functionalized.

FIGS. 60A and 60B are cross-sectional diagrams of an example sensor device having a functionalized fluid cavity.

FIG. 61 is a top-down schematic diagram of an example functionalized fluid cavity.

FIG. 62 is a top-down schematic diagram of an example functionalized fluid cavity.

FIG. 63 is a top-down schematic diagram of an example functionalized fluid cavity.

FIG. 64 is a top-down schematic diagram of an example functionalized fluid cavity.

FIG. 65 is a top-down view of an example sensor integrated circuit (IC) device having a functionalized fluid cavity.

FIG. 66A is a cross-sectional view of an example sensor IC device having a functionalized fluid cavity, and FIG. 66B illustrates an example technique of operating the sensor IC device of FIG. 66A.

FIG. 67 is a top-down view of an example functionalized fluid cavity.

FIG. 68 is a perspective view of an example functionalized fluid cavity.

The same reference numbers or other reference designators are used in the drawings to designate the same or similar (either by function and/or structure) features.

### DETAILED DESCRIPTION

Microfluidics and nanofluidics are emerging fields with a wide range of applications, such as analytical chemistry and biochemistry, liquid transport and metering, desalination, reaction control and detection, and energy conversion. In such applications, the fluid, an electrolyte solution, may not be at thermodynamic equilibrium. This infers that thermodynamic forces act across spatiotemporal gradients. Governing equations for transport of both solvents and solutes are Poisson-Nernst-Planck (PNP) equations to describe electrokinetic phenomena, and Navier-Stokes equation to describe fluid dynamics. Spatiotemporal variation of both electrical potential V, and activity (which in diluted solutions is identical to concentration) of hydrogen ions (pH), are key quantities in PNP equations, and can be studied using various devices, such as nanofluidic diodes, capacitive deionization, and electrophoresis devices. Even though these parameters are so important, they are also difficult to measure in confined spaces.

Electrochemical measurements can be of impedimetric or amperometric nature. In contrast to the linear concentration dependence of amperometry, potentiometry provides logarithmic concentration dependence, which makes it useful for low limit of detection biosensing, such as biosensing for low concentration targets. Potentiometric sensing is difficult due to susceptibility to noise and mismatch. On the other hand, potentiometric signal readout yields higher signal to background noise ratio. As to be described below, a fluid sensor including a fluidic structure can be fabricated as a monolithic silicon integrated circuit (IC) including microelectromechanical (MEMS) co-integration of microfluidic device, potentiometric sensors, and amplification in close proximity to the microfluidic device.

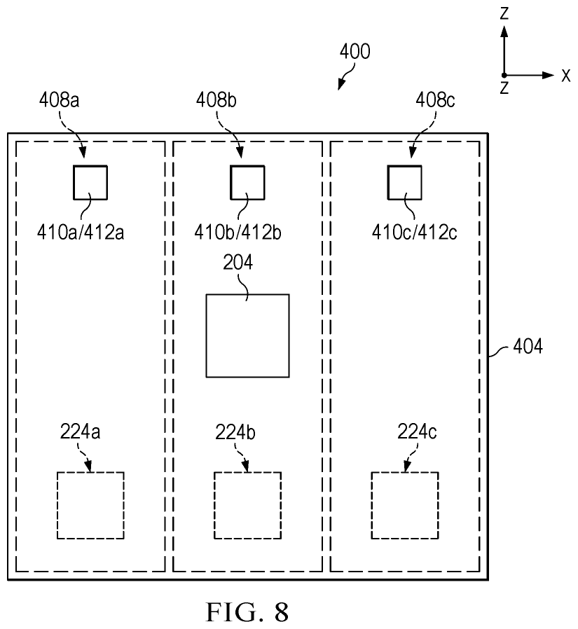

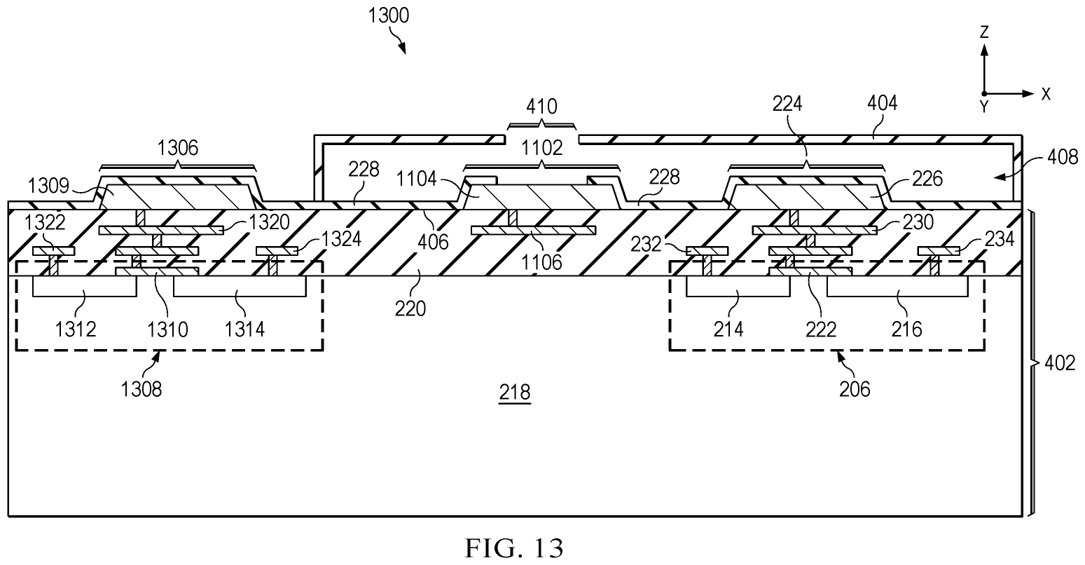

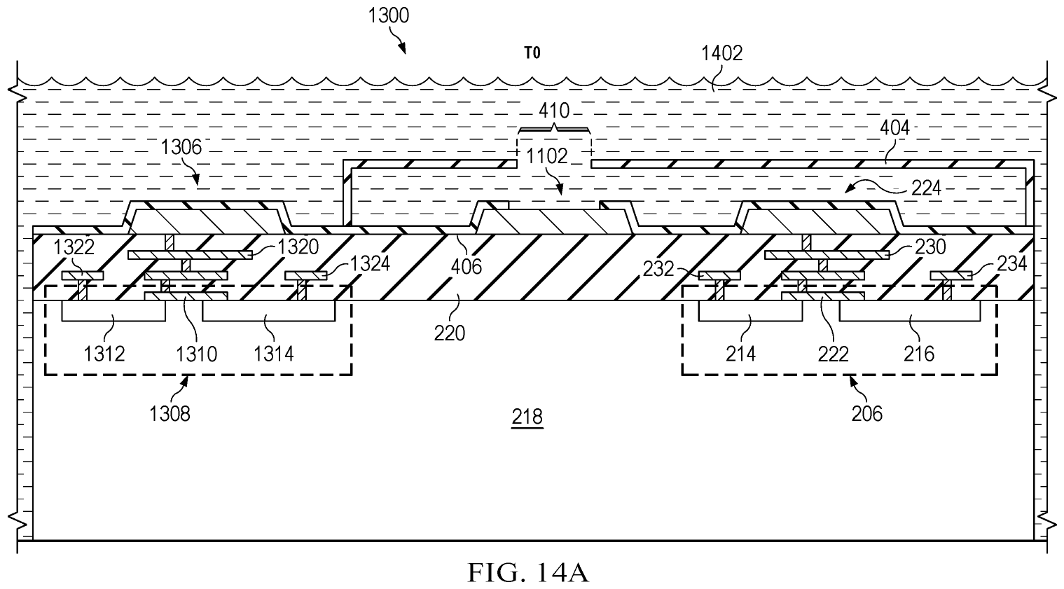

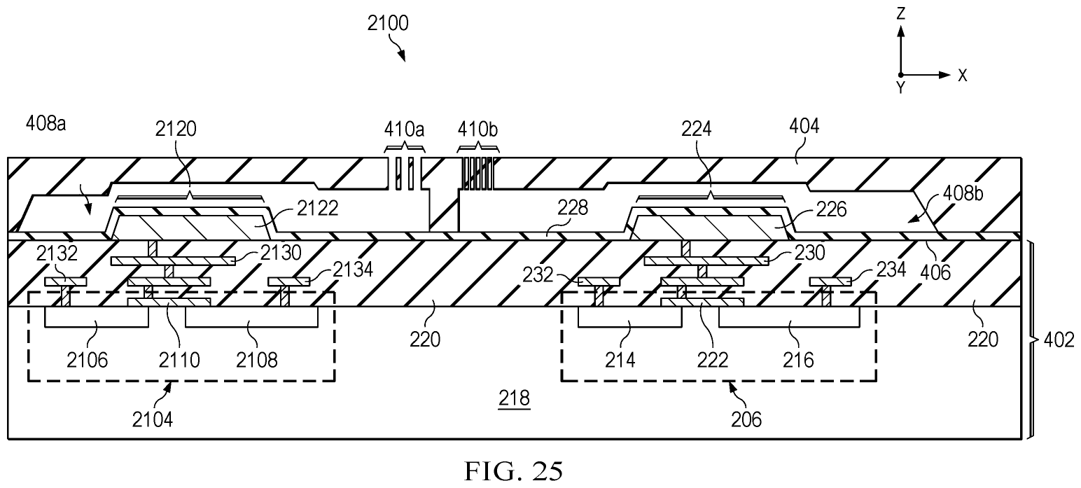

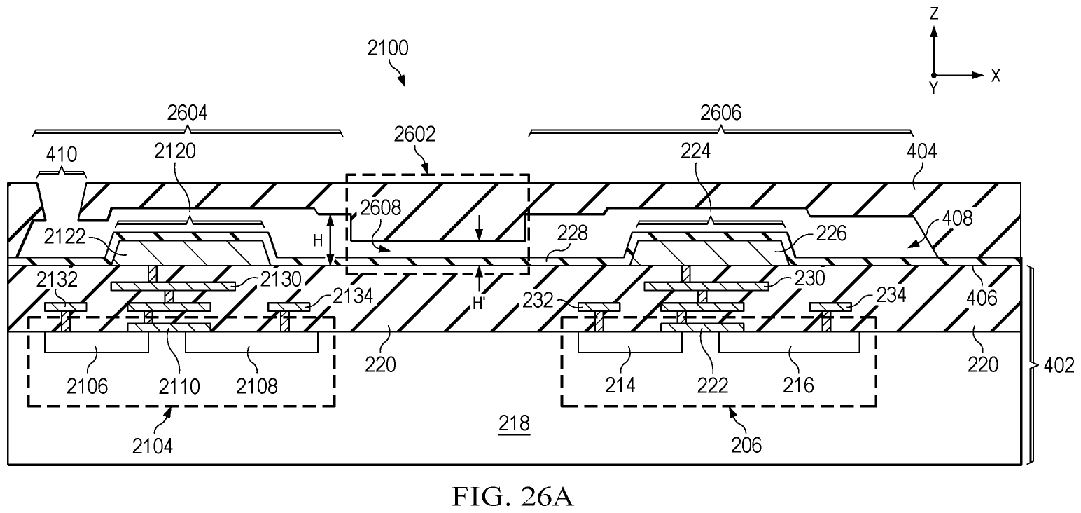

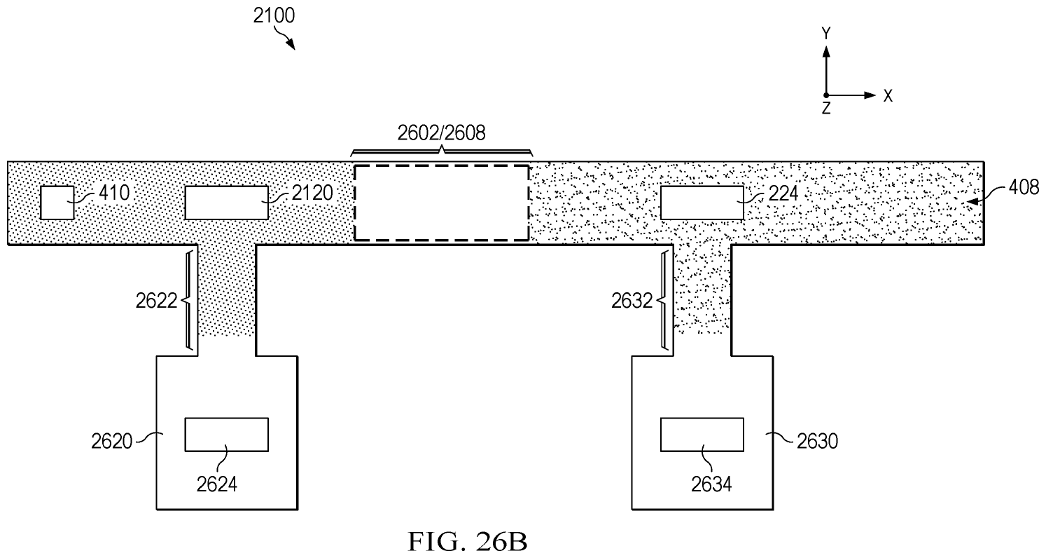

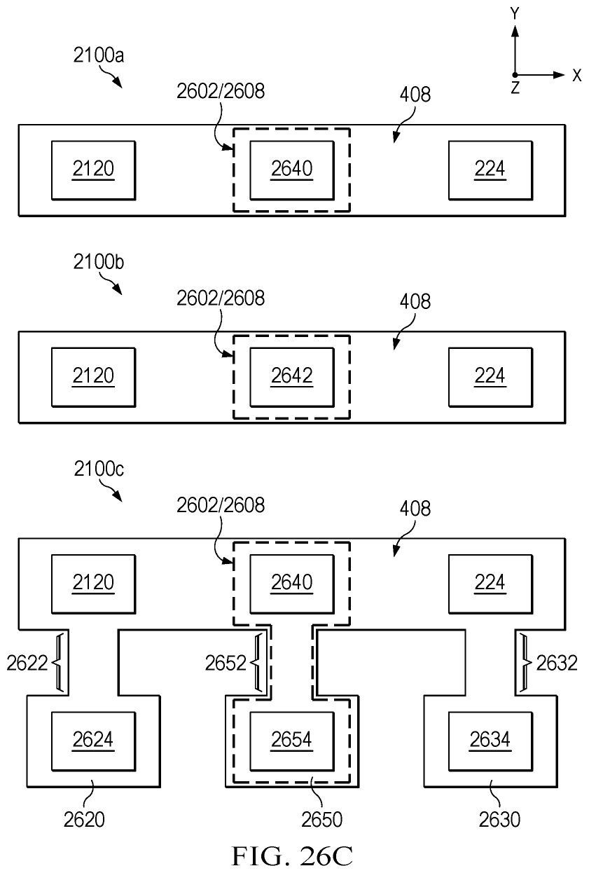

A fluid sensor can conduct spatiotemporal potentiometric measurement of surface potentials inside a microfluidic channel. The fluid sensor can include ion-sensitive field effect transistor (ISFETs) that can measure surface potential at dielectric surfaces interfacing the fluid. The charge of the surface can be passively mirrored downward into the silicon CMOS where amplification of the signal occurs. Certain geometric arrangements of such fluid sensors allows differential pH measurement where knowledge of an initial pH value and time delayed aspects enables to do differential pH sensing without requirement of a reference electrode (see FIGS. 13-20, 29). As to be described below, in certain geometric arrangements, the fluid sensor may also conduct spatiotemporal measurement of surface potentials inside nanofluidic channels, which depend not only on pH. In certain geometric arrangements, the fluid sensor may also provide a pH-independent voltage reference to conduct spatiotemporal measurement of bulk potential (similar to a discrete silver-silver chloride reference electrode in combination with a Luggin capillary) without requirement of a reference electrode (see FIGS. 26B, 26C, 31D, 42C, 43C, 43D, 44, 45, 46). Spatiotemporal gradients are present in fluids whenever one or more thermodynamic forces act, i.e. when a fluid is not in thermodynamic equilibrium. Spatiotemporal gradients can be monitored by the fluid sensors and may be passively created by a gradual or fast exchange of a single fluid under test in the bulk on the fluid sensor surface via diffusion (see FIGS. 8, 21, 22, 23, 24). In some examples, spatiotemporal gradients may be actively created by electrochemical techniques, nanofluidic confinement, use of multiple surfaces with different zeta potential or isoelectric point, mixing of multiple fluids under test, or a combination of these (see FIGS. 25, 26, 27, 28, 30, 31C, 31D, 41, 46).

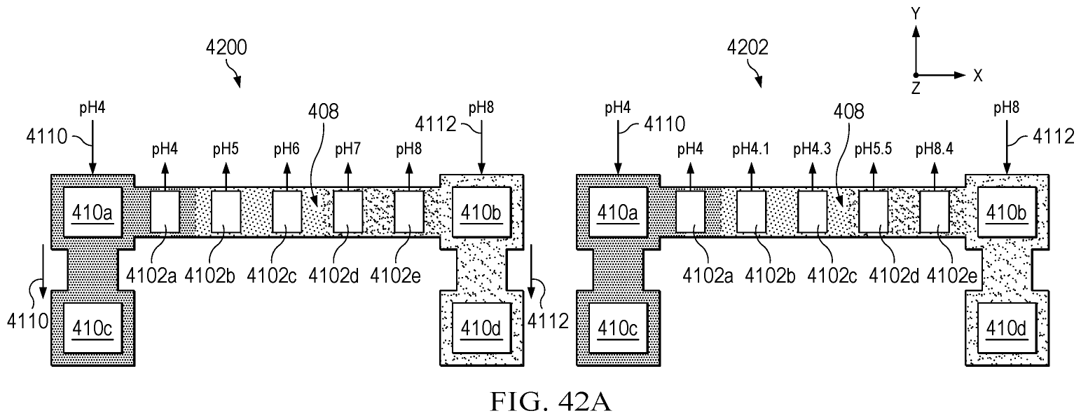

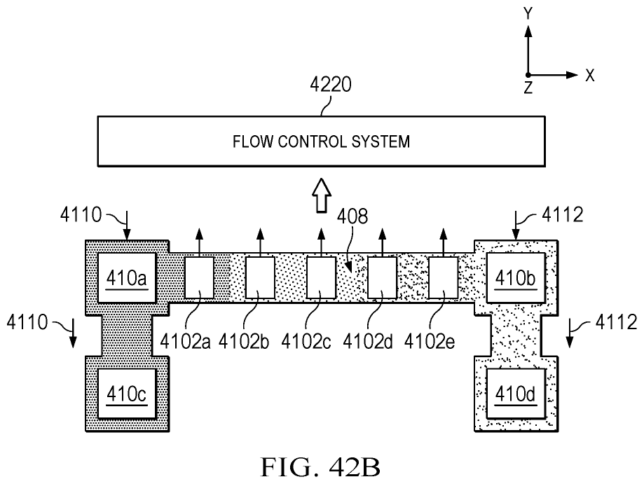

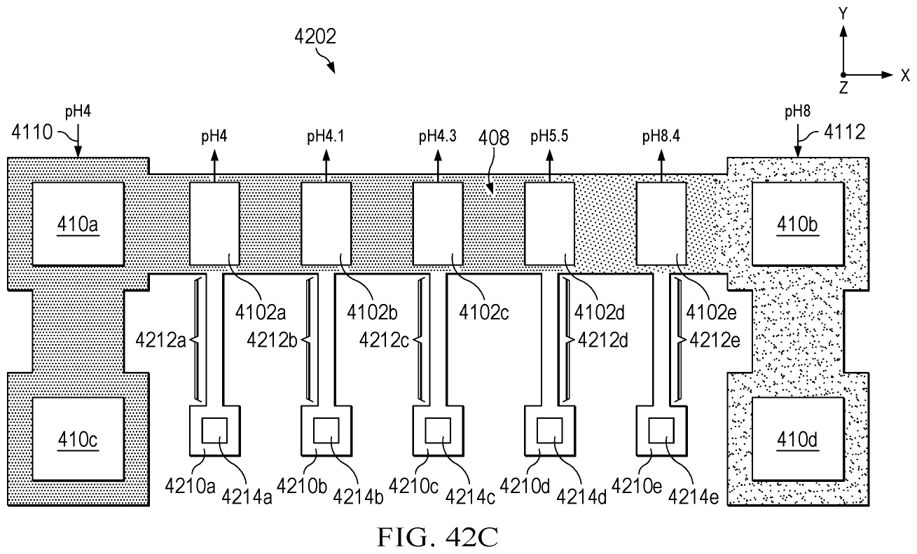

Also, in some examples, a 2D arrangement of such fluid sensors allows spatial mapping of the potential differences created by the spatiotemporal gradients, which is useful for many applications such as fluid process control. Further, most microfluidic devices benefit from detection and control, e.g. via a sensor-actuator feedback loop (see FIG. 42B), of gradients, such as devices involving monitoring of chemical reactions or devices involving electrophoresis, particularly isoelectric focusing, as well as mixers; devices involving electroosmosis, capacitive deionization, ion concentration polarization; nanofluidic devices such as DNA nanopores; devices with permselective membranes; and bioelectrochemical devices. Novel analytical devices such as micro-total analysis systems (μ-TAS) devices with main purpose of “fingerprinting” fluids, such as time-of-flight based identification of molecular or specifically ionic species may be created with the herein described fluid sensors as primary sensing elements, in combination with techniques such as described above.

Some types of sensors are configured to measure various physical properties of an environment, such as temperature, humidity, light, sound, pressure, etc. The sensor can be formed on a semiconductor die, which can be partially encapsulated in a mold compound to form a sensor package. In some cases, the sensor can be exposed directly via an opening in the mold compound to the environment to be tested.

Some sensor devices include an opening containing sensor terminals. The opening is configured to receive a fluid under test (FUT). A sensor device senses one or more properties of a substance in the FUT via the sensor terminals in the opening and generates an electrical signal (e.g., using appropriate circuitry, such as a transducer) indicating the one or more properties that were sensed. In some cases, the opening can contain a material that interacts (e.g., a chemical reaction) with the FUT to produce a substance to be sensed by the sensor transducer. For example, a sensor device surface may include a honeycomb structure having multiple openings, with each opening of the honeycomb containing a separate sensor terminal and a bead that functionalizes that cavity. When a FUT is applied into the opening, the FUT interacts with the bead in that opening to produce a substance that can be sensed by the sensor transducer of that opening.

The aforementioned sensor device having a honeycomb structure may suffer from numerous technical challenges, however. For instance, the bead in the opening is not restricted or restrained, and can easily fall out of the opening if the sensor device is tilted or turned upside down. The substance produced by the interaction between the FUT and the bead may also spill into other openings of the honeycomb structure, causing cross-contamination. Because of the risk of cross-contamination, the sensor device cannot test different substances in different openings of the honeycomb structure. Further still, if the sensor device is tilted or turned upside down, the FUT and/or the substance to be sensed may spill out of the openings. Further, in a case where the sensor device includes a membrane which is not physically restricted in the opening, the membrane can easily delaminate and detach from the sensor device, especially after the membrane experiences volume changes due to application of the FUT.

This disclosure describes various examples of a sensor device with a fluid cavity that can mitigate the technical challenges described above. The fluid cavity is functionalized, where it contains a functionalization material to interact with a fluid (e.g., a FUT) to generate a signal, and the functionalization material is at least partially encapsulated or enclosed in the fluid cavity and can be prevented from falling out of the fluid cavity. An example sensor device comprises a semiconductor die including a semiconductor substrate, a dielectric layer on the semiconductor substrate, and a metallization structure in the dielectric layer, in which the semiconductor substrate includes sensor circuitry coupled to the metallization structure. The dielectric layer has a sensing side facing away from the semiconductor substrate. The device also includes an insulation layer on the sensing side and a sensor terminal on the sensing side and coupled to the metallization structure. The device also comprises a restriction structure including an opening, in which the restriction structure is on the sensing side and encapsulates a fluid cavity on the sensing side. The sensor terminal is in the fluid cavity, and the restriction structure is configured to allow a fluid to enter the fluid cavity and reach the sensor terminal through the opening. The fluid cavity contains a functionalization material, which can be a solid material, configured to interact with the fluid to produce a signal due to a state change (e.g., a physical state change, a biological state change, or a chemical state change) in the functionalization material. The sensor circuitry is configured to sense/detect the signal via the sensor terminal. In examples, a length of the fluid cavity extends in a horizontal direction parallel to the semiconductor die and is covered at least in part by the restriction structure.

The restriction structure can at least partially enclose or encapsulate the functionalization material in the fluid cavity, which can prevent the functionalization material from exiting the fluid cavity via the opening. The restriction structure can also at least partially enclose or encapsulate the fluid. Consequently, the risk of cross-contamination between cavities is mitigated, thus enabling the simultaneous testing of different substances. The risk of loss of the functionalization material from the fluid cavity due to tilting, jostling, or other physical disturbances is mitigated.

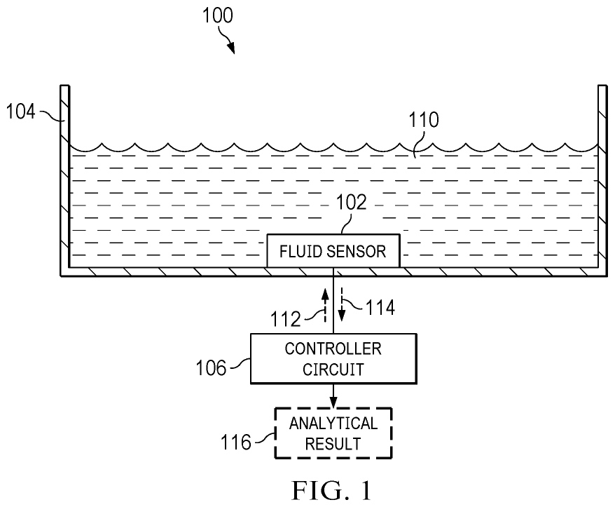

FIG. 1 is a schematic of an example fluid analytic system 100. Fluid analytic system 100 can include a fluid sensor 102, a container 104, and a control circuit 106. Container 104 can hold a fluid 110 to be analyzed by fluid analytic system 100. Fluid 110 can include an aqueous electrolyte solution of positive and negative ions. Fluid sensor 102 can be positioned in container 104 and interface with fluid 110. Controller circuit 106 can transmit a control signal 112 to fluid sensor 102. Responsive to control signal 112, fluid sensor 102 can sense a particular type of ions (e.g., Hydrogen ions) in fluid 110, and generate a sensor signal 114 representing, for example, a pH measurement of fluid 110. Fluid sensor 102 can provide sensor signal 114 to controller circuit 106, which can generate an analytical result 116 based on processing signal 108. Analytical result 116 can represent a result of a chemical and/or biochemical analysis, such as pH measurement, mass spectrometry, electrophoresis, and DNA analysis.

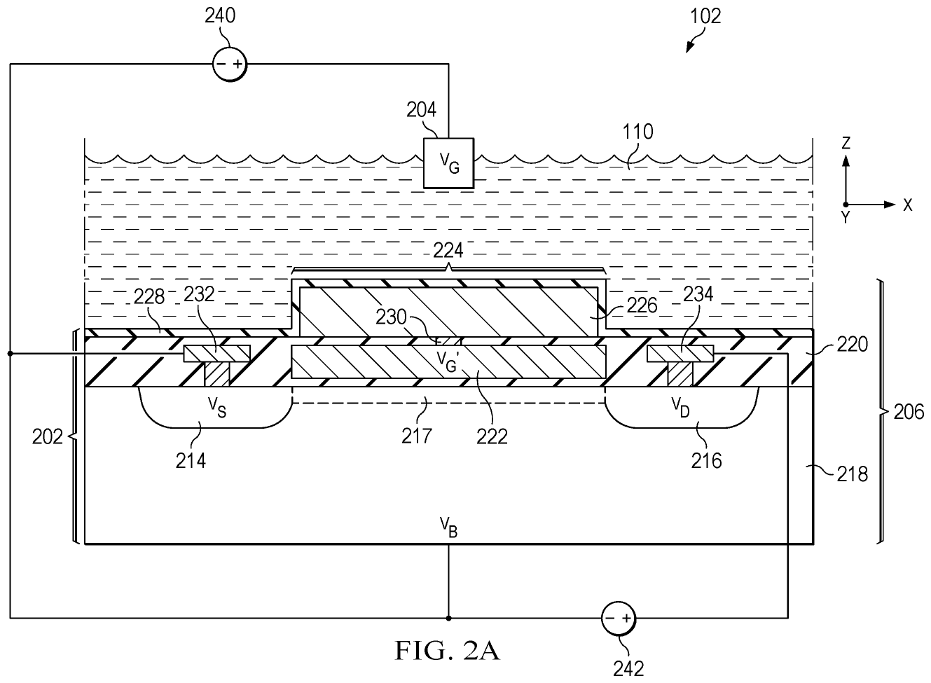

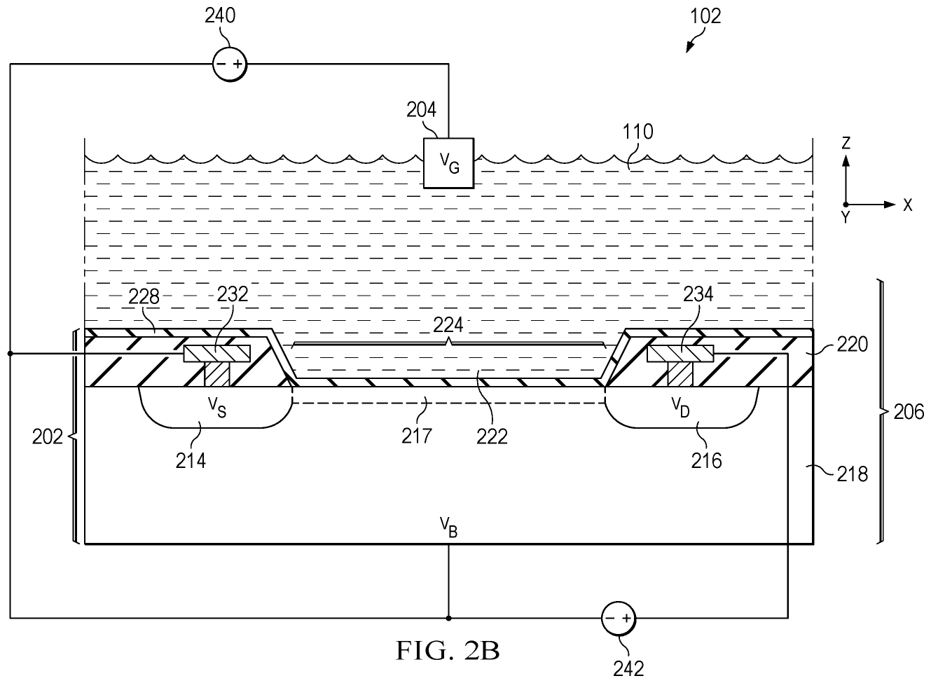

FIG. 2A is a schematic illustrating a cross-sectional view of fluid sensor 102. Fluid sensor 102 can include a semiconductor die 202. In some examples, fluid sensor 102 can also include a reference electrode 204. In some examples, an electrode in a fluid sensor can be made of Platinum or other noble metals. Also a reference electrode, such as reference electrode 204, can be a discrete silver-silver chloride metal wire inside of a Potassium Chloride (KCl) reservoir (not shown in FIG. 2A), and the KCl solution is connected to fluid 110 via a liquid junction.

In FIG. 2A, semiconductor die 202 can include an extended-gate ion-sensitive field effect transistor (EG-ISFET) 206, which includes current terminals 214 (e.g., a source terminal) and 216 (e.g., a drain terminal) separated by a channel region 217 in a substrate 218, a dielectric layer 220 on substrate 218, and a floating gate terminal 222 in dielectric layer 220 and separated from substrate 218. Fluid sensor 102 also includes a sensor terminal 224 on dielectric layer 220. Sensor terminal 224 can include an electrode 226 covered with an insulation layer 228. Examples of insulation layer 228 can include various silicon-based and metal-based oxides and nitride, such as silicon oxide (SiO₂), silicon nitride (Si₃N₄), aluminum oxide (Al₂O₃), and tantalum pentoxide (Ta₂O₅), Hafnium oxide (HfO₂), Zirconium dioxide (ZrO₂), Yttrium oxide (Y₂O₃), Zinc Oxide (ZnO), Tin Oxide (SnO₂), Manganese Dioxide (MnO₂), and Gallium Oxide (Ga₂O₃). Another example of insulation layer 228 can be Graphene. These materials can be formed by various processes, such as sputter deposition, vapor deposition (e.g., chemical vapor deposition), oxidation from a metal deposited by physical vapor deposition (e.g. TiO₂ from Ti) either wet chemically or in an oven with oxygen, atomic layer deposition, etc.

Gate terminal 222 is submerged in fluid 110, and insulation layer 228 can provide a sensing surface. Reference electrode 204 can also be partially or fully submerged in fluid 110. Electrode 226 can be coupled to gate terminal 222 via an interconnect 230, and drain and current terminals 216 and 214 each can be coupled to respective interconnects 232 and 234. Interconnects 230, 232, and 234 can be part of a metallization structure encapsulated (or surrounded) by dielectric layer 220. In FIG. 2B, semiconductor die 202 can also include an open-gate ion-sensitive field effect transistor (OG-ISFET), where fluid is separated from channel region 217 by insulation layer 228. With OG-ISFET, a region of insulation layer 228 directly above channel region 217 can be sensor terminal 224.

In examples, transistor 206 may have a planar 2D semiconductor surface similar to a metal oxide semiconductor field effect transistor (MOSFET). In some examples, transistor 206 may include a non-planar field effect transistor, such as fin field effect transistors or nanowire field effect transistors.

Reference electrode 204, source terminal 214, drain terminal 216, and substrate 218 can be coupled to voltage sources 240 and 242 to set their electrical potentials. For example, the source terminal 214 can be set to a potential Vₛ, the drain terminal 216 can be set to a potential V_{D}, and substrate 218 can be set to a potential VB. Also, reference electrode 204 can be set to a potential V_{G}, and the potential of gate terminal 222 can be based on V_{G} The gate-substrate potential difference between the gate terminal 222 and substrate 218 can be V_{FG}. V_{FG} and V_{G} can be related based on the following Equation:

V_{FG}=a+b×V_{G} (Equation 1)

In Equation 1 above, a is a constant (for simplification omitted in the following equations), and b can be a function of various capacitances, including the capacitances between floating gate terminal 222 and fluid 110, and between floating gate terminal 222 and other metals (e.g., interconnects 232, 230, 234, etc.), as described below.

A current channel can form between drain terminal 216 and source terminal 214 if the gate-substrate-source potential difference, V_{FG}-V_{S}, exceeds the threshold voltage V_{TH} of ISFET 206. The amount of current that flows between drain terminal 216 and source terminal 214, I_{DS}, can be a function of V_{FG}(pH)−V_{S}-V_{TH} and the voltage difference V_{DS} between drain terminal 216 and source terminal 214.

Fluid sensor 102 can provide a pH measurement and generate a signal that reflects the activity of hydrogen ions in fluid 110 based on I_{DS}. According to the site binding model, depending on their activity, hydrogen ions (H) in fluid 110 accumulate at the dielectric surface in the so-called electric double layer, and dominates the surface potential at the interface. The surface charge is capacitively coupled into the floating gate. The floating gate voltage V_{FG} hence is a function directly proportional to surface potential, which in turn is asymptotic to the electrode potential, i.e. in relative terms ΔV_{FG} is proportional to ΔV_{Surf}=ΔV_{G}. Since I_{DS} can vary with V_{FG}, it can provide a measurement of the pH of fluid 110.

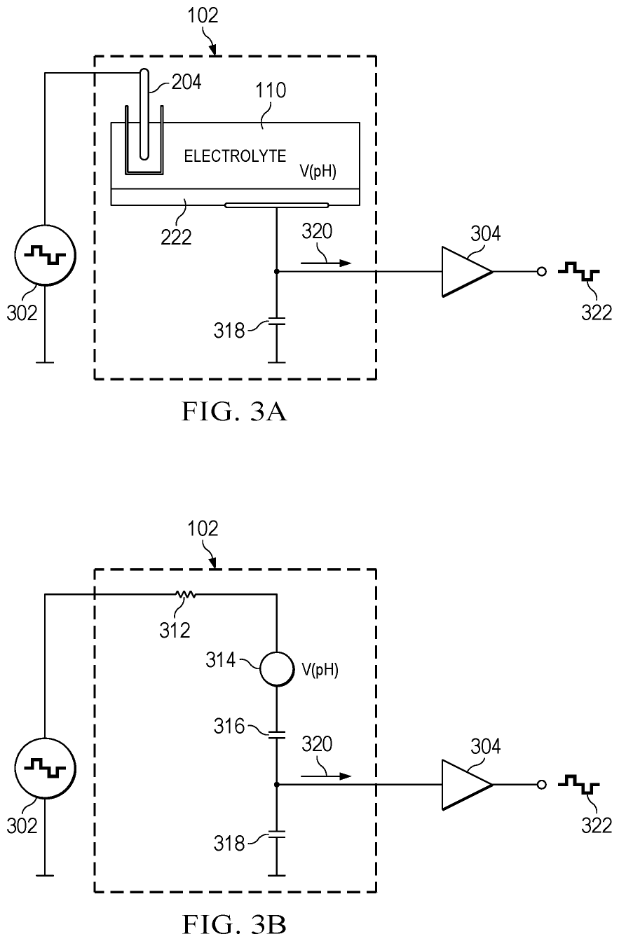

FIG. 3A and FIG. 3B illustrate example interface circuits of fluid sensor 102. Referring to FIGS. 3A and 3B, reference electrode 204 of fluid sensor 102 can be driven by a signal generator 302, and drain terminal 216 can be coupled to a voltage buffer 304. Signal generator 302 and voltage buffer 304 can be part of controller circuit 106, and can be implemented in semiconductor substrate 218 or external to semiconductor substrate 218. Referring to FIG. 3B, fluid 110 can be represented by a series connection of resistor 312, a variable voltage source 314, and a capacitive divider including capacitors 316 and 318. Resistor 312 can represent the resistance of reference electrode 204. Variable voltage source 314 can represent the surface potential V_{Surf} which is a function of the pH of fluid 110.

The relationship between a change in V_{Surf} (ΔV_{surf}) and a change in the pH of fluid 110 (ΔpH) can be based on the Nernst equation as follows:

ΔV_{surf}=RT/F×ΔpH (Equation 2)

In Equation 2, R represents the universal gas constant, F represents the Faraday constant, and T represents temperature in kelvins, and RT/F can measure the pH sensitivity (S) of the fluid sensor. At standard state 1 mol/L for solutes, 1 atm for gases, T=298.15 K, i.e., 25° C. or 77° F., the sensitivity S can be at −0.05916. Equation 2 can be generalized as follows:

ΔV_{surf}=ΔV_{G}+S×ΔpH (Equation 3)

Capacitor 316 can represent a capacitance between fluid 110 and gate terminal 222 including capacitances contributed by fluid 110 and sensor terminal 224. Capacitor 318 can represent a parasitic capacitance between floating gate terminal 222 and secondary circuit elements in proximity to floating gate terminal 222, such as an analog floating gate or a metal-insulator-metal capacitor to control the floating gate potential V_{FG}.

Signal generator 302 can provide a sequence of voltage step signals, e.g. V_{G}±Vₛₜₑₚ to reference electrode 204. Voltage steps can be applied to verify proper electrical coupling between signal generator 302 and floating gate terminal 222. Responsive to the step voltage signal V_{G}, channel region 217 can conduct a step in I_{DS} according to the step voltage signal V_{G}. Step signal 320 can be represented by dividing a voltage V_{FG}-Vₛ-V_{TH} between capacitors 316 and 318, and voltage buffer 304 can provide a signal 322 as a buffered version of signal 320. Signal 322 can represent a sensed electrical potential V(pH) and can a pH measurement of fluid 110. Signal generator 302 can provide the step voltage signal V_{G}±Vₛₜₑₚ repeatedly between sampling intervals, and voltage buffer 304 can receive signal 320 and provide buffered signal 322 continuously. A change in the amplitude of signal 322 can reflect a change in the pH of fluid 110. A change in the amplitude of the fraction between step voltage amplitude Vₛₜₑₚ at 302 and the step function response ΔVₛₜₑₚ at 322 indicates an anomaly such as an air bubble covering a fraction of the capacitor 316.

One example application of fluid sensor to support the study of microfluidics, which can include analysis and manipulation of a fluid in a cavity having dimensions at the microscale, from 0.01 to hundreds of micrometers. When the fluid is at the microscale, surface effects as well as diffusion and laminar flow play an important role. The study of Electrokinetics describes the electrical properties of fluids, which also depend on the confinement scale. Microfluidics studies how these behaviors change, and how they can be worked around, or exploited for new uses. Microfluidics can have various applications, such as molecular and cell biology research, genetics, the study of fluid dynamics, and microfluidic mixing.

In microfluidics, one mechanism of fluid transport is by diffusion, where particles (e.g., ions) have a net flux down a concentration gradient. The distance by which a fluid is transported by diffusion can be related to the square root of the transport time of the fluid. Another mechanism of fluid transport is by convection, which can occur at a higher speed than diffusion. The relatively slow speed of fluid transport by diffusion can support additional applications, such as pH measurement with or without a reference electrode.

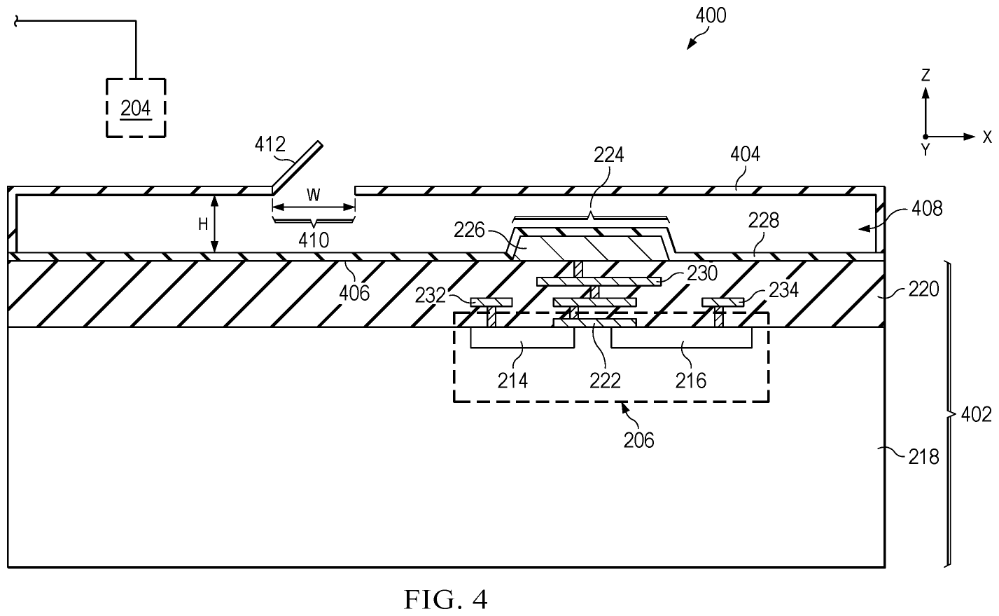

FIG. 4 is a schematic illustrating a cross-sectional view of an example microfluidic sensor. Referring to FIG. 4, microfluidic sensor 400 can be an integrated circuit including a semiconductor die 402 and a fluidic structure 404 on semiconductor die 402. Semiconductor die 402 includes semiconductor substrate 218, dielectric layer 220 on semiconductor substrate 218, and a metallization structure including interconnects 230, 232, and 234 encapsulated in/surrounded by dielectric layer 220. In FIG. 4, semiconductor die 402 also includes an ISFET (e.g., ISFET 206). In FIG. 4 and subsequent figures, each ISFET can be an EG-ISFET or an OG-ISFET. Semiconductor die 402 may include other circuits, such as controller circuit 106 of FIG. 1 and signal generator 302 and voltage buffer 304 of FIG. 3. Microfluidic sensor 400 also includes sensor terminal 224 on a sensing side 406 of dielectric layer 220, where sensor terminal 224 includes electrode 226 covered by insulation layer 228, which can cover other parts of sensing side 406 abutting electrode 226. The electrodes of a microfluidic sensor can be made of noble metals such as Platinum, Palladium, or Gold, as well as other metals or metal alloys such as Titanium Nitride(TiN), Tantalum Nitride (TaN), Ta, Tungsten (W), or Aluminum Silicon Titanium (AlSiTi). In some examples, microfluidic sensor 400 also includes reference electrode 204.

Also, fluidic structure 404 is on sensing side 406 of dielectric layer 220, and can enclose a fluid cavity 408 around sensor terminal 224. Fluidic structure 404 can be within a footprint of semiconductor die 402. In some examples, fluidic structure 404 can be made of a rigid silicon-based material, such as Silicon Oxide (SiO2), Silicon Nitride (Si₂N₃), etc. In some examples, fluidic structure 404 can be made of or include other materials, such as polymers like SU-8 or Polyimide, Al₂O₃, etc. In the example of FIG. 4, fluidic structure 404 can include an opening 410. Fluid cavity 408 can be configured as a microfluidic cavity/channel with a height (labelled H in FIG. 4) at the microscale, such as at 0.01 to hundreds of micrometers. The width of opening 410 (labelled W in FIG. 4) can also be at microscale. In some examples, part of fluid cavity 408 can have a height/width at the nanoscale, such as at tens to hundreds of nanometers. In some examples, fluid sensor 400 can include a control device 412 that can enable or disable the flow of fluid through opening 410 into cavity 408, or otherwise vary the rate of flow of fluid through opening 410 into cavity 408. As to be described below, microfluidic sensor 400 can include a valve in cavity 408 as control device 412.

In some examples, fluidic structure 404 can be part of a restriction structure to restrict/delay the flow of fluid from external of fluid sensor 400 to sensor terminal 224. The microscale dimensions of opening 410 and fluid cavity 408 can restrict the flow of the fluid from external of fluid cavity 408 to sensor terminal 224. When the sensor is dry and no fluid is present in fluid cavity 408, a first fluid may enter fluid cavity 408 through opening 410 by capillary action. With a first fluid present in fluid cavity 408, a second fluid can enter fluid cavity 408 through opening 410, and propagate within fluid cavity 408 to sensor terminal 224, by microfluidic diffusion.

In some examples, fluid cavity 408 may initially contain a dry substance, such as a salt, which at least partially dissolves to form a buffer solution, and can receive deionized water to form a buffer solution in the cavity. Fluid 110 can then enter fluid cavity 408 through opening 410 via a microfluidic diffusion into the buffer solution. Inside fluid cavity 408, fluid 110 can propagate to sensor terminal 224 via another microfluidic diffusion.

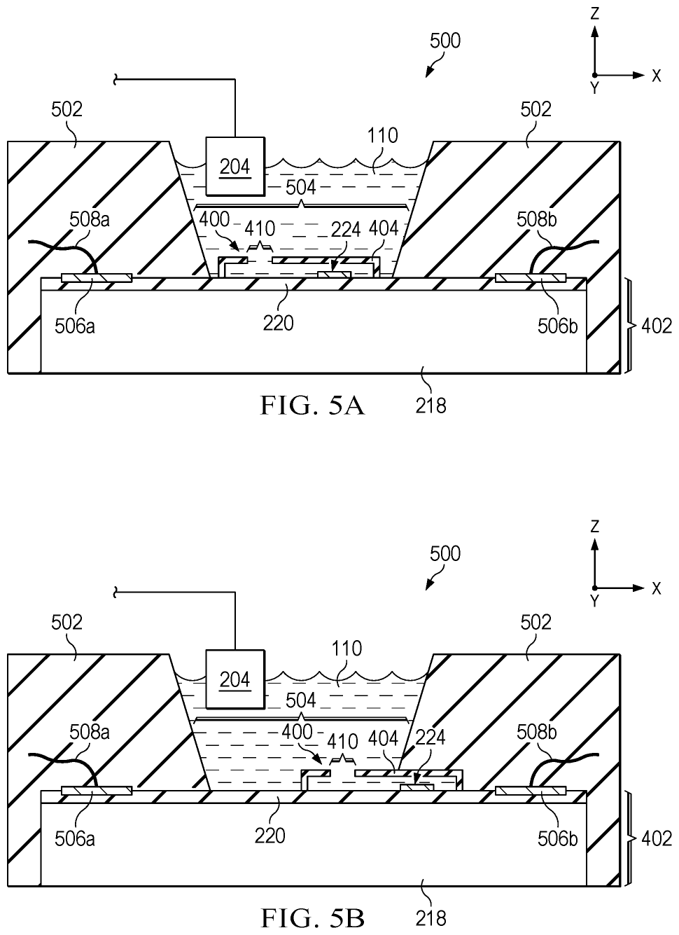

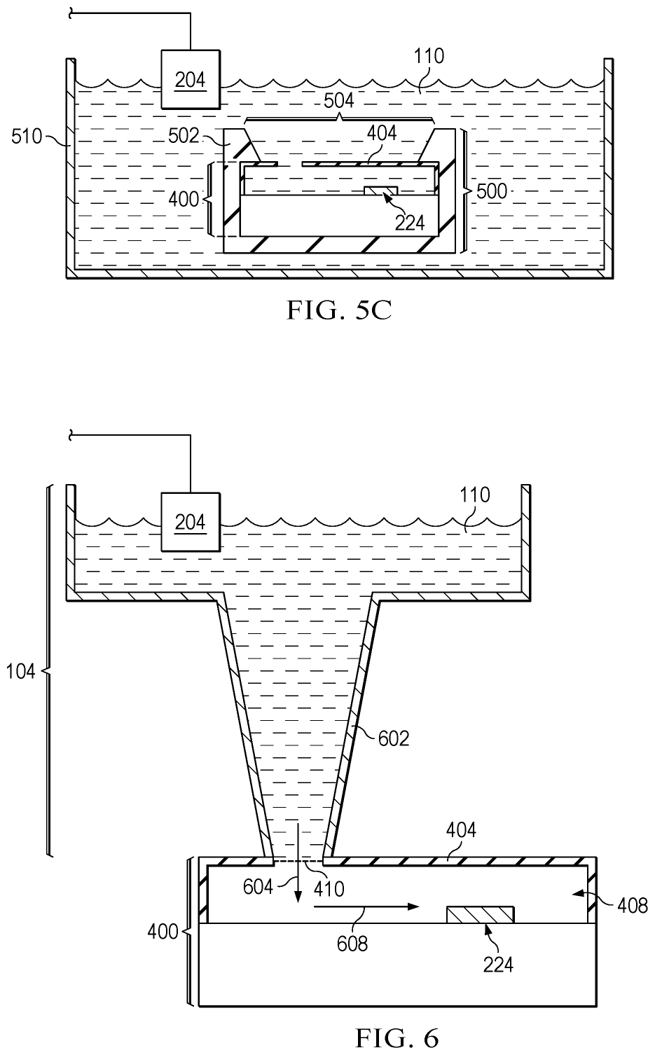

FIG. 5A, FIG. 5B, FIG. 5C and FIG. 6 illustrate example mechanisms of providing a fluid to microfluidic sensor 400 for sensing. FIG. 5A, FIG. 5B, FIG. 5C and FIG. 6 each is a schematic illustrating a cross-sectional view of a sensor system including microfluidic sensor 400. Referring to FIG. 5A, FIG. 5B, and FIG. 5C microfluidic sensor 400 can be part of a packaged integrated circuit 500 including package 502 abutting semiconductor die 402 and insulation layer 220. Package 502 can include a macroscopic opening 504 that exposes microfluidic sensor 400 (and opening 410), and opening 504 can hold a fluid, such as fluid 110, and microfluidic sensor 400 (and opening 410) can be submerged in fluid 110. A sensor system including packaged integrated circuit 500 can also include reference electrode 204 in contact with fluid 110 to set its electrical potential. Packaged integrated circuit 500 can also include interconnects, such as bond pads 506a/b and bond wires 508a/b, to support transmission of signals between microfluidic sensor 400 and an external system. In some examples, as shown in FIG. 5B, a first part of microfluidic sensor 400 can be embedded in package 502, and a second part of microfluidic sensor 400 including opening 410 can be exposed in opening 504. Also, referring to FIG. 5C, the entire packaged integrated circuit 500 can be submerged into a container 510 holding fluid 110. Packaged integrated circuit 500 can include wireless communication circuitry (not shown in FIG. 5C) to support wireless transmission of signals between microfluidic sensor 400 and an external system.

Also, referring to FIG. 6, fluid container 104 may include at least one port 602, which may include a microfluidic channel. In some examples, fluid container 104 may be part of a flow cell. Opening 410 of microfluidic sensor 400 can interface with and receive fluid 110 via conduit 602. Fluid 110 can then enter fluid cavity 408 through opening 410 via a microfluidic diffusion 604 into the buffer solution. Inside fluid cavity 408, fluid 110 can propagate to sensor terminal 224 via microfluidic diffusion 608.

Having a restriction structure including a microfluidic cavity integrated as an integrated circuit can provide various advantages. Specifically, as to be described later, fluidic structure 404 can be fabricated as part of wafer fabrication process or a packaging process of semiconductor die 402. The cleanliness, yield and quality control of wafer manufacturing process outperforms subsequent processes such as the packaging or housing process, which typically only partly takes place in a cleanroom, or at least in a clean room of lower class than a wafer fabrication cleanroom. When fluidic structure 404 is part of wafer fabrication, the dimensions of the overall sensor IC and IC package can be small. The small fluidic structure can reduce the overall size and footprint of the fluid sensor, especially compared with a case where the fluid sensor includes a discrete fluid container. This allows the fluid sensor to be deployed in various environments, such as on or within a patient's body. Further, because of the fluidic structure has a small footprint, it is more likely that the entire fluid cavity can have the same ambient condition (e.g., same temperature, same humidity, pressure, surface roughness, etc.), which can reduce measurement error caused by subjecting the fluid to non-uniform ambient conditions at different locations (e.g., at opening 410 and at sensor terminal 224) within the fluid cavity.

Further, as to be described later, having a fluid cavity integrated in an integrated circuit allows implementation of additional techniques to further improve the robustness of the fluid sensor and to support additional applications. For example, the inner surface of fluid cavity 408 can be covered with the same insulation layer 228 to provide a uniform wetting surface. This can reduce measurement error caused by difference in hydrophilic nature or Zeta potential difference due to the fluid being measured/sensed is in contact with two different wetting surfaces. Also, multiple sensor terminals and ISFETs can be implemented within the fluid cavity to provide differential sensing. Because those ISFETs are fabricated monolithically as part of the same semiconductor die, they can provide better matching, and such arrangements can reduce errors in the differential sensing caused by mismatches between ISFETs. Various circuits that interface with the ISFETs, such as signal generators and voltage buffers, can also be integrated with the ISFETs monolithically. This can improve matching and reduce the susceptibility of signal transmission to noise. Further, additional devices, such as valve and filter, can be implemented in the fluid cavity, at the opening, or otherwise as part of the restriction structure to control the flow of fluid and to further refine the selection of ions/particles to be measured by the fluid sensor, to support additional applications.

In some examples, fluidic structure 404 can also be fabricated as part of the packaging process, and the packaging process can be improved using various packaging techniques, such as wafer-to-wafer bonding or other heterogeneous integration methods, which can reduce mismatches among the fluid sensors and the cost of manufacturing of the fluid sensors. Accordingly, in some examples, fluidic structure 404 being fabricated as part of the packaging process can provide similar advantages as wafer fabrication.

In some examples, microfluidic sensor 400 can be used to measure a time of diffusion of a second fluid, which diffuses into fluid cavity 408, mixing and ultimately replacing the first fluid which occupies cavity 408 before the second fluid is introduced. Specifically, when the second fluid arrives at the sensor terminal 224, microfluidic sensor 400 can provide a signal representing the detection of local activity of ions (e.g., H+ ions), which in can depend on the activity of all ionic species i present in the first and second fluids, as well as their respective dissociation constants Kᵢ. Because it takes time for the fluid to propagate to sensor terminal 224 via diffusion, the signal provided by microfluidic sensor 400 can be used to measure a total time of, for example, the two fluids being fully mixed, full diffusion of ions of the second fluid into fluid cavity 408, and/or full diffusion of the ions of the first fluid out of fluid cavity 408.

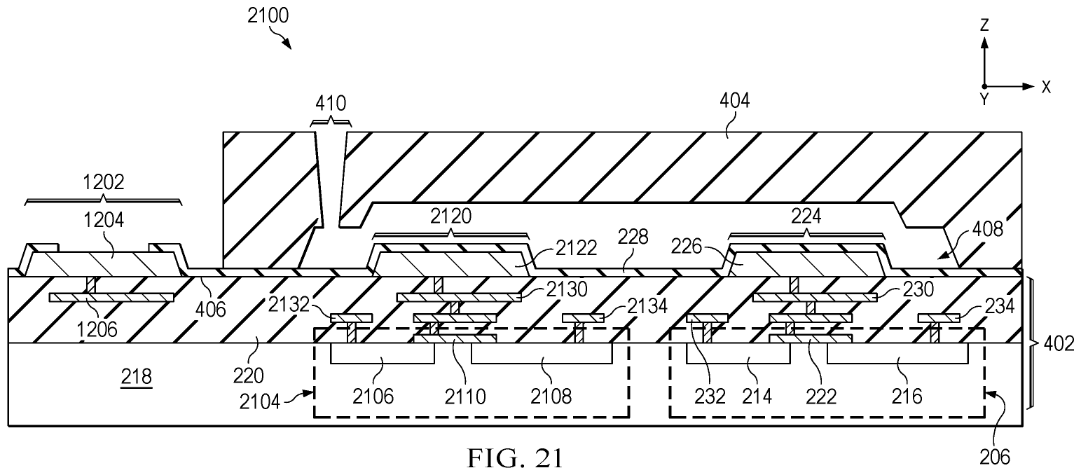

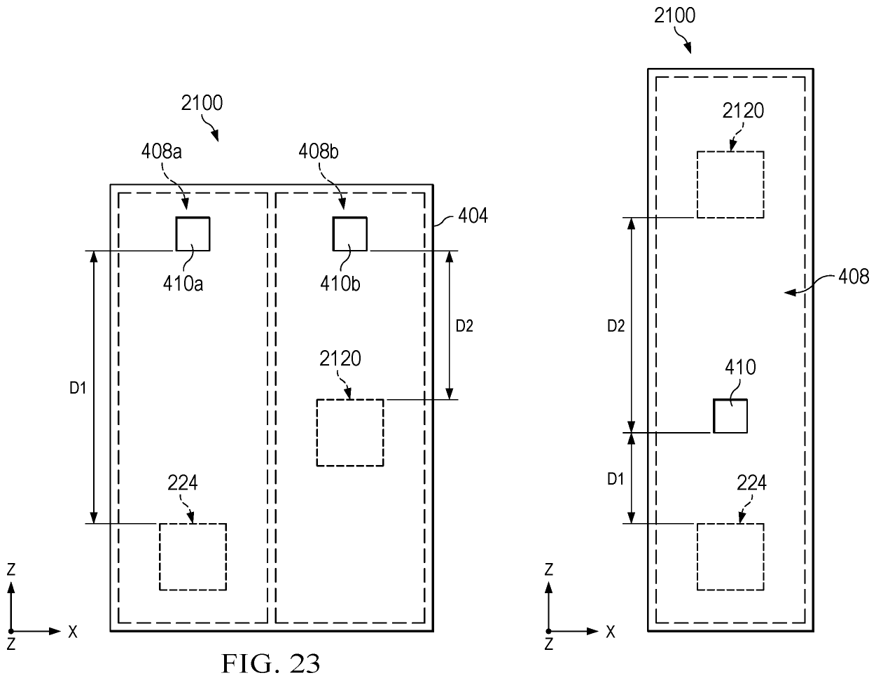

In case of a significantly larger reservoir of the second fluid being provided to fluid sensor 400 (e.g., as shown in FIGS. 5A-5C and FIG. 6), the first fluid can be fully replaced by the second fluid at a certain time. A change of H+ ion activity indicates that the diffusion front of the second fluid has reached sensor terminal 224. Once the H+ ion activity is no longer changing, an equilibrium such as full mixing or out-diffusion of first fluid is reached. This measurement in turn can support analytical measurements, since the mixing behavior described before depends on ionic species and the gradient of their respective activity formed between first and second fluid. As to be described below in FIGS. 21 and 23, a fluidic sensor can include multiple sensing elements (e.g., sensor terminals 224) along the diffusion path in fluid cavity 408 which allows further insight. Specifically, even for a matching pH of both fluids locally along the diffusion boundary, the pH can still vary to counter-balance charge accumulation due to the different free diffusion constants of the ions which are diffusing due to a non-zero activity gradient. In certain examples, this arrangement can be used to measure concentration of ionic species other than H+ ions, such as Potassium ions (K+), Sodium ions (Na+), or Chloride ions (Cl−).

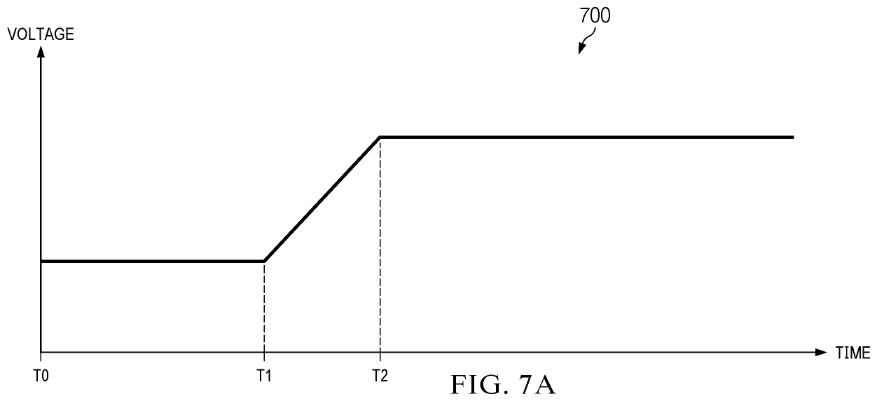

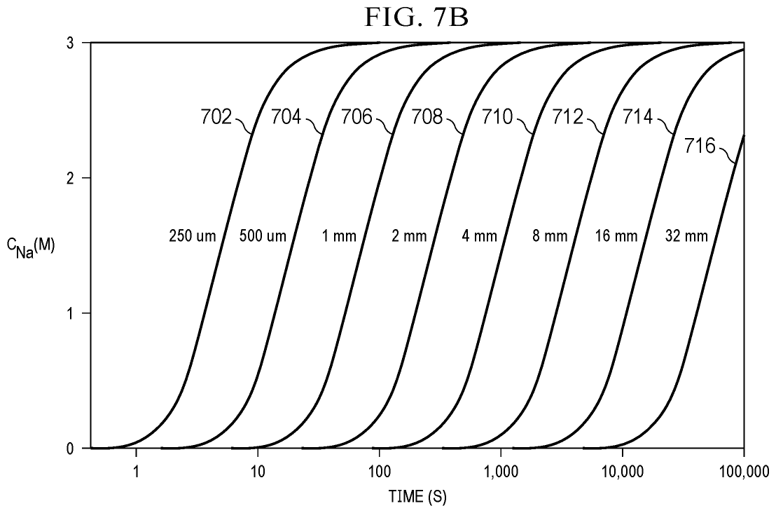

FIG. 7A and FIG. 7B illustrates example graphs representing time-series variations of the outputs of microfluidic sensor 400 in measuring a diffusion time. The outputs can represent changes in the concentration of an ion (e.g., hydrogen ion) as a result of diffusion. FIG. 7A illustrates an example graph 700. Referring to FIG. 7A, a fluid may be introduced at opening 410 of microfluidic sensor 400 at time TO. A first batch of ions of the fluid may diffuse across opening 410 and fluid cavity 408 and reach sensor terminal 224 at time T1, which causes a sensed electrical potential (voltage) of microfluidic sensor 400 to rise at T1. The diffusion time can be the time difference of T1-T0. As more ions arrive at sensor terminal 224 through diffusion, the sensed electrical potential of microfluidic sensor 400 may continue to rise. The sensed electrical potential of microfluidic sensor 400 can stop rising at T2 when a thermodynamic equilibrium state is reached.

Also, FIG. 7B illustrates example graphs 702 through 716 representing variations of Sodium concentration at sensor terminal 224 with respect to time for different channel lengths, where the channel length represents a distance between opening 410 and sensor terminal 224. In FIG. 0.7B, the vertical axis is mole concentration of Sodium (labelled C_{Na}), and the horizontal axis is time. The molar concentration of Sodium can be represented by the sensed electrical potential of microfluidic sensor 400. Referring to FIG. 7B, as the channel length increases, the time of diffusion from opening 410 to sensor terminal 224 also increases, the time for the molar concentration at sensor terminal 224 to increase to a particular level also increases. For example, referring to graph 702, for a channel length of 250 micrometers (um), it takes about 5 seconds for the molar concentration to reach 1 M. Also, referring to graph 716, for a channel length of 32 millimeters (mm), it takes about 50000 seconds for the molar concentration to reach 1 M.

In some examples, microfluidic sensor 400 can measure different diffusion times for different fluids. As described above, microfluidic sensor 400 can rely on microfluidic diffusion to receive a fluid from an external environment, and to transport the fluid within fluid cavity 408. Different ions/particles may have different diffusion time due to, for example, their different molecular masses, or other properties that affect the rate of diffusion. FIG. 8 illustrates a plan view of an example of microfluidic sensor 400 that supports diffusion time measurement of different fluids. Referring to FIG. 8, microfluidic sensor 400 includes separate fluid cavities 408a, 408b, and 408c enclosed by fluidic structure 404. Fluid cavity 408a can enclose a sensor terminal 224a, fluid cavity 408b can enclose a sensor terminal 224b, and fluid cavity 408c can enclose a sensor terminal 224c. Sensor terminals 224a, 224b, and 224c, and the ISFETs coupled to the sensor terminals, are in the same semiconductor die 402 and are part of a monolithic integrated circuit. Fluidic structure 404 also includes an opening 410a that extends to fluid cavity 408a, an opening 410b that extends to cavity fluid 408b, and an opening 410c that extends to fluid cavity 408c. Microfluidic sensor 400 can also include reference electrode 204 over fluidic structure 404 (e.g., along the z-axis).

In some examples, microfluidic sensor 400 can include additional sensor structures integrated in fluid cavities 408a-c and in close proximity to sensor terminals 224a-c. Such sensor structures can support various electrochemical measurement techniques such as impedance spectroscopy and amperometric measurements such as cyclovoltammetry.

In some examples, microfluidic sensor 400 can receive different fluids sequentially. For example, microfluidic sensor 400 can be part of packaged integrated circuit 500 of FIG. 5A and FIG. 5B, or can be in container 510. Different fluid can be introduced to opening 504 or container 510 at different times. Microfluidic sensor 400 can include a control device 412a at opening 410a (or between opening 410a and sensor terminal 224a), a control device 412b at opening 410b (or between opening 410b and sensor terminal 224b), and a control device 412c at opening 410c. When a first fluid is in opening 504/container 510, control device 412a can be opened and control devices 412b and 412c can be closed to allow the first fluid to enter fluid cavity 408a and to prevent the first fluid from entering fluid cavities 408b and 408c. Also, when a second fluid is in opening 504/container 510, control device 412b can be opened and control devices 412a and 412c can be closed to allow the second fluid to enter fluid cavity 408b and to prevent the second fluid from entering fluid cavities 408a and 408c. Further, when a third fluid is in opening 504/container 510, control device 412c can be opened and control devices 412a and 412b can be closed to allow the third fluid to enter fluid cavity 408c and to prevent the third fluid from entering fluid cavities 408a and 408b.

In other examples, the fluid cavity openings 408a, 408b, and 408c can each be coupled to a different port of FIG. 6, and each container can hold a different fluid. For example, fluid cavity opening 408a can be coupled to a port 602a to receive the first fluid, fluid cavity opening 408b can be coupled to a port 602b to receive the second fluid, and fluid cavity opening 408c can be coupled to a port 602c to receive the third fluid. Fluid cavities 408a, 408b, and 408c can receive the respective fluids at the same time.

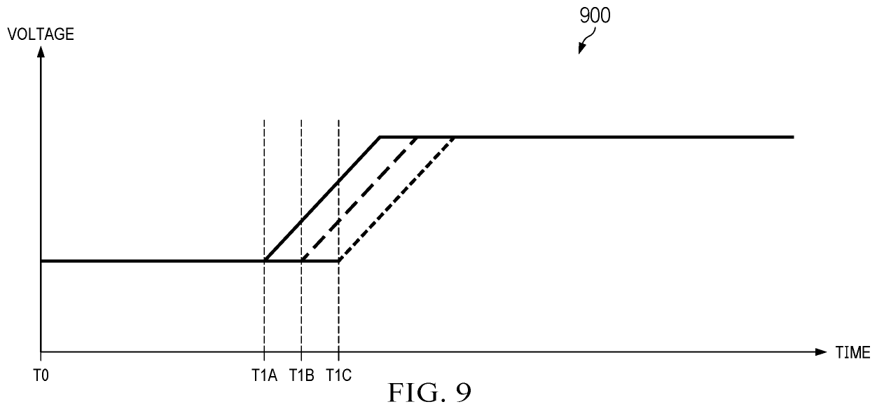

FIG. 9 illustrates a graph 900 representing a time-series variation of the outputs of microfluidic sensor 400 of FIG. 8 in measuring diffusion times of different fluids. Referring to graph 900, a first fluid, a second fluid, and a third fluid can be applied to the respective openings 410a, 410b, and 410c at time T0 via multiple ports 602a, 602b, 602c, as described above. Because of the different diffusion properties of the fluids, the sensed electrical potential at sensor terminal 224a can starts rising at time TIA, the sensed electrical potential at sensor terminal 224b starts rising at time T1B, and the sensed electrical potential at sensor terminal 224c starts rising at time TIC. The diffusion time of the first fluid can be represented by the difference of T1AT0, the diffusion time of the second fluid can be represented by the difference of T1B-T0, and the diffusion time of the third fluid can be represented by the difference of TIC-T0. As explained above, because fluidic structure 404 can have a small footprint, the diffusion of the different fluids in fluid cavities 408a, 408b, and 408c can be subject to the same conditions (e.g., same temperature, humidity, and pressure, as well as unchanged flow path cross section and surface), which can reduce the effect of ambient condition variation on the diffusion measurement. Further, because the sensor terminals and the ISFETs are part of a monolithic integrated circuits, the mismatches among the sensor terminals and the ISFETs can be reduced, which can reduce the effect of circuit mismatches on the diffusion measurement. Accordingly, the outputs of microfluidic sensor 400 can reflect the actual diffusion properties of the fluids being tested. All these can improve the robustness and measurement accuracy of microfluidic sensor 400.

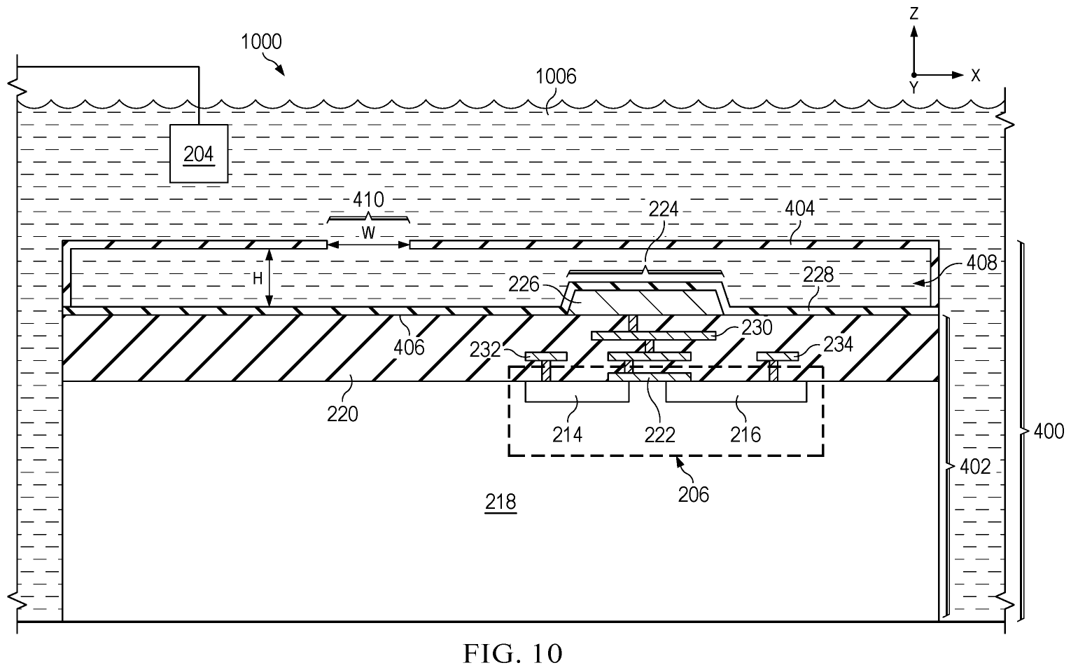

In some examples, microfluidic sensor 400 can be configured to provide a pH measurement of a fluid. FIG. 10 is a schematic illustrating a cross-section of an example microfluidic sensor 1000 including components of microfluidic sensor 400 of FIG. 4. Referring to FIG. 10, microfluidic sensor 1000 can include an integrated circuit having various components of microfluidic sensor 400, such as fluidic structure 404 on semiconductor die 402, the fluidic structure 404 enclosing fluid cavity 408 and including opening 410, and sensor terminal 224 coupled to ISFET 206. Fluid sensor 1000 can also include reference electrode 204. Both the integrated circuit and reference electrode 204 can be submerged/exposed to a same fluid 1006, and fluid 1006 can enter fluid cavity 408 and be in contact with sensor terminal 224. Reference electrode 204 can be driven by a signal generator (e.g., signal generator 302) to a known electrical potential. As explained in FIG. 3A and FIG. 3B, if the electrical potential of the reference electrode is known, the sensed electrical potential of ISFET 206 can provide a measurement of the surface potential at the interface between sensor terminal 224 and fluid 1006, and the surface potential measurement can indicate a concentration (or activity) of the hydrogen ion, which can provide a pH measurement. In FIG. 10, reference electrode 204 is illustrated as a discrete component separate from semiconductor die 402. As to be described below, reference 204 can be replaced with an electrode integrated in semiconductor die 402 as part of the package or the wafer fabrication.

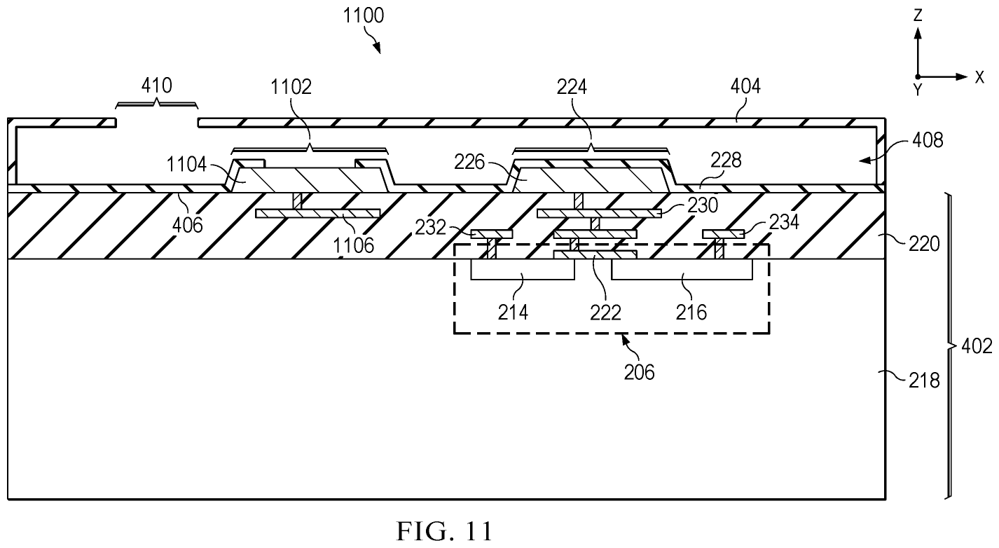

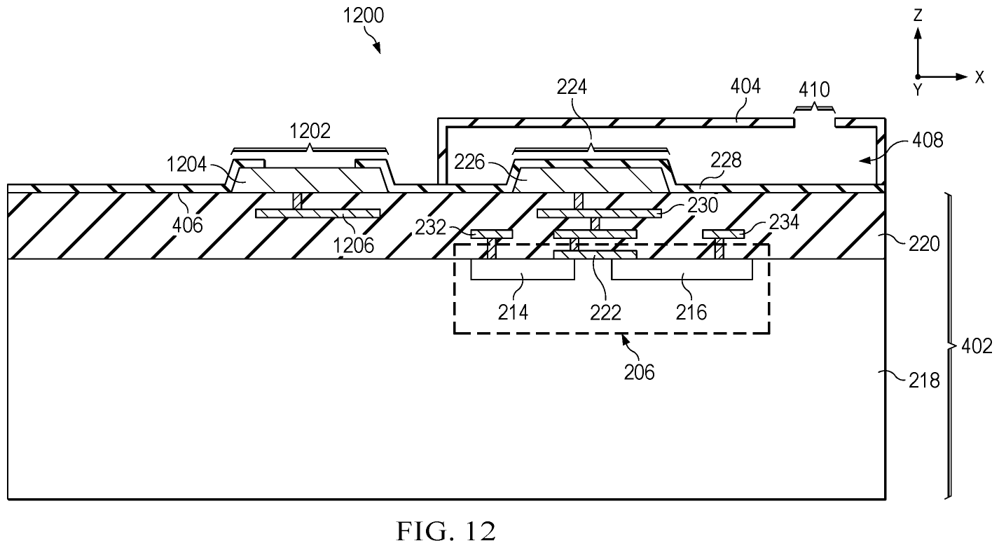

FIG. 11 and FIG. 12 illustrate examples of microfluidic sensors having integrated reference electrodes to provide pH measurements. Referring to FIG. 11 and FIG. 12, each of microfluidic sensors 1100 and 1200 can be an integrated circuit having various components of microfluidic sensor 400, such as fluidic structure 404 on semiconductor die 402, the fluidic structure 404 enclosing fluid cavity 408 and including opening 410, and sensor terminal 224 coupled to ISFET 206. In addition, microfluidic sensor 1100 can include a voltage terminal 1102, and microfluidic sensor 1200 can include a voltage terminal 1202. Voltage terminals 1102 and 1202 can be formed on sensing side 406 of dielectric layer 220 as part of the integrated circuit. Voltage terminal 1102 can include an electrode 1104 partially covered by insulation layer 228, and voltage terminal 1202 can include an electrode 1204 partially covered by insulation layer 228. In some examples, voltage terminals 1102 and 1202 can be reference electrodes integrated with semiconductor die 402, and can replace a discrete reference electrode 204. In some examples, electrodes 1104 and 1204 can be coated with or made of Platinum or another noble or electrochemically stable metal, if configured for differential sensing as shown later. In some examples, electrodes 1104 and 1204 or they can be configured as a reference electrode, and these electrodes can be made of a metal with a certain stable redox potential with regards to the fluids under test. For example, for solutions with a stable chlorine content, electrodes 1104 and 1204 can include silver and coated with a silver chloride layer. As another example, electrodes 1104 and 1204 can include copper and coated with a copper sulfate layer. In some examples, electrodes 1104 and 1204 can be part of an aqueous reference electrode. Electrodes 1104 and 1204 can be coupled to, respectively, interconnects 1106 and interconnect 1206 in dielectric layer 220, where interconnects 1106 and 1206 can be part of the metallization structure including interconnects 230, 232, and 234. In FIG. 11, voltage terminal 1102 can be enclosed in fluidic structure 404 with sensor terminal 224, and in FIG. 12, voltage terminal 1202 can be external to fluidic structure 404. In some examples, voltage terminal 1202 can be in another cavity separate from (and disconnected from) cavity 408.

In some examples, voltage terminals 1102 and 1202 can be coupled to a signal source (e.g., signal source 302) via respective metal interconnects 1106 and 1206. Responsive to a signal from the signal source, voltage terminals 1102 and 1202 can set the electrical potentials of a fluid in fluid cavity 408 and of gate terminal 224. The signal source can be implemented in semiconductor die 402 or as an external component. In some examples, voltage terminals 1102 and 1202 can be configured as reference electrode 1002 to provide a precise electrical potential. By integrating the reference electrode into the integrated circuit, the size of the microfluidic sensor can be further reduced.

FIG. 13 illustrates another example of microfluidic sensors that can also provide pH measurements. Referring to FIG. 13, a microfluidic sensor 1300 can be an integrated circuit having various components of microfluidic sensors 1100/1200, such as fluidic structure 404 on semiconductor die 402, the fluidic structure 404 enclosing fluid cavity 408 and including opening 410, and sensor terminal 224 coupled to ISFET 206. In the example of FIG. 13, microfluidic sensor 1300 also includes voltage terminal 1102 in fluid cavity 408, while in other examples, microfluidic sensor 1300 can include voltage terminal 1202 external to fluid cavity 408.

Also, microfluidic sensor 1300 includes a sensor terminal 1306 external to fluid cavity 408, and an ISFET 1308 in semiconductor die 402. Sensor terminal 1306 can be on sensing side 406 and includes an electrode 1309 covered by insulation layer 228. ISFET 1308 includes a gate 1310 and source and drain terminals 1312 and 1314. Electrode 1309 can be made of Platinum. Microfluidic sensor 1300 includes an interconnect 1320 coupled between gate 1310 and electrode 1309, an interconnect 1322 coupled to source terminal 1312, and an interconnect 1324 coupled to drain terminal 1314. Interconnects 1320, 1322, and 1324 can be part of a metallization structure in dielectric layer 220 including interconnects 1106, 230, 232, and 234.

ISFETs 206 and 1308 can perform a differential sensing operation to provide a pH measurement of a fluid. With differential sensing, ISFETs 206 and 1308 can output an electrical potential difference representing a pH difference between a first fluid to be measured and a second fluid having a known pH value. Because the electrical potential provided by voltage terminal 1102 can be cancelled in the electrical potential difference, the electrical potential provided by voltage terminal 1102 needs not be precisely controlled or known. Further, because ISFETs 206 and 1308 are fabricated as part of a monolithic integrated circuit, mismatches between the ISFETs can be reduced. All these can relax the implementation and control of voltage terminal 1102 without degrading the pH measurement accuracy.

In some examples, sensor terminal 1102 of FIG. 13 is less than 250 micrometers (um) from opening 410 if it is in fluid cavity 408, and less than 0.5 mm from the opening if external to fluid cavity 408. Sensor terminal 224 can be more than 1 mm from opening 410.

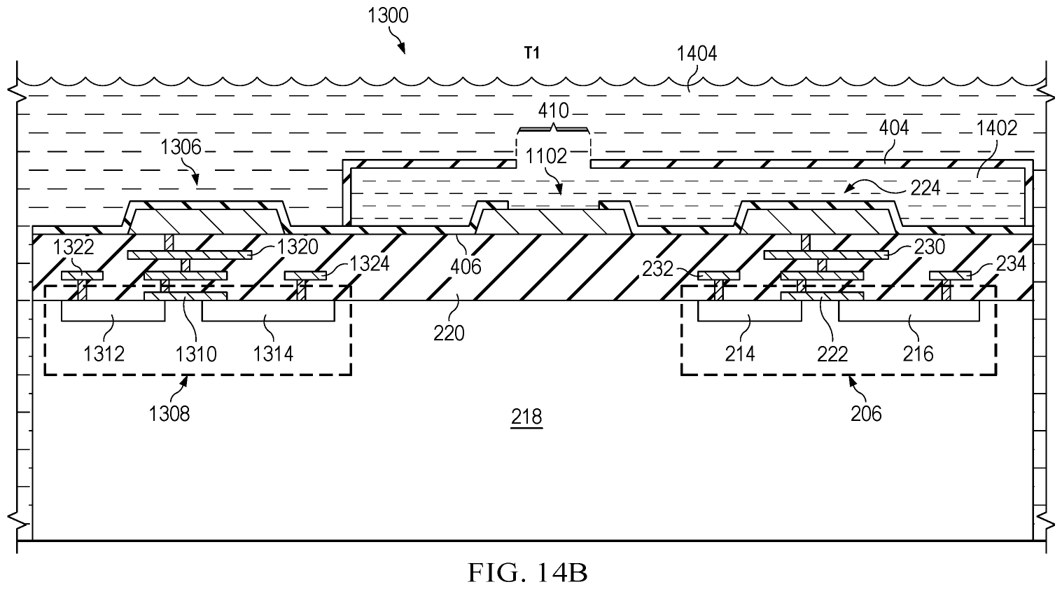

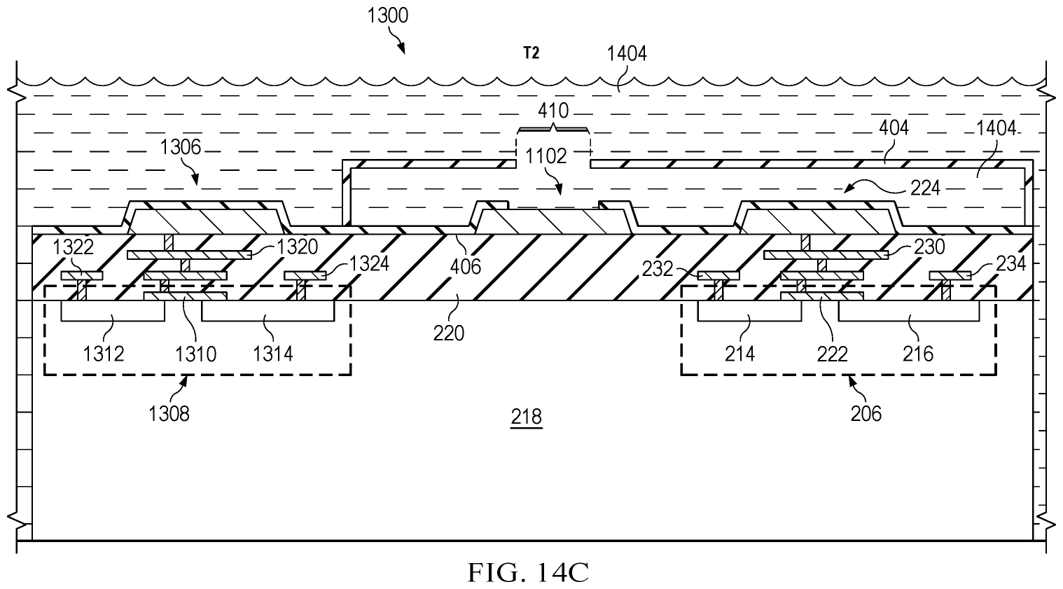

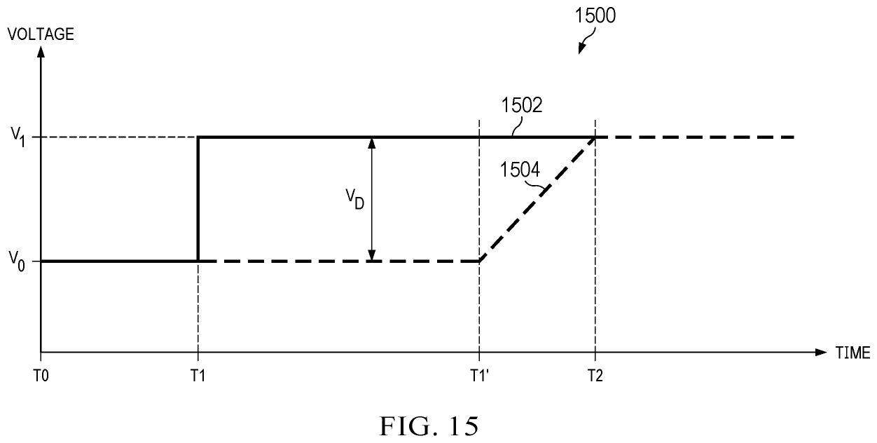

FIGS. 14A, 14B, and 14C illustrate an example sequence of operations of microfluidic sensor 1300 in performing differential sensing, and FIG. 15 illustrates graphs 1502 and 1504 representing the variations of the respective outputs of ISFETs 206 and 1308 with time. Microfluidic sensor 1300 can be positioned in a fluid container, such as fluid containers 104 and 510 and an IC package having an opening (e.g., package 502).

Referring to FIG. 14A, at time T0, the fluid container may carry a fluid 1402, and sensing side 406 of microfluidic sensor 1300 can be exposed to fluid 1402. Fluid 1402 can be a reference fluid or reference buffer of a known pH_{Ref}. Fluid 1402 can be a pH buffer of high ionic strength and can have a relatively high concentration of K+ and Cl− ions. Fluid 1402 comes into contact with sensor terminal 1306. Also, fluid 1402 can enter fluid cavity 408 via opening 410 and come into contact with sensor terminal 224. Because sensor terminals 224 and 1306 are both exposed to the same fluid 1402, ISFETs 206 and 1308 can provide a voltage of V₀, which can include a first component representing an electrical potential of voltage terminal 1102 (V_{G}), and a second component representing the pH-dependent surface potential of the sensor terminals 224 and 1306, as follows:

V₀=b×(V_{G}+V(pH₀))=b×(V_{G}+SpH₀) (Equation 4)

In Equation 4, b represents the capacitive divider ratio between a capacitance between voltage terminal 1102 and a sensor terminal (e.g., sensor terminals 224 or 1306) across fluid 1402. V(pH₀) represents the surface potential at sensor terminals 224 and 1306 when in contact with fluid 1402 having a pH value of pH₀.

Referring to FIG. 14B, at time T1, fluid 1402 in the fluid container can be replaced with a fluid 1404 for which the pH is to be measured. Fluid 1402 in fluid container 104 can be replaced by convection, or by other means faster than microfluidic diffusion. Sensor terminal 1306, which is external to fluidic structure 404, can be exposed to fluid 1404 at time T1. Accordingly, ISFET 1308 can provide a voltage of V₁, which can include the same electrical potential of voltage terminal 1102 (V_{G}), and a new pH-dependent surface potential of the sensor terminal 1306, as follows:

V₁=b×(V_{G}+V(pH₁)+V_{Ljp})˜b×(V_{G}+S×pH₁) (Equation 5)

The values of b and V_{G} in Equation 5 are equal to those of Equation 4, while V(pH₁) represents the surface potential at sensor terminal 1306 when in contact with fluid 1404 having a pH value of pH₁. An additional term V_{Ljp} can arise due to a liquid junction potential forming across the diffusion zone, at the liquid boundary or liquid junction between the two fluids. Across the boundary of two pH buffers, the liquid junction potential is very small and hence neglected. This is especially the case if the first fluid has a much greater ionic strength than the other fluid, and the first fluid's ionic species of opposite charge have roughly identical mobility, such as is the case for a highly concentrated (e.g. 3M or 4M) solution of KCl. Moving on with the assumption of negligible V_{LJp}˜0 mV according to Equation 5, the differential sensing output, which can be represented by the voltage difference V_{D} between voltages V₀ and V₁, can be represented as follows:

V_{D}=V₁−V₀=b×S×(pH₁−pH₀) (Equation 6)

Assuming that pH₀ is known, the value of pH₁ can be determined from Equation 6. Also, as shown in Equation 6, the electrical potential of voltage terminal 1102 (V_{G}) is cancelled out in the differential sensing output. Therefore, V_{G} needs not be precisely controlled or known to determine pH₁. Accordingly, the implementation and control of voltage terminal 1102 can be relaxed without degrading the pH measurement accuracy, if a pH-independent voltage reference (or a substantially pH-independent voltage reference) can be provided by the measured electrical potential at ISFET 206.

Referring to FIG. 14C and FIG. 15, between time T1 and T1′, fluid 1404 may enter fluid cavity 408 via microfluidic diffusion across opening 410, and propagate to sensor terminal 224 via microfluidic diffusion within fluid cavity 408. The duration between T1 and T1′ can be based on the distance between opening 410 and sensor terminal 224 (represented by channel length of FIG. 7). At time T1', the ions of fluid 1404 start to arrive at sensor terminal 224, and the sensed electrical potential of ISFET 206 starts to rise. At time T2, an equilibrium state is reached, and ISFET 206 and ISFET 1308 can sense the same electrical potential V₁. If the first fluid 1402 is buffered around its pH₀, then significant pH change can be delayed until the buffer capacity of 1402 is overcome. Various techniques are described to minimize (or at least reduce) the liquid junction potential component can be minimized (or at least reduced), and to maximize (or at least increase) the diffusion time T1′-T1 to ensure that the electrical potential measured by ISFET 206 is at V₀ when the differential sensing is performed. All these can ensure (or increase the likelihood of) the measured electrical potential at ISFET 206 providing a stable and pH-independent voltage reference for differential sensing.

In some examples, the first fluid can be a reference buffer, containing a highly concentrated solution where ionic strength is defined by KCl added to a pH buffer solution. As to be described below, the mixing of the KCl with the fluid to be measured can eliminate/reduce the liquid junction potential component. The pH buffer solution can be a single weak electrolyte (weak acid or base) or a relatively strong titrant (strong acid or base, respectively). For example, an acetate buffer is constructed by titration of an acetic acid (weak acid) solution with sodium hydroxide, Tris, or sodium acetate (strong bases), to a pH₀ at the pKᵢ of the weak acid ion species i, with pKᵢ related to the dissociation constant Kᵢ as pKᵢ=-log₁₀ Kᵢ. High buffer capacity is achieved by a high concentration of the buffering species. High buffer capacity can maximize (or at least increase) the diffusion time T1′-T1, which can provide pH-independent voltage reference. To prevent the buffer solution from diffusing out of fluid cavity 408 during the long diffusion time, control device 412 can be closed during intervals when no voltage reference is required, e.g. during idle phases when no measurement is conducted by the IC. Selection of buffer chemistry and pH₀ is driven by the application.

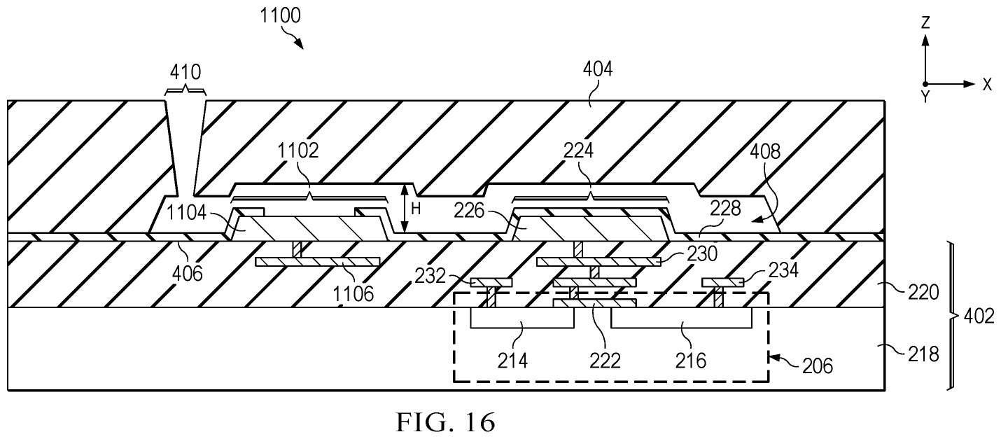

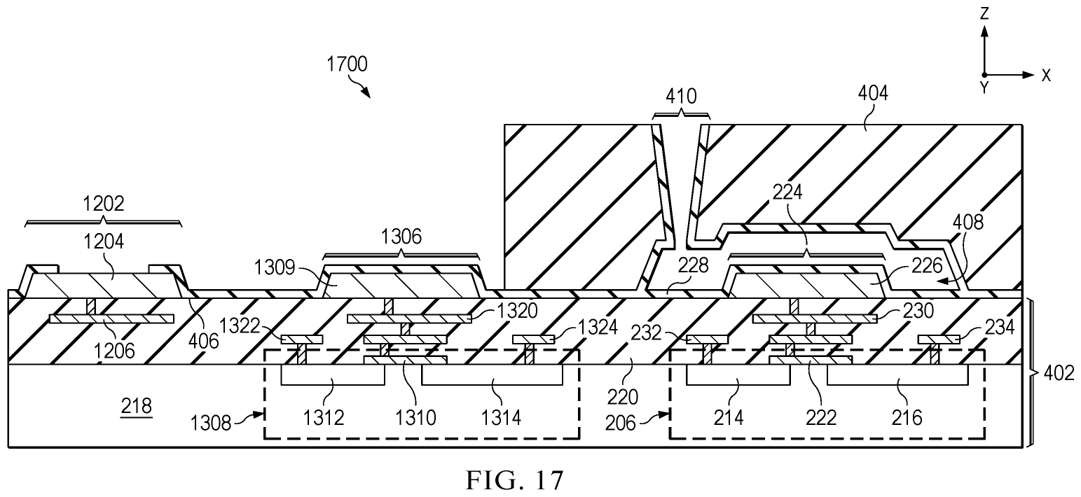

FIG. 16 and FIG. 17 are schematics illustrating examples of fluidic structure 404. FIG. 16 illustrates an example of fluidic structure 404 of microfluidic sensor 1100 of FIG. 11, and FIG. 17 illustrates an example of fluidic structure 404 of microfluidic sensor 1300 with voltage terminal 1202 external to fluidic structure 404.

Referring to FIG. 16, fluidic structure 404 can include an insulation material, such as Silicon Dioxide (SiO₂), Silicon Nitride (Si₃N₄), etc. Additional examples of insulation material can include Aluminum Oxide (Al₂O₃), Titanium Oxide (TiO₂), Tantalum pentoxide (Ta₂O₅), Silicon oxynitride (SiON), etc., and the insulation material can be doped with certain atoms such as Phosphorus and Boron (e.g., Borophosphosilicate glass (BPSG). In some examples, the insulation material can enclose a metal, such as Platinum and/or Titanium. In some examples, fluidic structure 404 can be formed on semiconductor die 402 as a passivation layer. In some examples, fluidic structure 404 can include a dielectric structure formed on another semiconductor die/wafer, and then transferred over onto semiconductor die 402. The height and thickness of fluidic structure 404 can define the height (H) of fluid cavity 408. The height and/or thickness of fluidic structure 404 may also vary to accommodate various internal structures in fluid cavity 408, such as sensor terminal 224 and voltage terminal 1102. In some examples, fluidic structure 404 can be planarized (e.g., by a chemical-mechanical polishing (CMP) operation) to include a planar surface. The planarization of fluidic structure 404 can improve the mechanical robustness of fluidic structure 404 and facilitate uniform flow of fluid across the planar surface. The planarization can also facilitate sealing in subsequent packaging steps. For example, in a case where fluidic structure 404 interfaces with a package, the planar surface can facilitate sealing of the interface with an elastomer like an o-ring.

Also, referring to FIG. 17, in some examples, the internal surface of fluid cavity 408 the sidewalls of opening 410, and sensing side 406 can be covered with the same insulation layer 228. Such arrangements can provide a uniform wetting surface. This can reduce measurement error caused by Zeta potential difference due to the fluid being measured/sensed is in contact with two different wetting surfaces. For the rest of the figures, illustration of insulation layer 228 covering the internal surface of fluid cavity 408 the sidewalls of opening 410 are omitted for brevity. In some examples, not shown here, the outer surface of fluid cavity may also be covered with insulation layer 228. In other examples, the outer surface intentionally is of different, e.g. hydrophobic material, so that fluid may be guided into the cavity more easily.

As explained above, after being exposed to a reference fluid, microfluidic sensor 1300 can perform differential sensing by restricting/delaying the diffusion of a new fluid into fluid cavity 408, so that two sensor terminals can be in contact with different fluids at the same time. Differential sensing can be performed prior to the new fluid reaching sensor terminal 224, such as between times T1 and T1′ of FIG. 15.

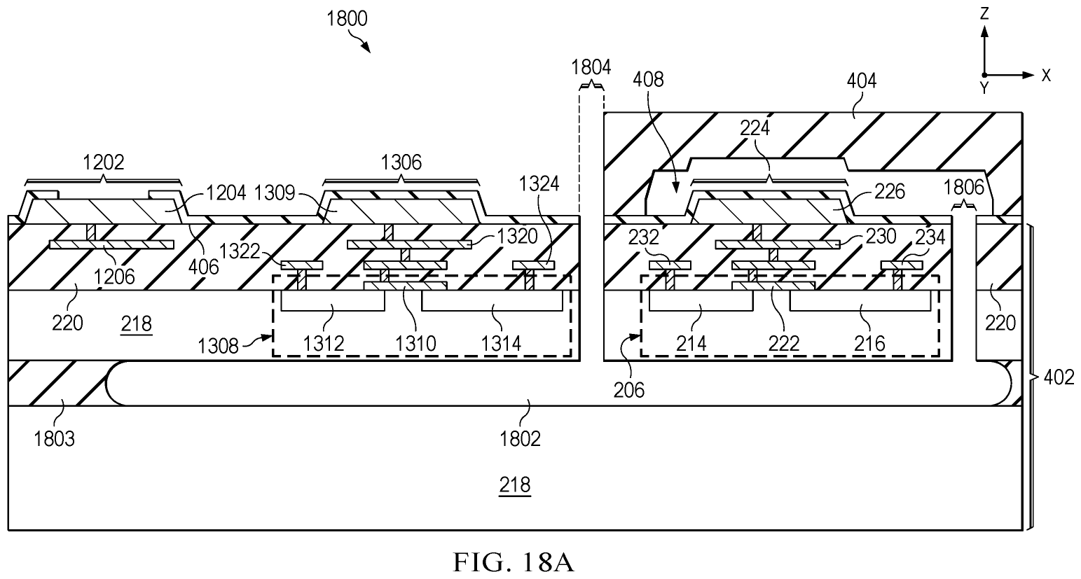

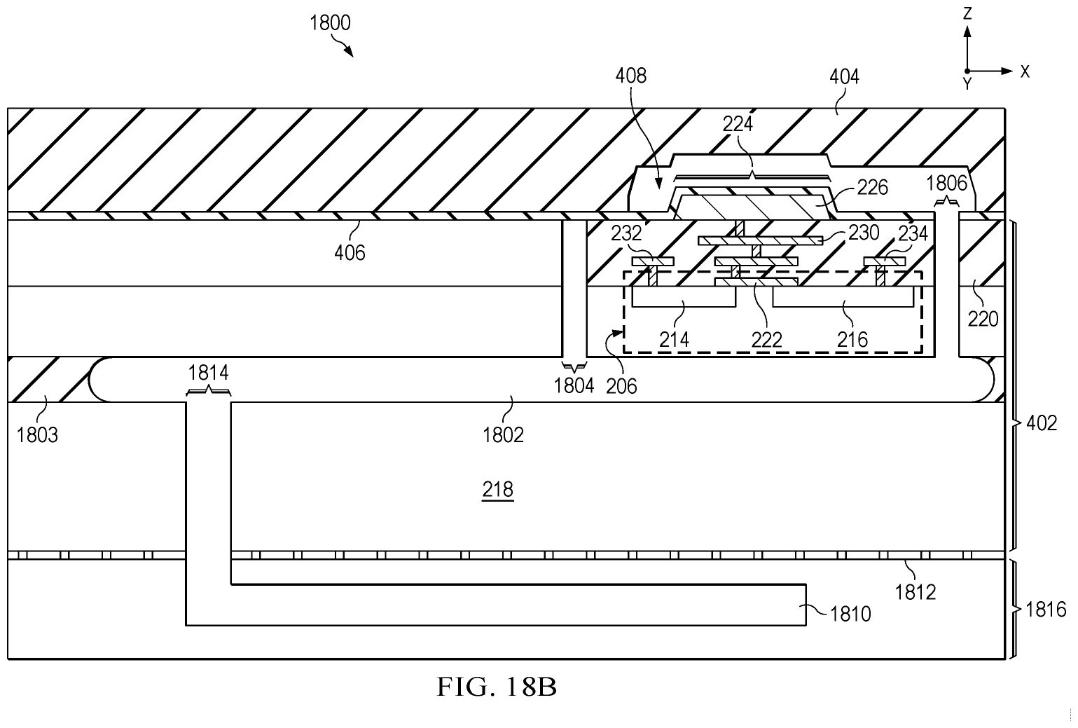

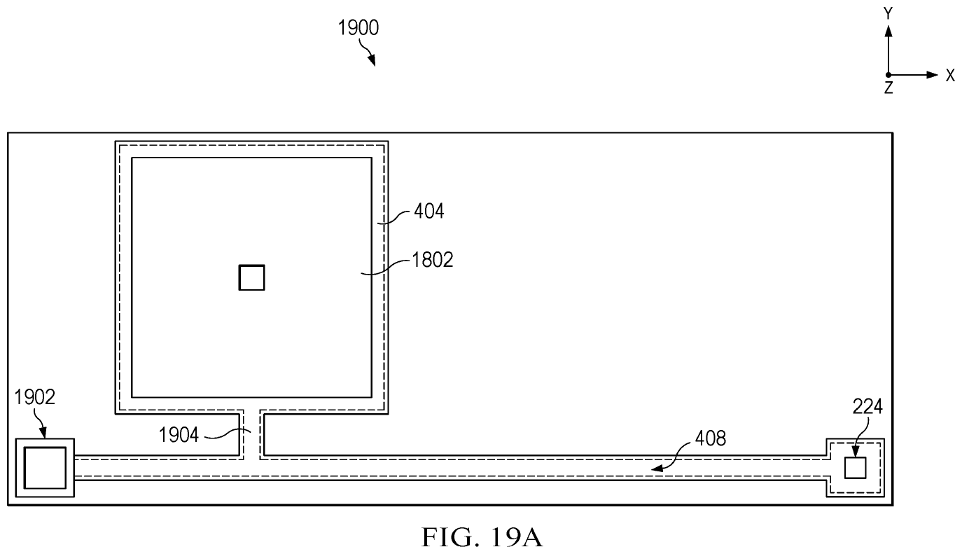

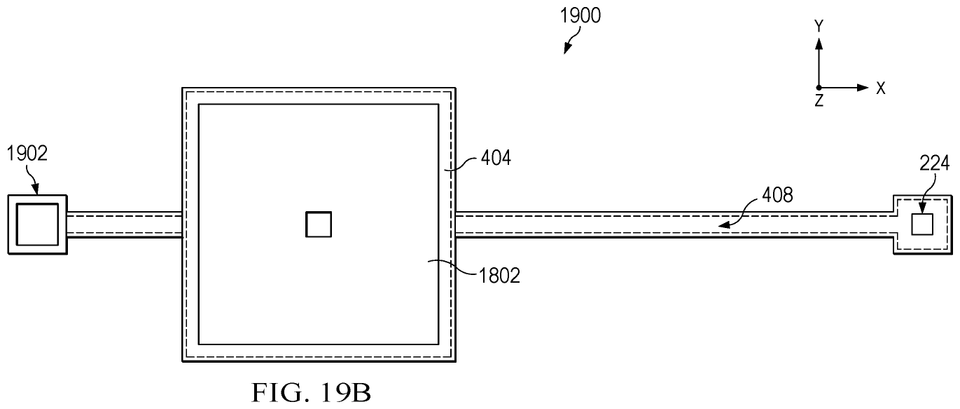

As explained above, one way to increase the diffusion time is to include a buffer solution having a high buffer strength in fluid cavity 408, and have the fluid diffuse/mix with the buffer solution. Another way to increase the diffusion time is by including an additional fluid cavity (e.g., a reservoir) between the opening and the sensor terminal to further delay the flow of the fluid to the sensor terminal. FIG. 18A, FIG. 18B, FIG. 19A, and FIG. 19B are schematics illustrating example microfluidic sensors that can further restrict/delay the diffusion of fluid into fluid cavity 408. FIG. 18A and FIG. 18B illustrate cross-sectional views of examples of microfluidic sensor 1800. FIG. 19A and FIG. 19B illustrate cross-sectional views of examples of microfluidic sensor 1900.

Referring to FIG. 18A, microfluidic sensor 1800 can be part of an integrated circuit having various components of microfluidic sensors of FIGS. 4-17, such as fluidic structure 404 on semiconductor die 402, the fluidic structure 404 enclosing fluid cavity 408, and sensor terminal 224 coupled to ISFET 206 and enclosed in fluid cavity 408. Microfluidic sensor 1800 also includes sensor terminal 1306 and voltage terminal 1202 on sensing side 406 of dielectric layer 220 and external to fluidic structure 404.

In addition, each of microfluidic sensors 1800 and 1900 includes a fluid cavity 1802 coupled to fluid cavity 408. Fluid cavity 1802 can be configured to provide an additional reservoir or buffer to store the reference fluid. By providing an additional reservoir or buffer, the time of diffusion of the new fluid into cavity 408 and reaching sensor terminal 224 can be further extended, which can provide more time to the ISFETs to perform the differential sensing.

In some examples, as shown in FIG. 18A, fluid cavity 1802 can be in substrate 218. For example, substrate 218 can be a silicon-insulator-silicon substrate and include an insulation layer 1803 (e.g., a layer of Silicon Dioxide) in substrate 218. Fluid cavity 1802 can be in insulation layer 1803 and below cavity 408, so that fluid cavities 408 and 1802 form a vertical stack. Microfluidic sensor 1800 also includes openings 1804 and 1806 on sensing side 406 through substrate 218 to fluid cavity 1802. Opening 1804 can be external to fluidic structure 404 to couple between fluid cavity 1802 and the exterior of fluidic structure 404, and opening 1806 can be below fluidic structure 404 to couple between fluid cavities 408 and 1802. A fluid can enter fluid cavity 1802 via opening 1804, and flow into cavity 408 via opening 1806.

In some examples, as shown in FIG. 18B, microfluidic sensor 1800 can include an additional reservoir 1810 on a side 1812 of semiconductor die 402 opposite from the sensing side 406. Semiconductor die 402 also includes an opening 1814 that extends between fluid cavity 1802 and 1810 through side 1812. In some examples, sensing side 406 can be a front side of semiconductor die 402, side 1812 can be a back side of semiconductor die 402. Microfluidic sensor can include a glass wafer 1816 (or a glass structure) enclosing reservoir 1810 mounted on side 1812, which can provide a planar surface for mounting glass wafer 1816.

In some examples, as shown in FIG. 19A, fluid cavity 1802 can be positioned laterally relative to cavity 408 on sensing side 406 of dielectric layer 220, and both fluid cavities 408 and 1802 can be enclosed by fluidic structure 404. In the example of FIG. 19, fluidic structure 404 can include an opening 1902 over a first end of fluid cavity 408, and a fluid conduit structure (or a connection structure) 1904 coupled between fluid cavities 1802 and 408. Sensor terminal 224 can be on a second end of fluid cavity 408 opposite to the first end, and fluid conduit structure 1904 can be between opening 1902 and sensor terminal 224 to delay the flow of fluid to sensor terminal 224. In some examples, as shown in FIG. 19B, fluid cavity 1802 can be directly between opening 1902 and sensor terminal 224. In some examples, fluid cavity 1802, openings 1804, 1806, and 1902, and fluid conduit structure 1904 can have dimensions at the microscale, so that the fluid can move into fluid cavity 1802 and cavity 408 by microfluidic diffusion.

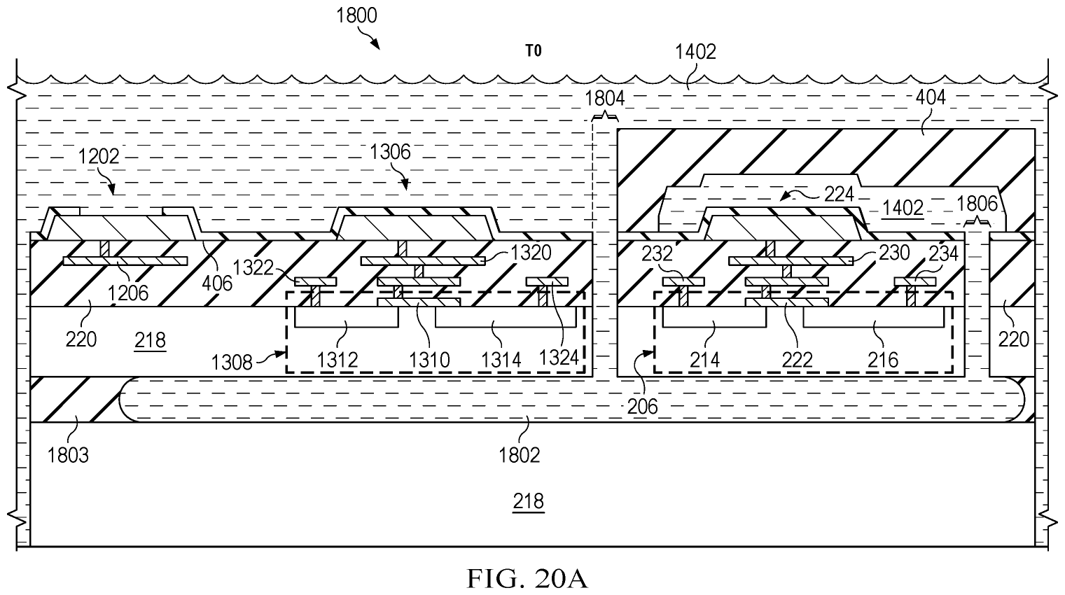

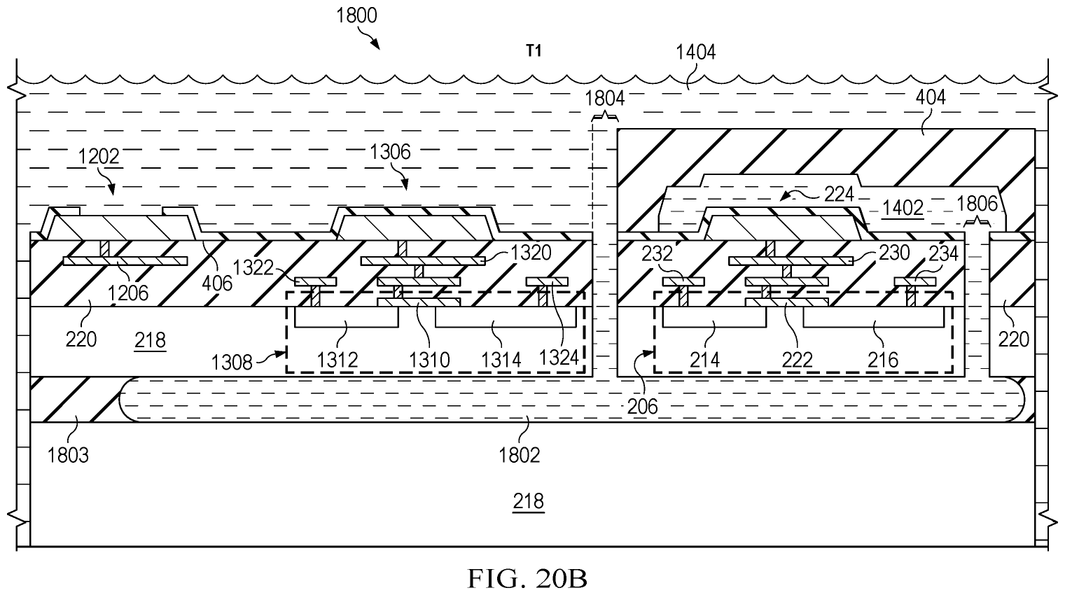

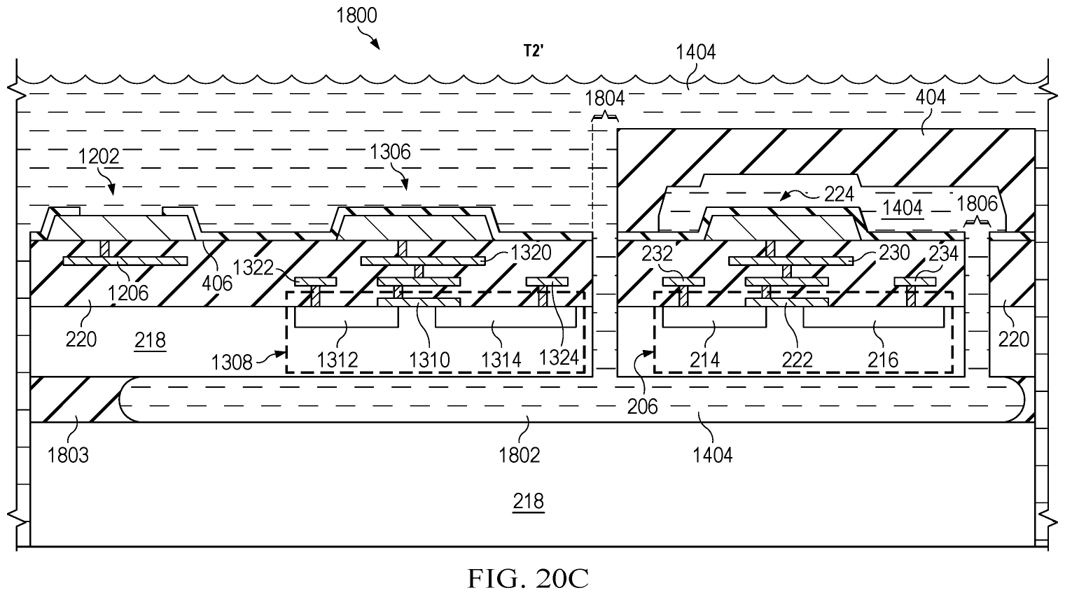

FIGS. 20A, 20B, and 20C illustrate an example sequence of operations of microfluidic sensor 1800 in performing differential sensing. Microfluidic sensor 1800 can be positioned in a fluid container, such as fluid container 104. Referring to FIG. 20A, at time T0, fluid container 104 may carry reference fluid 1402 with known pH, and fluid cavities 1802 and 408 are both filled with fluid 1402. Referring to FIG. 20B, at time T1, fluid 1402 in fluid container 104 can be replaced with new fluid 1404 for which the pH is to be measured. Sensor terminal 1306 comes into contact with new fluid 1404. But at that time both fluid cavities 1802 and 408 are still filled with fluid 1402. Accordingly, fluidic structure 404 and fluid cavity 1802 can stop new fluid 1404 from reaching sensor terminal 224 at time T1. New fluid 1404 can start diffusing into fluid cavity 1802 via opening 1804 and from fluid cavity 1802 to fluid cavity 408 via opening 1806. Referring to FIG. 20C, at time T2′, which can be much later than time T2 of FIG. 15, new fluid 1404 reaches cavity 408 and comes into contact with sensor terminal 224. The time difference between T1 and T2′ can be provided to ISFETs 206 and 1308 to perform the differential sensing.

In addition to pH measurement, a microfluidic sensor having an integrated microfluidic cavity (e.g., fluid cavity 408) can perform other operations involving microfluidic diffusion, such as detecting/measuring multiple types of ions in a fluid, mixing of fluids, measuring the strength of a buffer solution, separation of ions, etc.

FIG. 21 is a schematic illustrating an example microfluidic sensor 2100 that can detect/measure activities of a mixture of fluids. Referring to FIG. 21, microfluidic sensor 2100 can be an integrated circuit having various aforementioned components of a microfluidic sensor, such as fluidic structure 404 on semiconductor die 402, with the fluidic structure 404 enclosing fluid cavity 408 and including opening 410. Microfluidic sensor 2100 also includes sensor terminal 224 in fluid cavity 408, and ISFET 206 coupled to sensor terminal 224. In some examples, microfluidic sensor 2100 can include voltage terminal 1202 on sensing side 406 and external to fluidic structure 404. In some examples, microfluidic sensor 2100 may also include a reference electrode (e.g., reference electrode 1002) separated from semiconductor die 402.

In addition to ISFET 206, microfluidic sensor 2100 also includes an ISFET 2104 in semiconductor die 402. ISFET 2104 includes current terminals 2106 (e.g., a source terminal) and 2108 (e.g., a drain terminal), and a gate terminal 2110 in dielectric layer 220 and separated from substrate 218. Microfluidic sensor 2100 includes a sensor terminal 2120 on dielectric layer 220 and in fluid cavity 408. Sensor terminal 2120 can include an electrode 2122 covered with insulation layer 228. Electrode 2122 can be made of Platinum (or other noble metals) and can be coupled to gate terminal 2110 via an interconnect 2130, and drain and current terminals 2106 and 2108 each can be coupled to respective interconnects 2132 and 2134. Interconnects 2130, 2132, and 2134 can be part of a metallization structure including interconnects 230, 232, and 234 and encapsulated (or surrounded) by dielectric layer 220. In some examples, microfluidic sensor 2100 can include more than two sensor terminals in fluid cavity 408, and more than two ISFETs coupled to the respective sensor terminals.

In some examples, microfluidic sensor 2100 can support the aforementioned differential sensing operation, where sensor terminal 2120 is much closer to opening 410 than sensor terminal 224 and can sense a change in the electrical potential due to change of fluid than sensor terminal 224. Accordingly, sensor terminal 2120 can provide similar function as sensor terminal 1306 of FIG. 13. Also, in some examples, microfluidic sensor 2100 enables more precise detection/measurement of mixing dynamics of different fluids by providing sensor terminals at different diffusion distances from opening 410. As described above, the mixing of fluids can depend on multiple variables, such as ionic strength and pH difference, difference of concentration (activity) and mobilities of ionic species, and buffer capacity. For example, in microfluidic sensor 2100, sensor terminal 2120 is closer to opening 410 than sensor terminal 224. Such arrangement creates a shorter diffusion distance between opening 410 and sensor terminal 2120 than between opening 410. Each ISFET having a corresponding sensor terminal at a certain spatial location in fluid cavity 408, and can sense/measure a potential representing pH and liquid junction potential. When a new fluid 1404 is introduced, different ions can have different rates of diffusion in fluid cavity 408, and may arrive at the same sensor terminal at different times. As a mixture of different types of ions propagate within fluid cavity 408 to reach different sensor terminals, the local pH of the mixture of both fluids on top of each ISFET can vary over time. This spatiotemporal signature may ultimately be unique enough to be able to uniquely estimate concentrations of certain ionic species in the fluid mixture in fluid cavity 408, given a certain application.

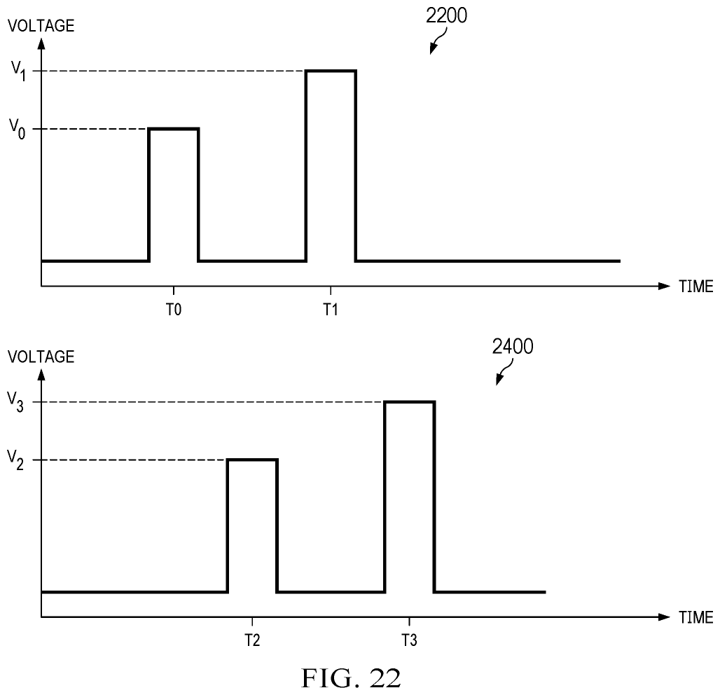

In certain instances, such as sequential introduction of fluids into cavity 408, or during application of electrochemical separation techniques such as electrophoresis, sensors can indicate concentration of certain particles/ions. FIG. 22 illustrates graphs 2202 and 2204 representing example output voltages of ISFETs 2104 and 206 in measuring a fluid including a mixture of two unknown types of ions. Graph 2202 can represent the example output voltage of ISFET 2104, and graph 2204 can represent the example output voltage of ISFET 206. Referring to graph 2202, at times T0 and T1, a potential difference V0 and V1 arising from a sharp concentration gradient of a known species of particles/ions at location ISFETs 2104 can be detected and, e.g. due to the controlled nature of the experiment, associated with a known species of particles/ions. Similarly, referring to graph 2204, at times T2 and T3, a potential difference V2 and V3 arising from a sharp concentration gradient of a known species of particles/ions at location ISFETs 206 can be detected.

A data processor (e.g., part of controller 106) can correlate between the voltage peaks sensed by ISFETs 206 and 2104 and determine that voltage peaks of V0 and V2 represent a first type of ion and voltage peaks of V1 and V3 represent a second type of ions, based on the voltage peaks of V0 and V1 having a similar magnitude and timing relationship as the voltage pulses of V2 and V3. The data processor may also compute the diffusion rate for each type of ions based on the time differences between the voltage pulses, and identify the type of ion based on the computed diffusion rate. The described potential differences or peaks may give an indication of the concentration of these two species, and may arise due to a pH gradient and/or liquid junction potential gradients such as described later, or as can be achieved by surface (bio-)functionalization such as salinization, deposited ion-selective membranes, or similar techniques.

In the example of FIG. 21, sensor terminals 2120 and 224 are positioned on the same side of opening 410 and along a diffusion path in fluid cavity 408 to provide different diffusion distances. FIG. 23 illustrates additional examples of arrangements of sensor terminals 2120 and 224 to provide different diffusion distances. In FIG. 23, the fluidic sensor can include a discrete or integrated reference electrode (e.g., reference electrode 204), or can include an integrated electrode (e.g., voltage terminals 1102 and 1202) to support differential sensing, both of which are not shown in FIG. 23 for brevity. FIG. 23 include schematics illustrating plan view of two additional examples of microfluidic sensors 2100. Referring to the left schematic of FIG. 23, fluidic structure 404 of microfluidic sensor 2100 can enclose two separate fluid cavities 408a and 408b and include two openings 410a and 410b. Opening 410a extends to fluid cavity 408a, and opening 410b extends to fluid cavity 408b. Also, referring to right schematic of FIG. 23, fluidic structure 404 of microfluidic sensor 2100 can enclose a fluid cavity 408a and include an opening 410, with sensor terminals 224 and 2120 on opposite sides of opening 410. In both examples, sensor terminal 224 can be spaced from opening 410a by a distance of D1, and sensor terminal 2120 can be spaced from opening 410b by a distance of D2, with D2 greater than D1. The different separation distances between the opening and the sensor terminals can provide different diffusion distances.

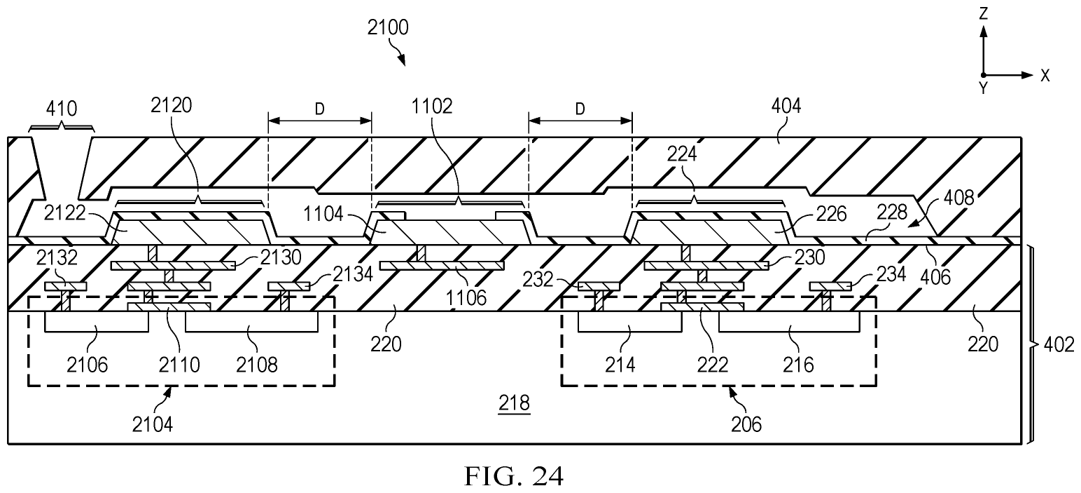

Also, in the example of FIG. 21, microfluidic sensor 2100 includes voltage terminal 1202 external to fluidic structure 404 (and fluid cavity 408). FIG. 24 illustrates an example of microfluidic sensor 2100 having voltage terminal 1102 (and electrode 1104) in fluid cavity 408. Voltage terminal 1102 can be positioned between sensor terminals 224 and 2120. In some examples, voltage terminal 1102 can be of equal distance (labelled D in FIG. 24) from each of sensor terminals 224 and 2120. Such symmetrical arrangements can cancel certain potential differences (such as so-called tip potentials commonly found in patch clamp experiments) between sensor terminals 224 and 2120, which can further improve the accuracy of measurements provided by ISFETs 206 and 2104.

In some examples, to facilitate separate measurement of multiple types of ions, fluidic sensor 2100 can include filtering mechanisms to separate between ions of different types (e.g., different sizes, different charge, etc.). In some examples, the filtering mechanism can be configured such that only ions of a particular type (e.g., having a particular size, charge, etc.) will be detected and measured.

FIGS. 25, 26A, 26B, 26C, 27, and 28 are schematics illustrating examples of microfluidic sensor 2100 including additional filtering (or flow control) mechanisms. In FIGS. 25, 26, 27, and 28, voltage terminals 1102/1202 (and/or reference electrodes) are omitted for brevity. Referring to FIG. 25, fluidic structure 404 can enclose separate fluid cavities 408a and 408b. Sensor terminal 224 can be enclosed in fluid cavity 408a, and sensor terminal 2120 can be enclosed in fluid cavity 408b. Fluidic structure 404 also includes an opening 410a that extends to fluid cavity 408a, and an opening 410b that extends to fluid cavity 408b. Openings 410a and 410b can have different widths to allow ions of certain charge or size to enter the respective fluid cavities 408a and 408b. In the example of FIG. 25, each of openings 410a and 410b can include a sieve/mesh structure, and each sieve opening 410a is wider than each sieve opening 410b. Accordingly, relatively large ions/particles can enter fluid cavity 408a via opening 410a, while only relatively small ions/particles can enter fluid cavity 408b. The effect of steric exclusion can prevent larger molecules, especially non-spherical macromolecules from entering a nanofluidic channel in the fluid cavity, as to be described below. In that way, the differential signal between fluid sensor 224 and 2120 can represent the potential (pH) difference created by “sieving” out certain ions or molecules of a certain charge or size.

Also, in FIG. 26A, fluidic structure 404 can include a fluidic structure 2602 coupled between a first portion 2604 of fluid cavity 408 and a second portion 2606 of fluid cavity 408, where sensor terminal 2120 is enclosed in first portion 2604 and sensor terminal 224 is enclosed in second portion 2606. Fluidic structure 2602 can define a channel 2608 having a reduced dimension (e.g., height H') compared with the dimension of the rest of fluid cavity 408 (e.g., height H). The dimension of fluidic structure 2602 can be configured so that ions or particles exceeding a particular size (referring to the hydrated ion) and/or of particular charge can remain in first portion 2604 of fluid cavity 408, and ions smaller than the particular size or of different charge can propagate to second portion 2606 of fluid cavity 408 via diffusion. The same restriction can also be achieved by vertical integration of openings of different size, such as in FIG. 25. The opening size is hence analogous to the reduced dimension H'.

In some examples, channel 2608 can be a nanofluidic channel, where nanofluidic effects start to play a role when electric double layers at the fluid-dielectric interface start to overlap. These effects should no longer be neglected when the dimension of the electric double layers, given by Debye length (the length where surface electrical potentials are shielded by a factor of 1/e with elemental charge e), is larger than 20*H'. With greater ionic strength, the Debye length decreases. For 1 mM NaCl, the Debye length is approximately 10 nm, and for physiological solutions of 150 mM ionic strength, it is approximately 0.7 nm. In some examples, channel 2608 can have a dimension at the nanoscale (e.g., 0.5-500 nanometers) to provide a nanofluidic channel (or a nanochannel). Sensor terminals 2120 and 224 can provide a measurement of a potential difference across the nanofluidic channel, and the potential difference can represent the change of a gradient (e.g., a potential gradient, a pH gradient, etc.) with time as the fluid propagate through the nanofluidic channel.

FIG. 26B is a schematic illustrating a plan view of another example of microfluidic sensor 2100. As shown in FIG. 26B, microfluidic sensor 2100 can include a reservoir 2620 and a reservoir 2630. Reservoir 2620 can be coupled to part of cavity 408 having sensor terminal 2120 via a fluid conduit structure 2622, and reservoir 2630 can be coupled to part of cavity 408 having sensor terminal 224 via a fluid conduit structure 2632. Microfluidic sensor 2100 also includes sensor terminals 2624 and 2634 in the respective reservoirs 2620 and 2630. Sensor terminals 2624 and 2634 can be coupled to respective ISFETs (not shown in FIG. 26B). Reservoirs 2620 and 2630, and sensor terminals 2624 and 2634, can be on sensing side 406 and are enclosed in fluidic structure 404. Reservoir 2620 and fluid conduit structure 2622 can be a split-off reference channel from fluid cavity 408, and reservoir 2630 and fluid conduit structure 2632 can be another split-off reference channel from fluid cavity 408.

Both reservoirs 2620 and 2630 can hold a fluid similar in its properties to the described fluid 1402 of FIG. 14, such as a reference buffer of high ionic strength, high concentration of K+ and Cl− ions, and stable pH_{Ref}. The fluid to be measured, after entering through opening 410, can diffuse through fluid conduit structures 2622/2632 and mix with the reference fluid or reference buffer in fluid cavity 408. As described in FIG. 14, such arrangements provide a pH-independent voltage reference, and can hence here in FIG. 26B be used to measure the potential difference in the fluid on the two ends of the nanofluidic structure 2602, which allows a more precise measurement of the potential difference in the fluid across the nanofluidic structure 2602. Specifically, differential sensing can be performed to measure a first pH difference between sensor terminals 2120 and 2624, and to effectively measure a pH difference between sensor terminals 224 and 2634:

V_{pH0}=V₂₆₂₄−V₂₁₂₀=b×S×(pH_{Ref}−pH₀) (Equation 7)

V_{pH1}−V₂₆₃₄−V₂₂₄=b×S×(pH_{Ref}−pH₁) (Equation 8)

Because there is negligible liquid junction potential at the boundaries to the KCl containing reference buffer, the potential difference V_{D} can be measured. An additional term V_{NF} may arise due to a potential gradient across the nanofluidic structure 2602 and add to the liquid junction potential V_{LJP} of the two fluids in fluid cavity 408 separated by 2602:

V_{D}−V₂₆₂₄−V₂₆₃₄−b×(V_{LJp}+V_{NF}) (Equation 9)

The potential difference across the nanofluidic structure 2602 can be based on a difference between the first and second potential differences, and the liquid junction potential component can be eliminated or at least attenuated in the difference.

FIG. 26C are schematics illustrating the plan view of additional examples of microfluidic sensors 2100a, 2100b, and 2100c having nanofluidic channel 2608. In FIG. 26C opening 410 is omitted for brevity. Reference electrode (if included) is also omitted for brevity. Referring to FIG. 26C, sensor 2100a can include a control terminal 2640 in nanofluidic channel 2608. Control terminal 2640 can include an electrode 2704 covered by insulation layer 228. Electrode 2704 can be made of Platinum and can be coupled to a signal generator circuit (not shown) via an interconnect 2706, which can be part of the metallization structure in dielectric layer 220. The signal generator circuit can be in semiconductor die 402 or can be external to the integrated circuit of microfluidic sensor 2100.

In some examples, control terminal 2640 can perform a filter operation by repelling ions of a particular size and/or polarity, to control the size and/or polarity of ions that flow across nanofluidic channel 2608 and measured by sensor terminals 224 and 2634. Control terminal 2640 can receive a DC voltage to generate an electric field to repel ions of a particular polarity. For example, if the control terminal 2640 receives a negative potential, it can generate an electric field to repel negative ions (e.g., anions such as Chloride (Cl−), Bromide (Br−), or Sulfate (SO42−) and prevent those negative ions from reaching sensor terminal 224, and those negative ions can be sensed by sensor terminal 2120. Also, if control terminal 2640 receives a positive potential, it can generate an electric field to repel positive ions (e.g., cations Sodium (Na+), Iron (Fe2+), Ammonium (NH4+)) and prevent those positive ions from reaching sensor terminal 224, and those positive ions can be sensed by sensor terminal 2120.

Also, microfluidic sensor 2100b can include a sensor terminal 2642 (coupled to an ISFET not shown in the figures) in nanofluidic channel 2608. Sensor terminal 2642 can provide measurement of a potential in nanofluidic channel 2608.

Further, microfluidic sensor 2100c can include a reservoir 2650 in addition to reservoirs 2620 and 2630 of FIG. 26B. Reservoir 2650 can be coupled to nanofluidic reference channel 2602 via a fluid conduit structure 2652, which can be a nanofluidic opening, and reservoir 2650 can also hold a 3M KCl solution to reduce/eliminate the effect of liquid junction potential. Microfluidic sensor 2100c can include a sensor terminal 2654 coupled to an ISFET (not shown in FIG. 26C) to provide differential sensing between sensor terminals 2640 and 2654, and the liquid junction potential component in the potential difference measured by sensor terminals 2640 and 2654 can be eliminated/attenuated by the mixing of the 3M KCl solution with the fluid(s) in nanofluidic channel 2608. Reservoir 2650 and fluid conduit structure/nanofluidic channel 2652 can form a split-off reference channel from nanofluidic channel 2608.

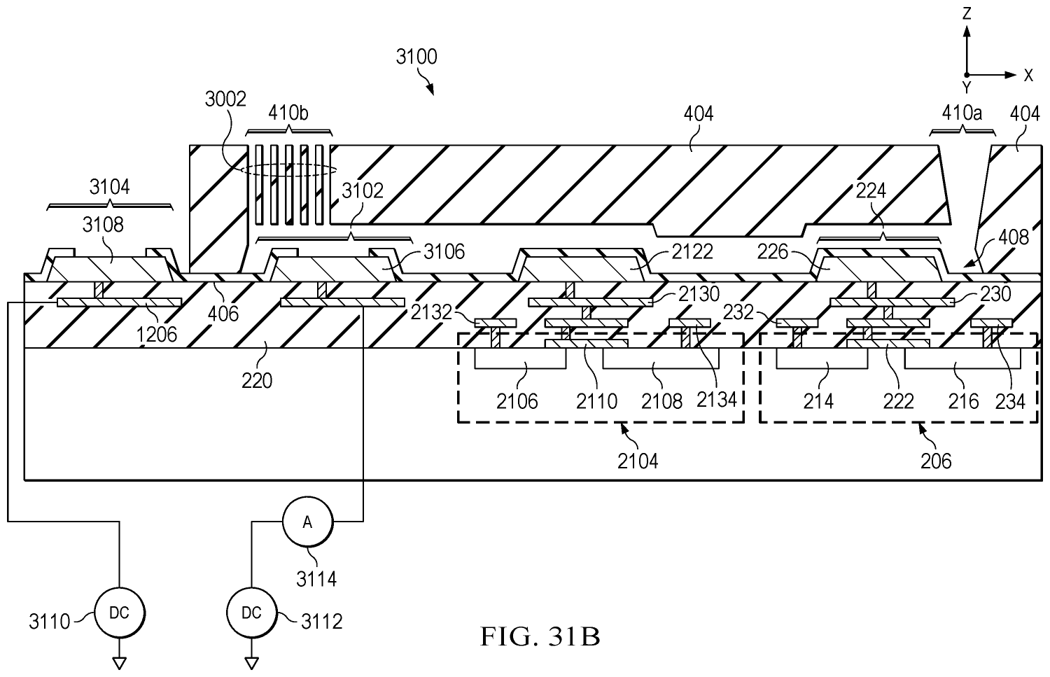

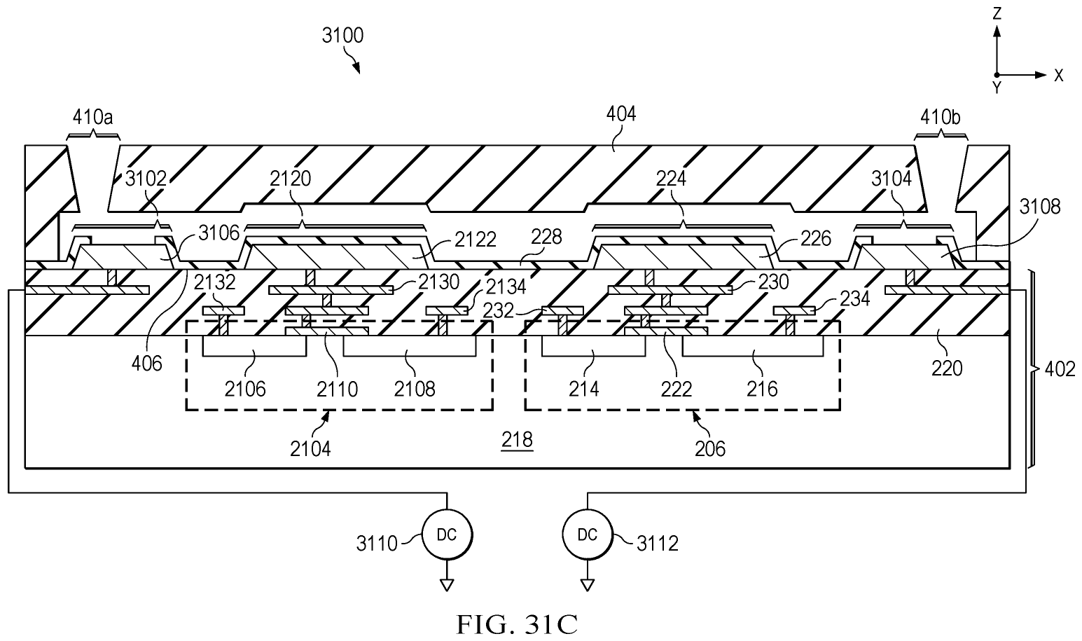

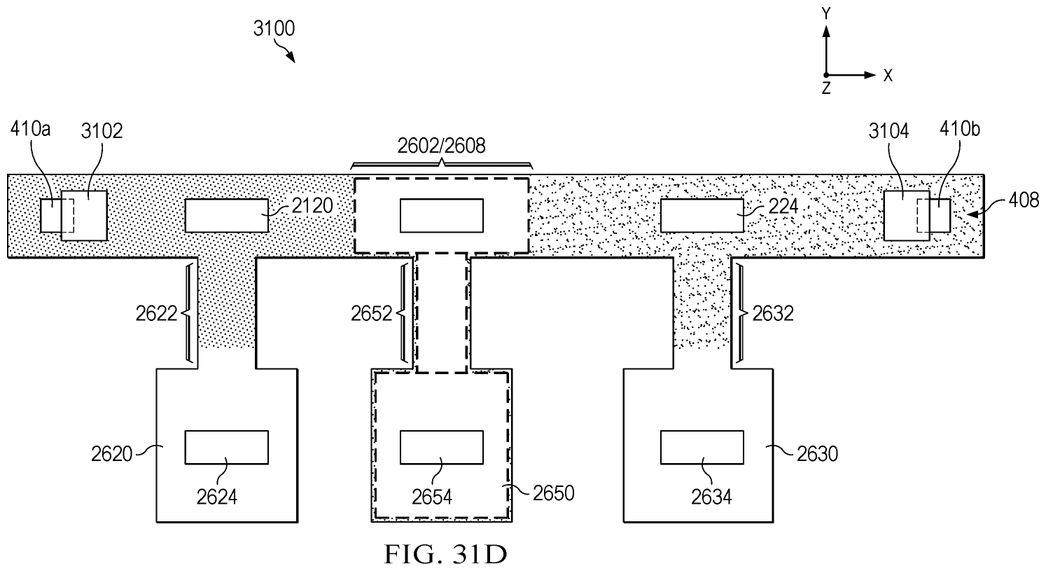

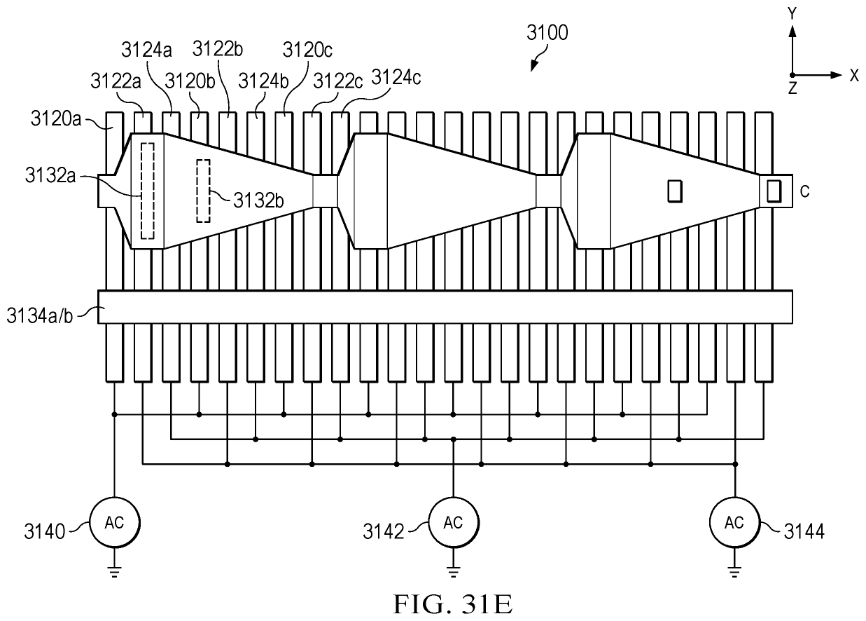

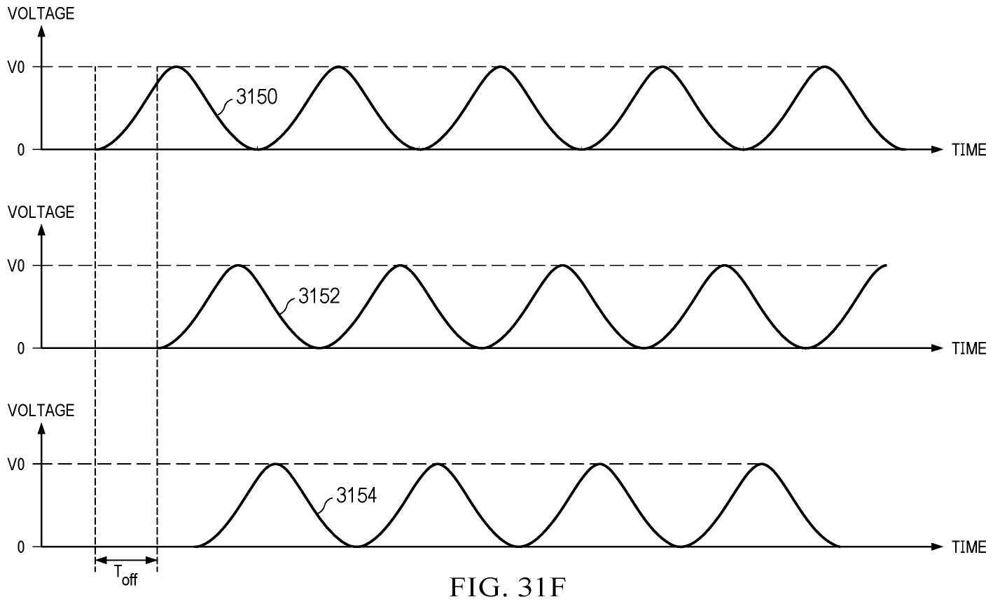

In some examples, control terminal 2640 can operate as a nanofluidic diode and generate an electric field that alters the Zeta potential between the electrode of control terminal 2640 and the fluid in fluid cavity 408, which in turn alters the force experienced by the ions in the fluid and modulates the flow of the ions in fluid cavity 408, which can create electrochemical gradients. In some examples, surface modulation, such as heterogeneous surfaces of different zeta potential, can also introduce rectifying effect as a voltage gated nanofluidic diode. In some examples, given an applied external electric field across the cavity 408, microfluidic sensor 2100 can operate as a flowFET or nanofluidic transistor such as shown below in FIG. 31D.

From an electrochemical standpoint, a nanofluidic diode can have similar (or identical) properties as a permselective membrane, which can include an organic porous membrane having a set of nanofluidic channels that limit diffusion of certain ionic species. A potential difference can be created between the cavities separated by the nanofluidic diode. This potential difference can be a Donnan potential, and can arise since certain ionic species are restricted from diffusing through the nanofluidic diode. The ISFETs coupled to 2624 and 2634 in FIG. 26B at the ends of fluid conduit structures 2622 and 2632 can measure the Donnan potential manifesting as V_{NF} of equation (9). In some examples, fluidic sensor 2100 can include an organic permselective membrane, such as a Nafion™ membrane, or an ionophore permeable only to certain ions (e.g. potassium or sodium). Such an organic permselective membrane may be locally arranged on top of or inside of a channel opening, or inside of the fluidic cavity 408, so that the Donnan potential V_{NF} can be measured in the described fashion. Biomimetic solid-state voltage-gated ion (or larger, e.g. bio-molecule) channels similar to biological nerve fibers can also be constructed by means of nanofluidic diodes (either vertically or laterally integrated), where ion impulses can create action potentials which are measurable in patch clamp experiments using micro-pipettes. Spatiotemporal potential measurement inside of such nanofluidic channels can be performed using split-off microfluidic reference channels and the ISFETs at the split-off channels in examples shown in FIGS. 26B and 26C. In both cases, an ISFET in the reservoir with a reference buffer (e.g., 3M KCl containing solution) at its end measures reference voltages, and the voltage can be pH-independent. The differential signal between an ISFET inside of a nanochannel of changing ionic content (due to mixing of fluids) and an ISFET inside of a connected, long nanochannel of non-changing ionic content (of the reference fluid) can give indication of the pH-independent potential inside of the nanofluidic channel 2608.

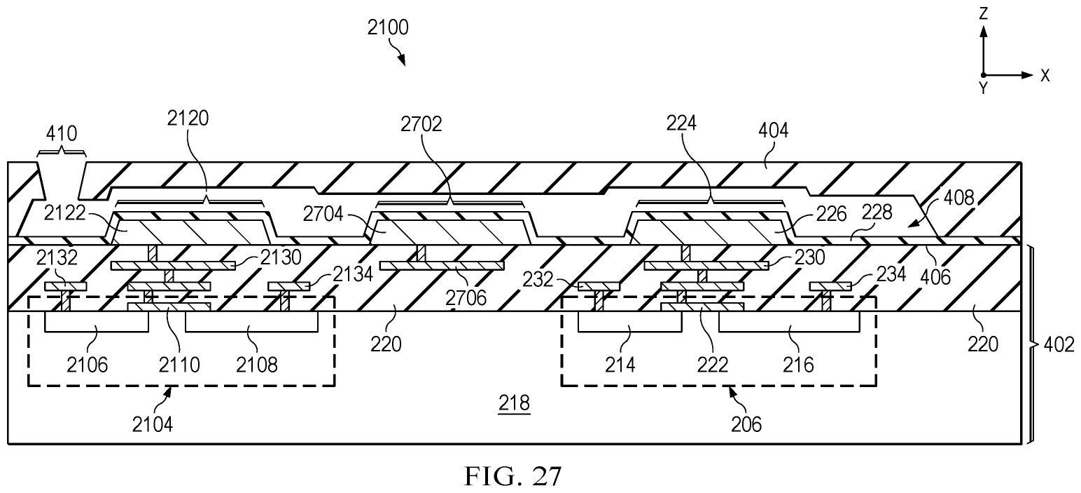

FIG. 27 is a schematic illustrating an example of microfluidic sensor 2100 having a control terminal 2702 on sensing side 406 and between sensor terminals 2120 and 224. The height of fluid cavity 408 above control terminal 2702 can be the same as other parts of fluid cavity 408, and control terminal 2702 can be in a microfluidic channel. Control terminal 2702 can include an electrode 2704 covered by insulation layer 228. Electrode 2704 can be made of Platinum and can be coupled to a signal generator circuit (not shown) via an interconnect 2706, which can be part of the metallization structure in dielectric layer 220. The signal generator circuit can be in semiconductor die 402 or can be external to the package integrated circuit of microfluidic sensor 2100. Control terminal 2702 can receive a DC voltage to repel ions of particular polarity and control the polarities of ions that propagate through the microfluidic channel and measured by sensor terminals 2120 and 224, as explained above.

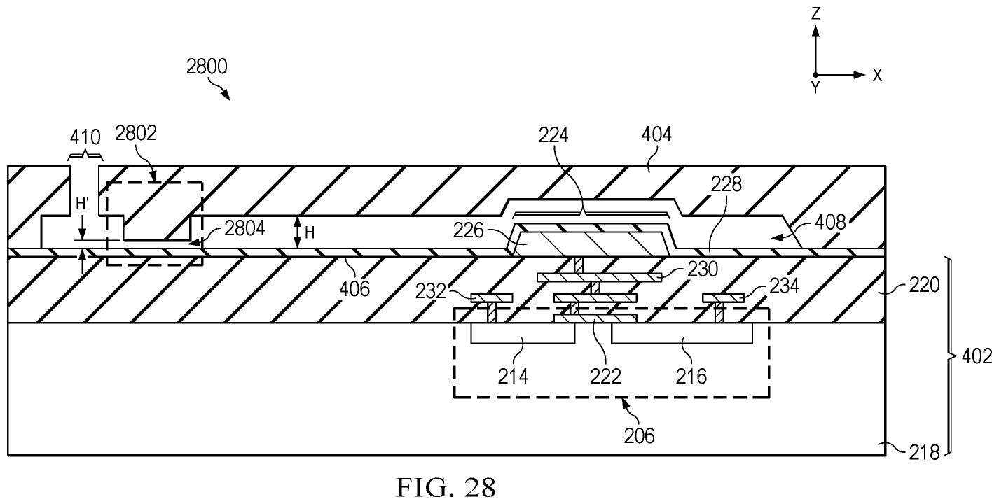

The aforementioned example filter mechanisms can also be implemented in a microfluidic sensor including a sensor terminal in fluid cavity 408, such as microfluidic sensors described in FIGS. 4-16. FIG. 28 is a schematic illustrating an example microfluidic sensor 2800, which is an integrated circuit and includes fluidic structure 404 enclosing fluid cavity 408. Reference electrode (if included) or electrodes for differential sensing are omitted in FIG. 28 for brevity. Microfluidic sensor 2800 also includes sensor terminal 224 in fluid cavity 408. Microfluidic sensor 2800 also includes a fluidic structure 2802 that defines a channel 2804 having a reduced dimension (e.g., height H') compared with the rest of fluid cavity 408. Fluidic structure 2802 can allow ions smaller than a particular size and/or charge to reach sensor terminal 224 and prevent (or restrict) ions larger than the particular size from reaching sensor terminal 224. In some examples, the size of opening 410 can be configured to allow ions of a particular size and/or charge to enter cavity 408 and reject ions larger than the particular size. Also, in some examples, fluidic structure 2802 can be replaced by (or combine with) field effect terminal 2702 of FIG. 27, which can provide an electric field to modulate the flow of ions through fluid cavity 408. In some examples, microfluidic sensor 2800 can include a sensor terminal and an ISFET below channel 2804 (not shown in FIG. 28) to measure the potential in channel 2804.

In some examples, a microfluidic sensor can include a pair of openings in fluidic structure 404 extending to a same fluid cavity 408. Multiple ISFETs can be positioned between the two openings. Examples of such a microfluidic sensor can also include circuits to perform various operations, such as to control the flow of fluid between the inlet and the outlet in fluid cavity 408, to perform calibration, to perform an electrophoresis operation to separate ions in the fluid, to perform an impedance spectroscopy operation, etc. In some examples, having multiple openings (e.g., two openings) can speed up the initial wetting of fluid cavity 408, since air in cavity 408 can be displaced when fluid enters one of the multiple openings first.

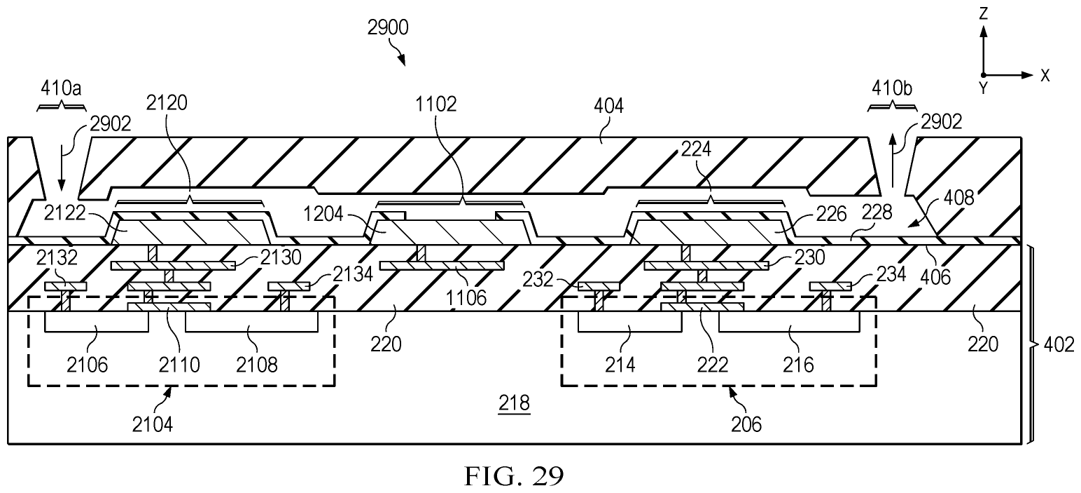

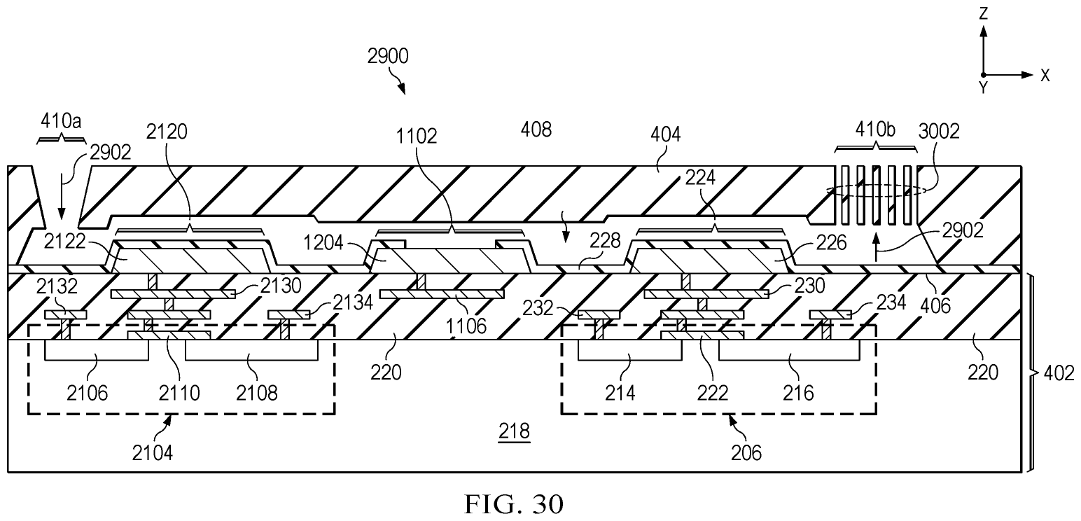

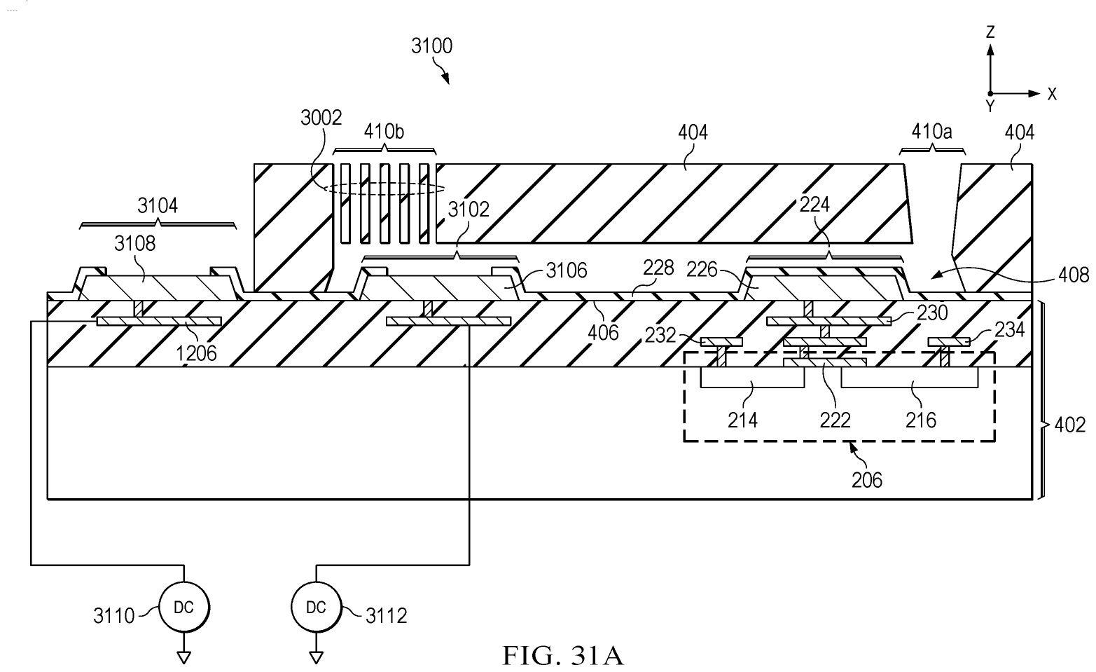

FIG. 29 and FIG. 30 illustrate examples of a microfluidic sensor 2900. Microfluidic sensor 2900 is an integrated circuit including fluidic structure 404. Microfluidic sensor 2900 also includes two openings 410a and 410b in fluidic structure 404. Both openings 410a and 410b extend to fluid cavity 408. Microfluidic sensor 2900 also includes sensor terminals 2120 and 224 and voltage terminal 1102 in fluid cavity 408. Opening 410a can be an inlet to allow a fluid 2902 to enter cavity 408, and opening 410b can be an outlet to allow fluid 2902 to exit cavity 408. In the example of FIG. 30, opening 410b can include an osmotic structure 3002 (e.g., a permselective membrane) to create a concentration gradient, which can facilitate the flow of the fluid out of cavity 408 through opening 410b via, for example, a diffusioosmotic process. In some examples, opening 410b may be of nanofluidic dimension, and its angle against sensing side 406 may be 90 degrees or tapered. In some examples, opening 410b include nanopores. Sensor terminal 2120 can be proximate opening 410a and further away from opening 410b than sensor terminal 224. Sensor terminal 224 can be proximate opening 410b and further away from opening 410a than sensor terminal 2120.

In some examples, openings 410a and 410b can be coupled to an external pump system to force the fluid to move through opening 410a to enter fluid cavity 408, and exit fluid cavity 408 through opening 410b. In some examples, such as the example of FIG. 30, the fluid can flow from opening 410a to opening 410b without the external pump system. In both cases, the fluid can be transported through fluid cavity 408 by convection at a higher speed than microfluidic diffusion. Such arrangements can facilitate initial wetting of the internal surface of fluid cavity 408 and the surfaces of the sensor terminals. Also, such arrangements can facilitate a calibration operation. For example, a fluid with a known pH can enter fluid cavity 408 and come into contact with sensor terminals 224 and 2120, and a calibration operation can be performed to determine the various capacitances of the microfluidic sensor (e.g., capacitors 316 and 318 of FIG. 3B) based on the known pH value of the fluid and the outputs of the ISFETs. By forcing the fluid to enter and flow through fluid cavity 408 by convection rather than microfluidic diffusion, the flow and possibly exchange of the fluids in fluid cavity 408 can be sped up, which allows the calibration operation to be performed more efficiently. Also, such arrangements can facilitate sample injection for subsequent electrochemical operations such as electrophoresis, as described later.

In some examples, such as examples described in FIGS. 29, 30, 31, 32, and 43, when a convective fluid flow is forced across the cavity 408, a streaming potential between the openings can be generated. The streaming potential facilitates as a potential gradient and can be measured at the locations of the sensor terminals 2120 and 224, and can be used to measure the Zeta potential. If the pH across the cavity 408 is not constant, then an arrangement of voltage references provided by ISFETs in split-off reference channels having a reference fluid of pH_{Ref} such as described earlier and shown in FIG. 26B can be used to determine the streaming potential independent of the pH gradient across 408. In some examples, for the purpose of such streaming potential measurements, the pH inside cavity 408 can be adjusted by means of electrochemical actuation such as electrolysis, as described later, which can allow experimental determination of the isoelectric point.

FIG. 31A, FIG. 31B, FIG. 31C, FIG. 31D, FIG. 31E, and FIG. 31F illustrate examples of a microfluidic sensor 3100 that can support additional operations, such as an electrophoresis operation and an electroosmotic operation. Referring to FIGS. 31A through 31D, microfluidic sensor 3100 is an integrated circuit and has two openings 410a and 410b in fluidic structure 404.

Microfluidic sensor 3100 also includes one or more sensor terminals in fluid cavity 408. In FIG. 31A, microfluidic sensor 3100 includes sensor terminal 224 coupled to ISFET 206. In FIG. 31B and FIG. 31C, microfluidic sensor 3100 includes sensor terminals 224 and 2120 coupled to the respective ISFETs 206 and 2104. In FIG. 31D, microfluidic sensor 3100 includes nanofluidic channels 2608 and 2652 and reservoir 2650 of FIG. 26C, reservoir 2620 and fluid conduit structure 2622, and reservoir 2630 and fluid conduit structure 2632. Also, in addition to sensor terminals 2120 and 224, microfluidic sensor 3100 of FIG. 31D includes and sensor terminals 2642 (in nanofluidic channel 2608) and 2654 (in reservoir 2650), sensor terminal 2624 in reservoir 2620, and sensor terminal 2634 in reservoir 2630. Microfluidic sensor 3100 can also include a reference electrode or an electrode to set an electrical potential of the fluid, and these electrodes are omitted in FIGS. 31A through 31D for brevity.

Microfluidic sensor 3100 also includes control terminals 3102 and 3104. In FIGS. 31A and 31B, control terminal 3102 is inside fluid cavity 408 and control terminal 3104 is outside fluid cavity 408. In FIGS. 31C and 31D, both control terminals 3102 and 3104 are inside fluid cavity 408. Control terminal 3102 can include an electrode 3106 partially covered by insulation layer 228, and control terminal 3104 can include an electrode 3108 partially covered by insulation layer 228. Control terminal 3102 can proximate opening 410a, and control terminal 3104 can proximate opening 410b. In some examples, control terminals 3102 and 3104 are of identical size. In other examples, control terminals 3102 and 3104 can be of different size, which enables separation and focusing of electrically neutral particles via dielectrophoresis.

Microfluidic sensor 3100 also includes direct current (DC) voltage generators 3110 and 3112. DC voltage generator 3110 is coupled to control terminal 3102 and can set a voltage of control terminal 3102. DC voltage generator 3112 is coupled to control terminal 3104 and can set a voltage of control terminal 3104. DC voltage generators 3110 and 3112 can be implemented in semiconductor die 402 or can be external to the integrated circuit of microfluidic sensor 3100. In some examples, DC voltage generator 3110 can provide a first DC voltage (e.g., 20V, 10V, etc.) to control terminal 3102, and DC voltage generator 3112 can provide a second DC voltage that is less positive (or more negative) than the first DC voltage (e.g., 0V, −10V, etc.) to control terminal 3104. In some examples, microfluidic sensor 3100 can include an ammeter 3114 coupled between one of the control terminals 3102/3104 and the DC voltage generator 3112, in order to provide an amperometric measurement of the DC current. This can be beneficial to ensure proper conduct of the electroosmotic or electrophoretic cooperation. Ammeter 3114 can be implemented in semiconductor die 402 or can be external to the integrated circuit of microfluidic sensor 3100.

In FIGS. 31A and 31B, microfluidic sensor 3100 can include opening 410b having osmotic structure 3002, and microfluidic sensor 3100 can support an electroosmotic operation, such as operating as a DC electroosmotic pump, to facilitate flow of a fluid across fluid cavity 408 from opening 410a and out of opening 410b, or from opening 410b and out of opening 410a. Control terminals 3102 and 3104 can generate an electric field across osmotic structure 3002 of opening 410b. The electric field force the fluid to move through the osmotic structure to create a flow/pressure, and osmotic structure 3002 provides additional surface area to improve the pump performance. The DC electroosmotic pump can speed up the flow of the fluid in fluid cavity to, for example, support a calibration operation, etc. Following the electroosmotic operation, microfluidic sensor 3100 can then receive another fluid via opening 410a and perform the sensing operations as described above.

In FIG. 31C, microfluidic sensor 3100 can perform an electrophoresis operation on the fluid in fluid cavity 408 to separate positive and negative particles. In some examples, openings 410a and 410b can be coupled to different ports and receive different fluids. Control terminal 3102 can attract negatively charged molecules or ions, and repel positively charged molecules or ions, which can lead to a concentration gradient or separation of molecules between the two terminals according to their mobility. Accordingly, different pH values may be found fluid cavity 408 from 3202 to 3204, and a pH value at a location within fluid cavity 408 can depend on the composition (e.g., concentrations of different types of ions and molecules) of the fluid. ISFETs 2104 and 206 can generate voltages representing pH values at different locations within fluid cavity 408, and the pH values can indicate the composition of the fluid. In the example of FIG. 31C, to support or facilitate the electrophoresis operation, the distance between opening 410a and control terminal 3102 can be greater than the distance between opening 410b and control terminal 3104, so that most of the DC current will flow across the microfluidic channel. In examples, undesired electroosmotic flow during the electrophoretic operation can be prevented by choosing the pH value of the fluid (or control of pH via actuation, as described later) close to the isoelectric point of the cavity surface, or otherwise reduction or modification of the Zeta potential, such as by surface modification or addition of zwitterionic surfactants.

As described above, potential gradients such as the liquid junction potential described earlier may arise due to the concentration gradients across the path between the openings 410a and 410b. FIG. 31D illustrates an example of microfluidic sensor 3100 having the split-off reference channels such as nanofluidic channel 2652 and reservoir 2650 of FIG. 26C, reservoir 2620 and fluid conduit structure 2622, and reservoir 2630 and fluid conduit structure 2632, to measure the liquid junction potentials (or otherwise occurring pH-independent potential difference V_{D}) on two sides of nanofluidic channel 2608, as described in FIG. 26C with the differential measurement of (Equation 9). In some examples, microfluidic sensor 3100 can include a control terminal 3118 (coupled to a voltage source not shown in FIG. 31D) in nanofluidic channel 2602, so that microfluidic sensor 3100 can also operate as a nanofluidic transistor/flowFET, where control terminals 3102 and 3104 can represent the source and drain terminals of the nanofluidic transistor/flowFET, and control terminal 3118 can represent the gate terminal of the nanofluidic transistor/flowFET.

In some examples, DC voltage generator 3110 can provide a first DC voltage (e.g., 2V, 1V, etc.) to control terminal 3102, and DC voltage generator 3112 can provide a second DC voltage that is less positive (or more negative) than the first DC voltage (e.g., 0V, −1V, etc.) to control terminal 3104. In such examples, microfluidic sensor 3100 can perform an isoelectric focusing operation on the fluid in fluid cavity 408 to create a pH gradient in order to separate amphoteric particles such as proteins or pharmaceuticals. Due to current transfer from electron to ion at the electrode interface, so called actuation, at control terminal 3102 (cathode), hydroxide ions OH− can be created, -which can lead to a high pH in the portion of fluid cavity 408 below opening 410b. Similarly, at control terminal 3204 (anode), hydrogen ions H+ can be created, which can lead to a high pH in the portion of fluid cavity 408 below opening 410a. The rate of H+ and OH− creation depends on electrode metal and surface area, the distance between the electrodes, and most dominantly the ionic contents of the solution. The ratio of the two rates also depends on ionic concentration of the solution. Accordingly, a pH gradient can be formed along fluid cavity 408 from opening 410a to opening 410b, and a pH value at a location within fluid cavity 408 can depend on the composition (e.g., concentrations of different types of ions) of the fluid. ISFETs 2104 and 206 can generate voltages representing pH values at different locations within fluid cavity 408, and the pH values can indicate the composition of the fluid. In electrophoresis, described earlier, the actuated H+ and OH− ions might negatively affect the separation operation. Therefore, the control terminals 3102 and 3104 may be positioned at greater distance than for an isoelectric focusing operation. In some examples, control terminals 3102 and 3104 may be positioned in a split off path (not shown in FIG. 31) where the products of electrolysis such as H+ and OH− generation and/or generation of H2 or O2 bubbles does not affect the electrophoresis operation.

Electroosmotic pumps based on DC electroosmosis can be affected by undesired bubble generation and other electrochemical reactions at the electrodes at voltages beyond 1 V for electrolytes. These disadvantages can limit the throughput of the pump and the flow rate. An alternating current (AC) electroosmotic pump can pump at a high frequency (e.g., higher than 100 kHz) to circumvent the bubble problem by inducing polarization and slip velocity on embedded electrodes.

FIG. 31E illustrates an example of microfluidic sensor 3100 having an AC electroosmotic pump. Referring to FIG. 31E, fluidic structure 404 (or fluid cavity 408) can have a series of arrow shape footprints pointing towards a particular direction (e.g., direction C). In some examples, cavity 408 may also have a rectangular footprint. Microfluidic sensor 3100 also includes sets of electrodes, such as a set of electrodes 3120 (e.g., 3120a-c), a set of electrodes 3122 (e.g., 3122a-c), and a set of electrodes 3124 (e.g., 3124a-c), where electrodes from different electrode sets interleave. The electrodes extend below fluid cavity 408, and some (or all) of the electrodes are coupled to respective control terminals in fluid cavity 408. Some of the control terminals are illustrated in FIG. 31E, while others may exist and are omitted for brevity. For example, microfluidic sensor includes a control terminal 3132a coupled to electrode 3122a, and a control terminal 3132b coupled to electrode 3122b. Each control terminal can include a metal electrode (e.g., Platinum) fully covered by insulation layer 228, which can avoid the electrode changing the electrical potential of the fluid. Microfluidic sensor 3100 can also include AC voltage generators, with each AC voltage generator coupled to a set of electrodes. For example, Microfluidic sensor 3100 can include an AC voltage generator 3140 coupled to electrodes 3120, an AC voltage generator 3142 coupled to electrodes 3122, and an AC voltage generator 3144 coupled to electrodes 3124.

FIG. 31F illustrate graphs 3150, 3152, and 3154 illustrating the variation of voltage signals provided by, respectively, AC voltage generators 3140, 3142, and 3144. As shown in FIG. 31F, each AC voltage generator can generate an AC voltage signal having a frequency. The AC signal can include a sequence of varying voltage signals. In the example shown in FIG. 31F, the AC signal can be sinusoidal. In other examples, the AC signal can include pulses (e.g., rectangular pulses, triangular pulses, etc.). The AC voltage signals provided by AC voltage generators 3140, 3142, and 3144 can have a phase offset from each other in time. For example, the pair of AC signals provided by AC voltage generators 3140 and 3142 (represented by graphs 3150 and 3152), and the pair of AC signals provided by AC voltage generators 3142 and 3144 can be offset from one another by a time/phase T_{off}.

Because of the offset, neighboring electrodes can have asymmetric potentials, which creates a potential difference, and the potential difference varies with time at a particular frequency (e.g., 100 kHz). The potential difference can create electric field between neighboring electrodes. The electric field can induce a nanometer layer of charge/ions (also known as double layer) at the control terminals, and the ions on neighboring control terminals have opposite polarity. Under the influence of electric fields that are parallel to the surface, the surface charges in the double layer will migrate, which in turn produces fluid motion due to fluid viscosity. By applying asymmetric electric signals to neighboring electrodes, the two electrodes in a pair will exhibit different polarizations and strength of the double layer at the electrode/electrolyte interface. This can generate a unidirectional Maxwell force on the fluid, leading to throughflow pumping. In some examples, the control terminals in fluid cavity 408, such as control terminals 3132a and 3132b, can also have asymmetric footprints to unidirectional Maxwell force, which allows pump operation with fewer AC signal generators.

FIG. 32 illustrates an example microfluidic sensor 3200 that can support an impedance spectroscopy operation. Referring to FIG. 32, microfluidic sensor 3200 is an integrated circuit and has two openings 410a and 410b in fluidic structure 404. Microfluidic sensor 3200 also includes sensor terminals 224 and 2120 and ISFETs 206 and 2104. In addition, microfluidic sensor 3200 includes control terminals 3202 and 3204. Control terminal 3202 can include an electrode 3206 covered (fully or partially) by insulation layer 228, and control terminal 3204 can include an electrode 3208 covered (fully or partially) by insulation layer 228. Control terminal 3202 can proximate opening 410a, and control terminal 3204 can proximate opening 410b. Microfluidic sensor 3200 also includes an alternating current (AC) voltage generator 3210 coupled between control terminals 3202 and 3204. AC voltage generator 3210 can provide an AC voltage signal across control terminals 3202 and 3204. Control terminals 3202 and 3204 can set an electrical potential of the fluid in fluid cavity 408 similar to voltage terminals 1102/1202, albeit the electrical potential being AC. One of control terminals 3202 and 3204 can also sense the electrical potential. Microfluidic sensor 3200 can also include an ammeter to measure current. The impedance can be based on a ratio between the electrical potential and the current, and can be measured for different AC voltage signal frequencies to generate the spectroscopy.

In some examples, AC voltage generator 3210 can be implemented in semiconductor die 402 or can be external to the integrated circuit of microfluidic sensor 3200. In some examples, more than two control terminals can be used for an impedance spectroscopy operation, such as four electrodes to support a four-electrode conductivity measurement. In some examples, the proximity between control terminals may be closer than indicated in FIG. 32, e.g. similar to the proximity of the control terminal in FIG. 31, which may in some examples be dynamically (by means of switching circuitry) re-configured for impedance spectroscopy. The components of microfluidic sensor 3200 to support the impedance spectroscopy operation (e.g., AC voltage generator 3210 and electrodes 3206 and 3208) can also be included in other examples of microfluidic sensors described herein.

To support an impedance spectroscopy operation, AC voltage generator 3210 can perform a frequency sweep by providing AC voltage signals having a range of frequencies. Openings 410a and 410b can be coupled to separate fluidic ports or inlets. In some examples, the distance of opening 410a to sensor terminal 3202 and the distance of opening 410b to sensor terminal 3204 can be greater than twice the distance between sensor terminals 3202 and 3204. In both cases, most of the AC current can flow through the microfluidic channel. At each frequency, ISFETs 2104 and 206 can generate voltages representing pH values of a fluid in fluid cavity 408, and a relationship between the pH values of the fluid and the frequency of the AC voltage signal applied across control terminals 3202 and 3204 can be determined. The relationship can represent an impedance spectroscopy of the fluid, and can reflect the composition of the fluid. For the here described purposes, impedance structures can be integrated as part of a larger fluidic network of actuators and sensors, such as described earlier and in the following. The fluidic network is can be a multitude of channels formed by the fluidic structure. There may be an element for performing mixing, another element for performing electrophoresis, and elements such as pumps and valves connecting the parts of this so-formed larger fluidic network.

In some examples, an impedance spectroscopy operation can be beneficial to ensure proper operation of these devices, e.g. by conducting an auxiliary conductivity measurement in case a certain ionic strength or conductivity is desired or to be controlled by a sensor-actuator mechanism. In other examples, undesired air bubbles or particles can be detected by impedance spectroscopy, and, for example, these air bubbles or particles can be expelled by means of convection created by (external or internal) pumps as a response to the bubble detection mechanism. In similar examples, where an emulsion of fluids or undissolved particles (i.e. colloids or suspensions) are desired to be present in the fluid of cavity 408, an impedance spectroscopy operation can give an indication about the composition of such emulsions, colloids, or suspensions.

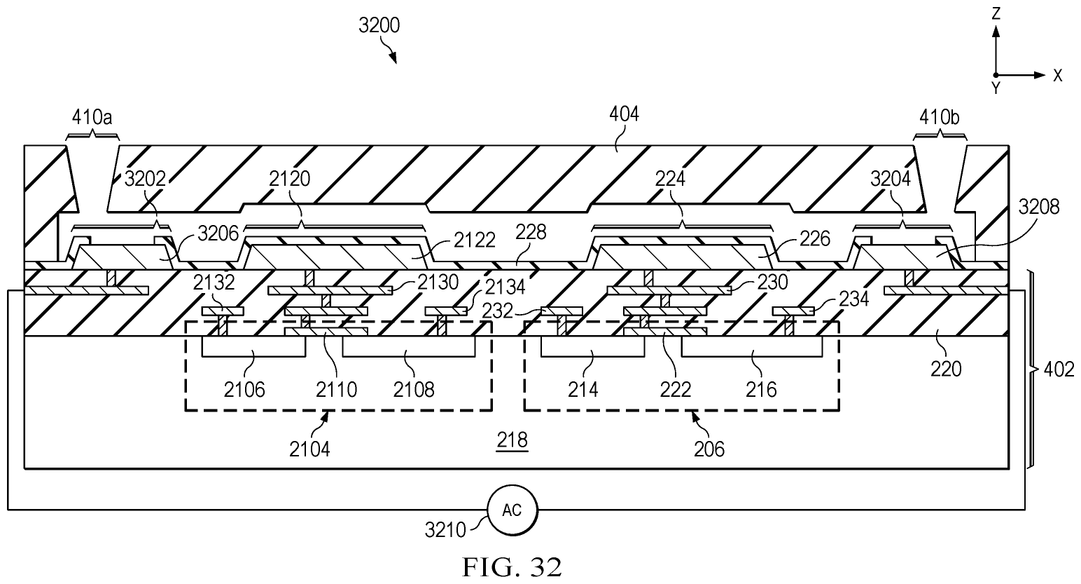

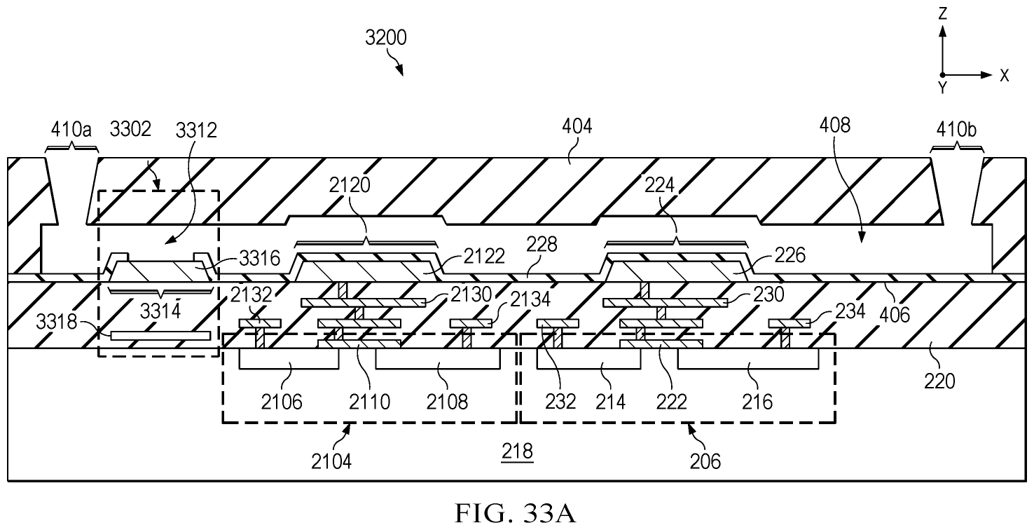

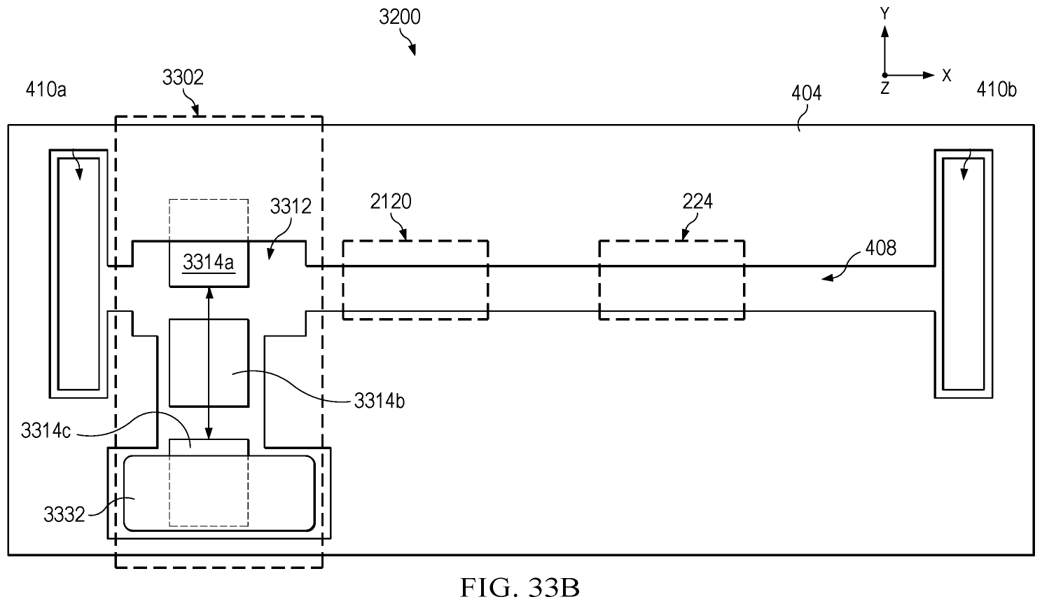

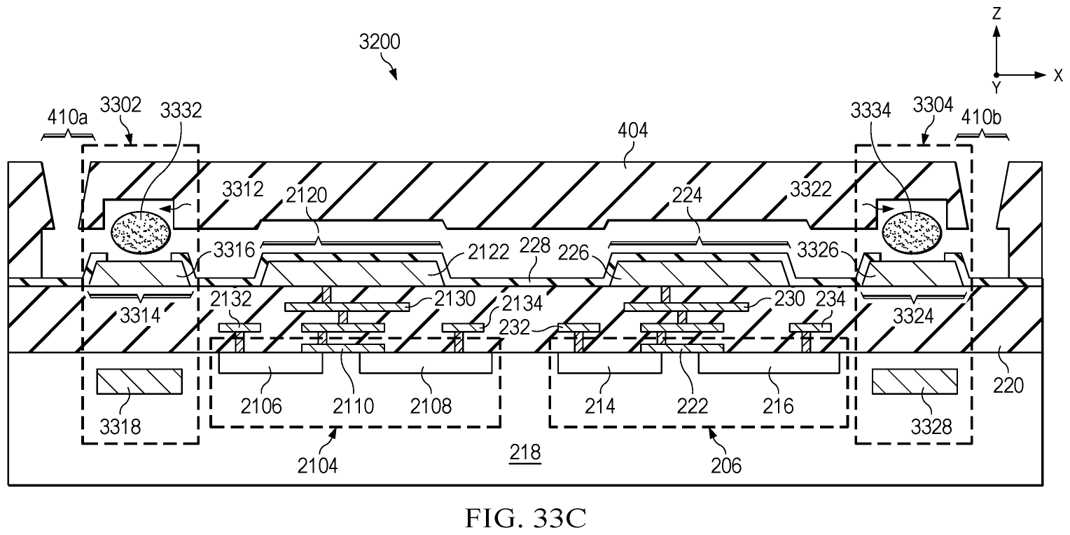

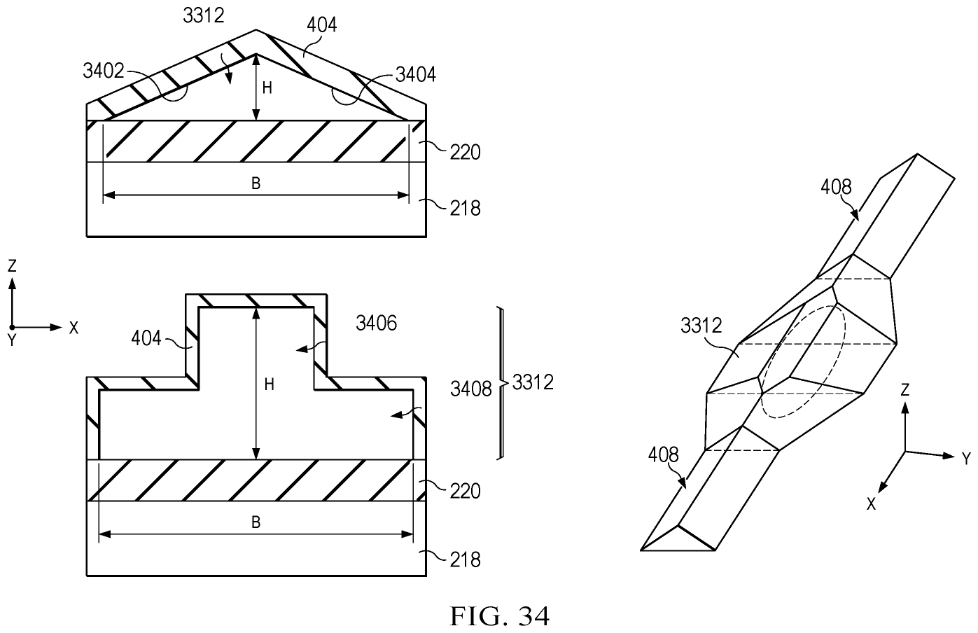

In some examples, a microfluidic sensor can include valves in fluid cavity 408 to control the direction and/or rate of flow of the fluid between openings 410a and 410b. FIGS. 33A, 33B, 33C, and FIG. 34 are schematics illustrating examples of a microfluidic sensor 3300, which is an integrated circuit including fluidic structure 404. FIG. 33A illustrates a cross-sectional view of microfluidic sensor 3300, and FIG. 34 illustrates another cross-sectional view and perspective view of fluid cavity 408 of microfluidic sensor 3300. Referring to FIG. 33A and FIG. 33B, microfluidic sensor 3300 has openings 410a and 410b in fluidic structure 404. In some examples, microfluidic sensor 330 can include one opening 410. Microfluidic sensor 3300 also includes sensor terminals 224 and 2120 and ISFETs 206 and 2104. Microfluidic sensor 3300 can also include voltage terminal 1102 in fluid cavity 408 or voltage terminal 1202 external to fluid cavity, or a discrete reference electrode, which are not shown in FIGS. 33A, 33B, and 34 for brevity.

Also, microfluidic sensor 3300 includes a valve, such as valve 3302. A valve can include a chamber that is part of fluid cavity 408, a voltage terminal, and a heater. For example, valve 3302 includes a chamber 3312 (shown in FIG. 33B), one or more control terminals 3314 each including an electrode 3316 partially covered by insulation layer 228 on sensing side 406 of dielectric layer 220, and a heater circuit 3318 in substrate 218. The interconnects are omitted in FIG. 33 for brevity.

In FIGS. 33A and 33B, chamber 3312 can extend along a lateral direction (e.g., along the y-axis) orthogonal to the flow path of a fluid in fluid cavity 408 (e.g., along the x-axis) and between opening 410a and sensor terminal 224. Chamber 3312 can hold a gas bubble 3332 (e.g., oxygen, hydrogen, etc.). In FIGS. 33A and 33B, microfluidic sensor 3300 can include multiple control terminals 3314, such as 3314a, 3314b, and 3314c positioned laterally (e.g., along the y-axis) along chamber 3312. Control terminals 3314 can be coupled to a voltage generator, which can set the control terminals to a negative electrical potential. As part of an electrolysis operation, the water component of the fluid can be broken down into oxygen gas and hydrogen ions responsive to the negative electrical potentials at control terminals 3314, and the oxygen (or hydrogen) gas can be trapped in chamber 3312. Also, as to be described below, the voltage generator can also generate voltage pulses, which causes control terminals 3314 to generate electric fields to move gas bubble 3332 along chamber 3312 to open, close, or otherwise restrict the flow of fluid between opening 410a and sensor terminal 224. For example, when gas bubble 3332 is at control terminal 3314c, valve 3302 can be in an open state. Also, when gas bubble 3332 is at control terminal 3314a and/or control terminal 3314b, valve 3302 can be in a shut off state or in a restricted state.

Also, the size of gas bubble 3332 can be controlled by respective heater 3318 to set a degree of flow restriction provided by valve 3302. If the bubbles are expanded to a certain size, they may act as an isolation valve and completely shut off the flow path so that galvanic separation between the fluid inside the cavity and outside of the cavity can be achieved. ISFETs (e.g., 206 an 2104) can be operated when the valves are open. If any ISFET operation is desired when the flow path is shut off, at least one voltage terminal is required in a liquid separated from other liquids by means of at least one isolation valve, in order to provide a V_{G} necessary to operate the ISFET. As to be described below, microfluidic sensor 3300 can also include a set of serially-connected valves operating as a pump, in which the gas bubbles in the valves can be expanded (e.g., when heater is on) and shrunk (e.g., when heater is off) sequentially to force the fluid to move in a particular direction.

FIG. 33C illustrates another example of microfluidic sensor 3300. In FIG. 33C, microfluidic sensor can include another valve 3304, which includes a chamber 3322, a control terminal 3324 including electrode 3326, and a heater 3328. In FIG. 33C, chamber 3312 and chamber 3322 can extend along a vertical direction (e.g., along the z-axis) orthogonal to the flow path of a fluid in fluid cavity 408 (e.g., along the x-axis) and between opening 410a and sensor terminal 224. Chamber 3312 can hold a gas bubble 3332 (e.g., oxygen, hydrogen, etc.). Such an arrangement may be advantageous since it allows gravitational trapping of the bubble, as indicated later in FIG. 34.

Referring to FIG. 34, each chamber can have recessed internal surfaces 3402 and 3404 forming an angle, and can have a cross-sectional shape of a triangle, or a trapezoid, having a widened base. In the example of FIG. 34, chamber 3312 extends in the z-direction and its cross-section (and that of cavity 408) can have a triangular shape having a height of H and a base width of B. In some examples, H can be about 0.5 um and B can be about 5 um. The recessed internal surface can facilitate trapping of gas bubble in chamber 3312, where due to gravity gas bubble can be trapped in the widened base. In some examples, the cross-section of chambers 3312 and 3322 can also include ridge shape including a narrow polygon portion 3406 and a wide polygon portion 3408, with narrow polygon portion 3406 of the chamber to trap the gas bubble. The width of wide polygon portion 3408 can be B, and the height of the ridge shape can be H.

In the examples of FIGS. 33A, 33B, 33C, and 34, bubbles can be introduced from openings 410a/410b during the first wetting of fluid cavity 408. If the bubble can be reliably trapped in chamber 3312, the control terminals for bubble creation can be omitted (or otherwise not used for bubble creation). Also, heater 3318 can be omitted if the size and, optionally, position (e.g., a bi-stable valve) of the bubble can be controlled by control terminals alone.

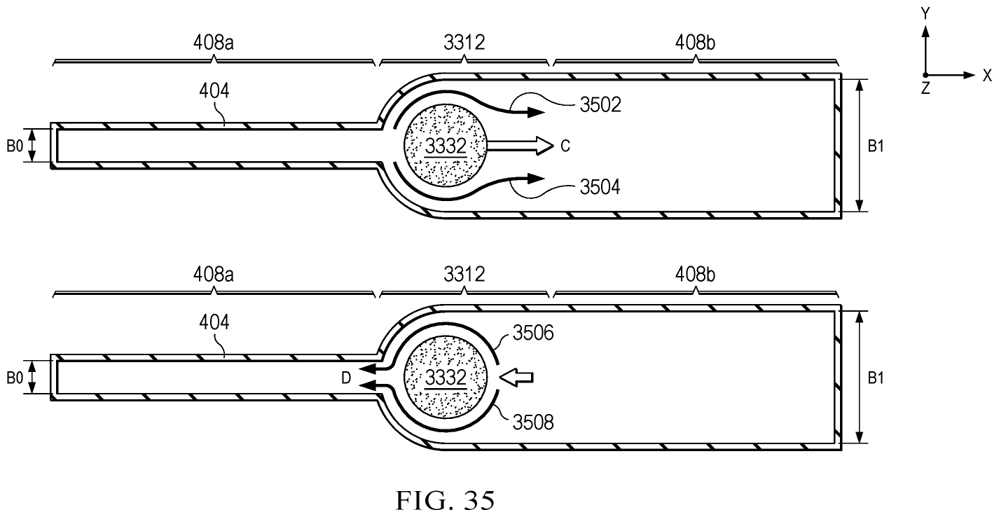

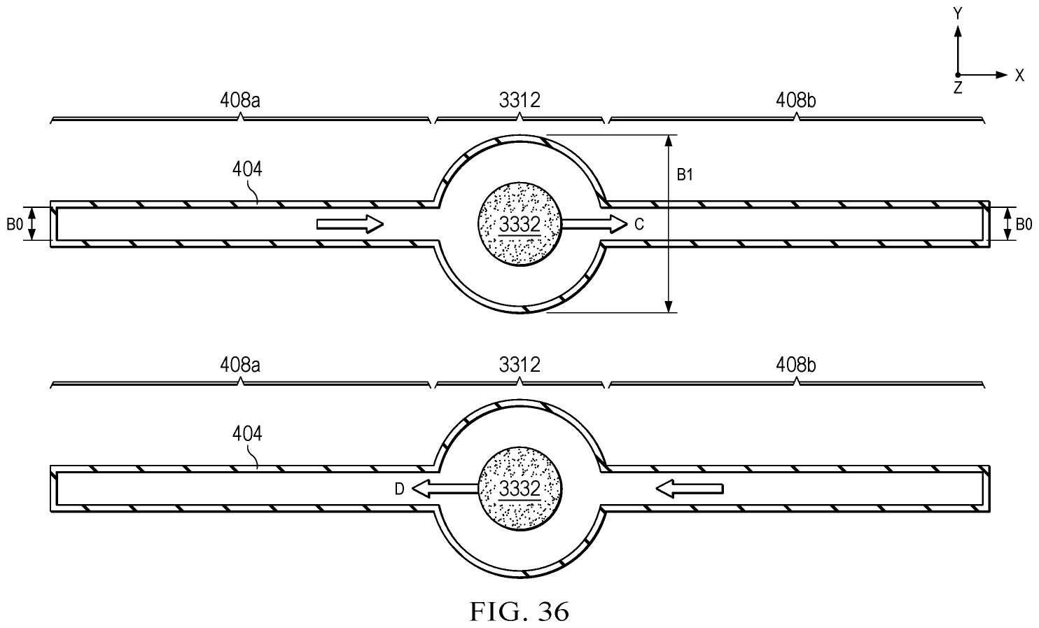

FIGS. 35 and 36 are schematics illustrating plan views of example fluid cavity 408 and valve 3302 including chamber 3312 and gas bubble 3332 enclosed in fluidic structure 404. Referring to FIGS. 35 and 36, microfluidic sensor 3300 can include chamber 3312 coupled between cavity portions 408a and 408b. In FIG. 35, cavity portion 408a can have a based width B0, and cavity portion 408b and chamber 3312 can have a base width B1 larger than B0. Also, in FIG. 36, cavity portions 408a and 408b can have base width B0.

In FIG. 35, valve 3302 can be configured as a unidirectional check valve that can block the flow of fluid towards in one direction. Specifically, gas bubble 3332 can restrict flow of fluid towards both directions C and D, where the fluid flow around gas bubble 3332 between cavity portions 408a and 408b as represented by flows 3502, 3504, 3506, and 3508. As the flow rate of the fluid increases towards direction D, bubble 3332 can be pushed against the opening between cavity portion 408a and chamber 3312 and can block the fluid from entering cavity portion 408a. On the other hand, if the flow rate the fluid increases towards direction C, bubble 3332 can be pushed further away from the opening between cavity portion 408a and chamber 3312. But because cavity portion 408b and chamber 3312 has the same base width B1, the bubble does not block the fluid from flowing into cavity portion 408b. Accordingly, valve 3302 can function as a unidirectional valve that can block of the flow of fluid towards direction D. Similarly, with added actuator elements to move the bubble, a piston pump can be achieved where the bubble is moved and creates convection along its path of motion.

Also, in FIG. 36, valve 3302 can be configured as a bidirectional check valve that can block the flow of fluid towards either directions C or D, because chamber has a larger base width than both cavity portions 408a and 408b. Specifically, as the flow rate of the fluid increases towards direction D, bubble 3332 can be pushed against the opening between cavity portion 408a and chamber 3312 and can block the fluid from entering cavity portion 408a. Also, as the flow rate of the fluid increases towards direction C, bubble 3332 can be pushed against the opening between cavity portion 408b and chamber 3312 and can block the fluid from entering cavity portion 408b.

As described above, valve 3302 includes a heater circuit 3318 to thermally expand or shrink gas bubble 3332 to set a degree of flow restriction. FIG. 37 illustrates example operation of heater circuit 3318. Referring to FIG. 37, by thermal expanding gas bubble 3332 in chamber 3312, gas bubble 3332 can act as an isolation valve, completely blocking the flow of fluid between cavity portions 408a and 408b. The expansion of gas bubble 3332 in chamber 3312 can also push the fluid out of chamber 3312 into cavity portions 408a and 408b, as indicated by flows 3702 and 3704.

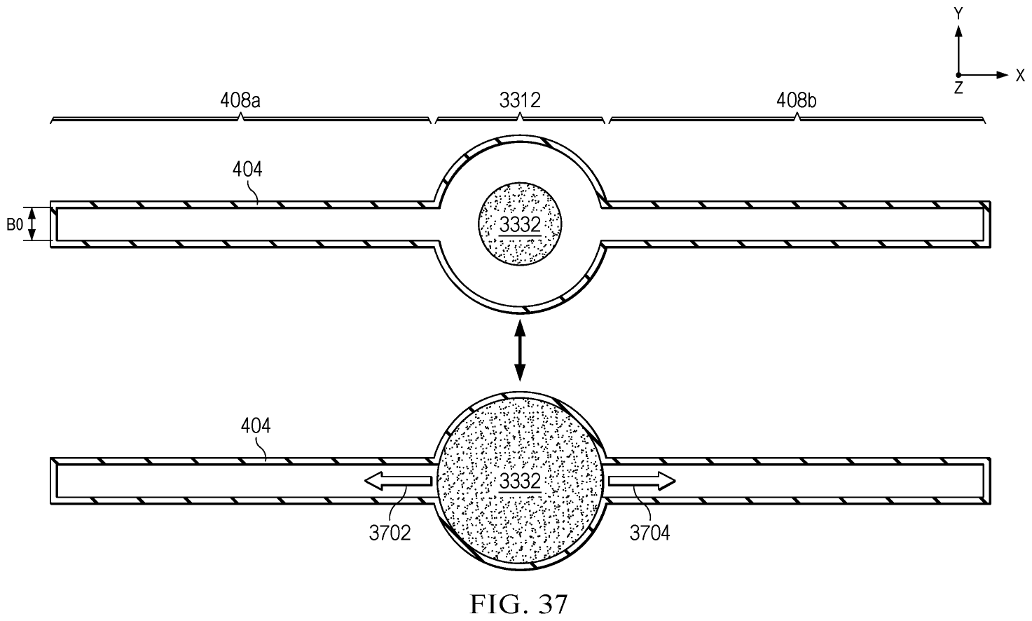

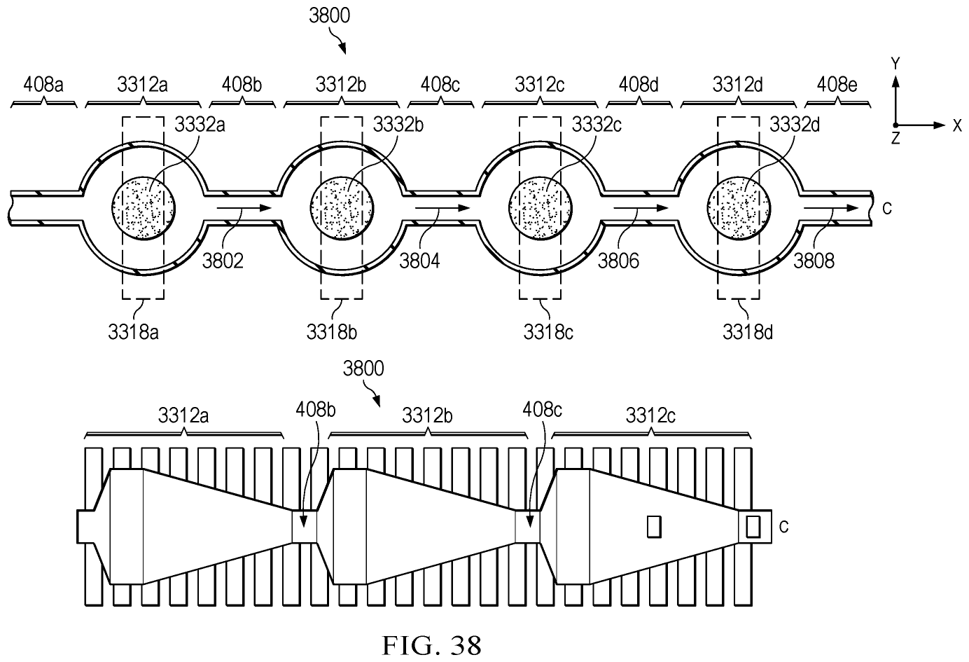

In some examples, microfluidic sensor 3300 includes a set of serially-connected valves operating as a pump, in which the gas bubbles in the valves can be expanded and shrunk sequentially to force the fluid to move in a particular direction. FIG. 38 are schematics illustrating plan views of an example pump 3800 that can be part of microfluidic sensor 3300. Referring to FIG. 38, microfluidic sensor 3300 can include a set of serially-connected chambers 3312 enclosed in fluidic structure 404. The serially-connected chambers 3312 include chambers 3312a, 3312b, 3312c, and 3312d, each holding respective gas bubbles 3332a, 3332b, 3332c, and 3332d. Chamber 3312a can be coupled between cavity portions 408a and 408b. Chamber 3312b can be coupled between cavity portions 408b and 408c. Chamber 3312c can be coupled between cavity portions 408c and 408d. Microfluidic sensor 3300 also includes heater circuits 3318a, 3318b, 3318c, and 3318d under the respective chambers 3312a, 3312b, 3312c, and 3312d. Heater circuits 3318a, 3318b, 3318c, and 3318d can thermally expand the gas bubbles sequentially to force a fluid to flow in a particular direction, such as direction C. In some examples, the chambers can have an arrow shaped footprint pointing towards a particular direction (e.g., direction C) to facilitate the flow of the fluid towards that direction.

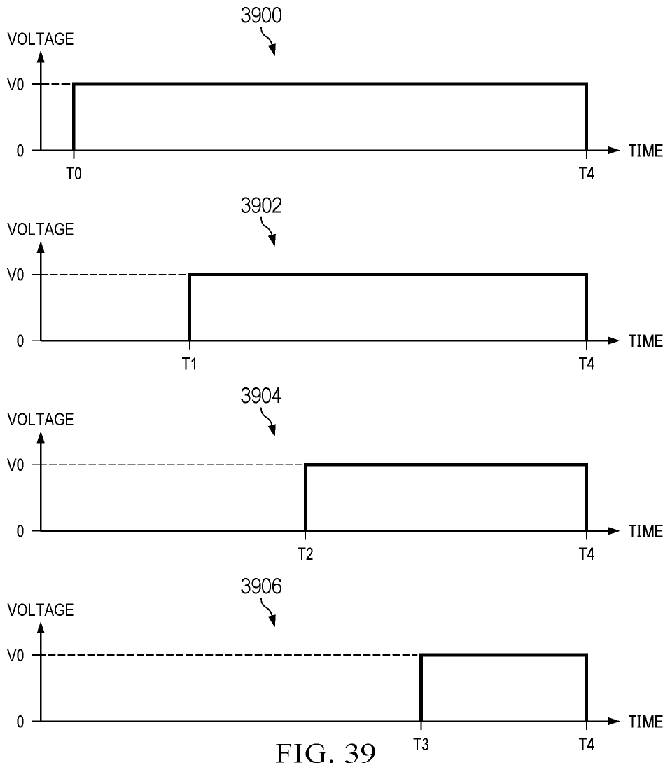

FIG. 39 are graphs 3900, 3902, 3904, and 3906 illustrating example operations of heater circuits 3318a, 3318b, 3318c, and 3318d to operate the serially-connected valves of FIG. 38 as a pump. In each of graphs 3900, 3902, 3904, and 3906, Graph 3900 illustrates an example variation of a voltage provided to heater circuit 3318a with time, graph 3902 illustrates an example variation of a voltage provided to heater circuit 3318b with time, graph 3904 illustrates an example variation of a voltage provided to heater circuit 3318c with time, and graph 3906 illustrates an example variation of a voltage provided to heater circuit 3318c with time. In each of graphs 3900 through 3906, a voltage of V₀ represents that the heater circuit is enabled and thermally expand a gas bubble in the chamber, and a voltage of zero represents that the heater circuit is disabled.

Referring to FIG. 39, at time T0, heater circuit 3318a receives a voltage of V₀ and thermally expands gas bubble 3332a. Referring again to FIG. 38, the expanded gas bubble 3332a pushes the fluid out of chamber 3312a into cavity portion 408b, represented by flow 3802. At time T0, heater 3318b is disabled and gas bubble 3332b is not thermally expanded, which allows the fluid to flow towards direction C into chamber 3312b via cavity portion 408b.

Also, at time T1, heater circuit 3318b receives a voltage of V₀ and thermally expands gas bubble 3332b, while heater circuit 3318a remains enabled. Accordingly, both gas bubbles 3332a and 3332b can be in the thermally expanded state. The expanded gas bubble 3332b pushes the fluid into cavity portion 408c, as represented by flow 3804. Because gas bubble 3332a is in the thermally expanded state and block the opening between chamber 3312a and cavity portion 408b, the fluid cannot enter chamber 3312a and can be forced to flow towards direction C and into chamber 3312c via cavity portion 408c.

Further, at time T2, heater circuit 3318c receives a voltage of V₀ and thermally expands gas bubble 3332c, while heater circuits 3318a and 3318b remain enabled. Accordingly, gas bubbles 3332a, 3332b, and 3332c can be in the thermally expanded state. The expanded gas bubble 3332c pushes the fluid into cavity portion 408d, as represented by flow 3806. Because gas bubbles 3332a and 3332b are in the thermally expanded state, the fluid cannot enter chambers 3312b and 3312c and can be forced to flow towards direction C and into chamber 3312d via cavity portion 408d.

Also, at time T3, heater circuit 3318d receives a voltage of V₀ and thermally expands gas bubble 3332d, while heater circuits 3318a, 3318b, and 3318c remain enabled. Accordingly, gas bubbles 3332a, 3332b, 3332c, and 3332d can be in the thermally expanded state. The expanded gas bubble 3332d pushes the fluid into cavity portion 408e, as represented by flow 3806. Because gas bubbles 3332a, 3332b, and 3332c are in the thermally expanded state, the fluid cannot enter chambers 3312a, 3312b, and 3312c, and can be forced to flow towards direction C and into cavity portion 408d. At time T4, the pump operation can end, and the voltages provided to the heaters can be back to zero to disable the heaters.

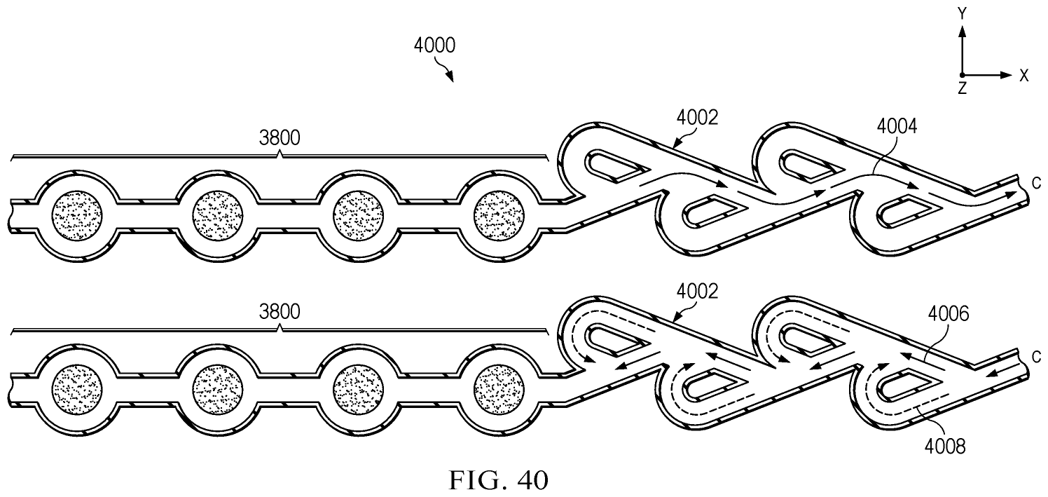

FIG. 40 is a schematic illustrating a plan view of an example pump 4000. As shown in FIG. 40, in some examples pump 4000 can include pump 3800 of FIG. 38 coupled to a Tesla valve 4002. Both pump 3800 and Tesla valve 4002 can be enclosed in fluidic structure 404. Tesla valve 4002 can allow the fluid to flow in one direction (e.g., direction C), as represented by flow 4004. When receiving fluid flowing in an opposite direction from the allowed direction, Tesla valve 4002 can create flows of the fluid, such as flows 4006 and 4008, that cancel each other out, so that the fluid can only flow in the allowed direction within fluid cavity 408. It can also be coupled to other pumps which generate non-directional movement to rectify the fluid flow.

In the examples of FIGS. 29-30 where a microfluidic sensor includes two openings 410a and 410b in fluidic structure 404, one of the two openings (e.g., opening 410a) is configured as an inlet, and the other one of the two openings (e.g., opening 410b) is configured as an outlet. The microfluidic sensor can receive a fluid via opening 410a and drain the fluid via opening 410b.

Also, in the examples of FIGS. 31, 33-40 where a microfluidic sensor includes valves or pumps, these elements can be integrated as part of a larger fluidic network of actuators and sensors, such as described earlier and in the following. In the example of multiple package fluidic ports as shown in FIG. 6, pumps can serve to provide new fluid between the ports, which may be connected by a fluidic network. For example, referring again to FIGS. 5A-5C and FIG. 6, pumps can be controlled to mix, exchange, or replace fluids between fluid cavity 408 and fluid 110. Similarly, isolation valves can act to (stop) restrict diffusion or flow into- and out of cavities such as 408. This can provide a significant advantage when a first fluid is aimed to be stored for a long period of time T1′ without mixing it with a second fluid under test, such as in the pH sensor described in previous figures.

In some examples, a microfluidic sensor can be configured as a fluid mixer, in which two openings 410a and 410b can be configured as inlets. In such examples, the microfluidic sensor can receive a first fluid via opening 410a, and a second fluid via opening 410b, and allow mixing of the fluids in fluid cavity 408. One example application of a fluid mixer is to determine a strength of a buffer solution, which can be one of the fluids provided to the microfluidic sensor. A buffer solution may resist pH change when mixed with a second fluid, and the buffer strength can represent the resistance of the buffer solution to the pH change after mixing with the second fluid. A small pH change may indicate a high buffer strength, and vice versa. A microfluidic sensor can measure the pH of the mixture to indicate the relative buffer strengths of the two fluids. Additional examples can include chemical reaction monitoring, a feedback control (e.g., if a stable gradient is desired) for separation of molecules or focusing applications, etc.

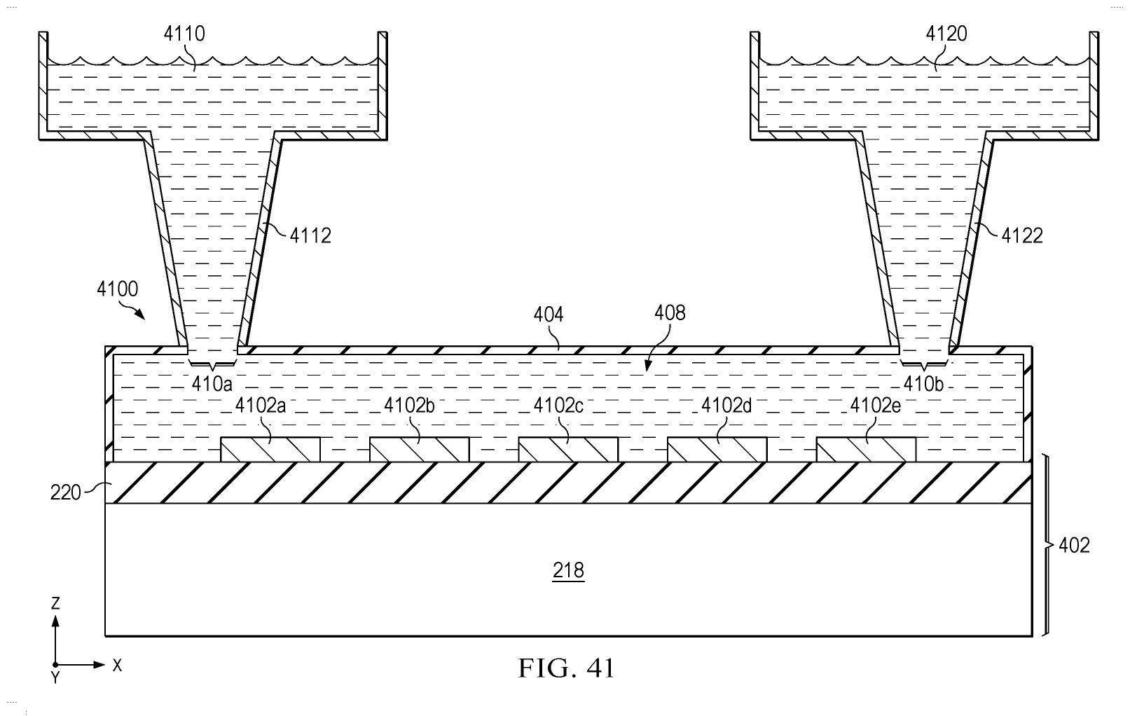

FIG. 41 is a schematic illustrating a cross-sectional view of an example microfluidic sensor 4100 that supports mixing and buffer strength measurement. Microfluidic sensor 4100 can be an integrated circuit including fluidic structure 404 on semiconductor die 402. Fluidic structure 404 encloses fluid cavity 408 and includes openings 410a and 410b extending to fluid cavity 408. Fluidic structure 404 may include additional openings not shown in FIG. 41. Each of openings 410a and 410b can be configured as a fluid inlet. Microfluidic sensor 4100 can include a set of sensor terminals, such as sensor terminals 4102a, 4102b, 4102c, 4102d, and 4102e, on dielectric layer 220 and inside fluid cavity 408. Each sensor terminal can include an electrode covered by insulation layer 228 (not shown in FIG. 41), and each sensor terminal is coupled to an ISFET in semiconductor die 402. Each sensor terminal/ISFET can sense the pH at a particular location in fluid cavity 408 between openings 410a and 410b, and provide a voltage representing the sensed pH value. Microfluidic sensor 4100 may also include a voltage terminal (not shown in FIG. 41) or an external reference electrode to set the electrical potential of the fluids. In some examples, microfluidic sensor 4100 can include a nanofluidic channel (e.g., nanofluidic channel 2608), a nanofluidic diode, or a nanofluidic transistor between openings 410a and 410b.

Microfluidic sensor 4100 can receive a fluid 4110 from a fluid container 4112 via opening 410a (and a port), and receive a fluid 4120 from a fluid container 4122 via opening 410b (and another port). Microfluidic sensor 4100 can enable a mixing of fluids 4110 and 4120 in fluid cavity 408, and provide measurements of pH at different locations in fluid cavity 408. The pH measurements can indicate the relative buffer strengths of the fluids.

FIGS. 42A, 42B, and 4C are schematics of plan view of microfluidic sensor 4100 illustrating examples of pH measurement operations. FIG. 42A illustrates pH measurement operations 4200 and 4202 provided by microfluidic sensor 4100 from the mixing of fluids 4110 and 4112. Microfluidic sensor 4100 can receive a fluid 4110 from opening 410a, and fluid 4410 can exit through opening 410c. Also, microfluidic sensor 4100 can receive a fluid 4112 from opening 410b, and fluid 4112 can exit through opening 410d. Fluid 4110 can have a pH value of 4, and fluid 4112 can have a pH value of 8. The mixture of fluids 4110 and 4112 can have a pH gradient from pH 4 to pH 8 across fluid cavity 408, and the slope of the pH gradient can indicate relative buffer strengths of fluids 4110 and 4112. As shown in pH measurement operation 4200, sensor terminals 4102a-e can provide results indicating that the pH rising steadily from pH₄ to pH₈ following a constant or steady pH gradient. The middle sensor terminal 4102c measures a pH₆, which is the average pH between the two fluids. The results of pH measurement operation 4200 can indicate that fluids 4110 and 4112 have similar buffer strength. In contrast, in pH measurement operation 4202, the measured pH has a relatively shallow gradient from sensor terminals 4102a to 4102d (e.g., pH₄ to pH_{5.5}), and a relatively steep gradient between sensor terminals 4102d and 4102e (e.g., pH_{5.5} to pH_{8.4}). This can indicate that fluid 4110 has a much higher buffer strength than fluid 4112, and a mixture of fluid 4110 and 4112 exhibits a relatively small pH change from standalone fluid 4110. In the region between sensor terminals 4102d and 4102e, because very little of fluid 4110 is present and the mixture is dominated by fluid 4112, the pH value of such a mixture is dominated by fluid 4112. Accordingly, sensor terminal 4102e outputs a pH close to 9.

Referring to FIG. 42B, in some examples, microfluidic sensor 4100 can be coupled to (or include) a flow control system 4220 to set the flow rates of fluids 4110 and 4112 based on the signals provided by sensor terminals 4102a-e. For example, if the signals provided by sensor terminals 4102a-e indicate that the buffer strength of one of the fluids (e.g., fluid 4110) far exceeds the buffer strength of the other fluid (e.g., fluid 4112), such as shown in operation 4202, flow control system 4220 can reduce the flow rate of the fluid having the much higher buffer strength. In some examples, flow control system 4220 can include components integrated into microfluidic sensor 4100, such as including valve 3302. Referring back to FIGS. 33A and 33B, flow control system 4220 can move bubble 3332, or enable heater 3318 to expand bubble 3332, to block the fluid having the stronger buffer strength from entering fluid cavity 408 from opening 410a.

FIG. 42C illustrates another example of microfluidic sensor 4100, which can include split-off reference channels containing 3M KCl solution (or other solutions with approximately zero liquid junction potential) similar to examples described above (e.g., FIG. 26B) to provide liquid junction potential measurements, and the measurement results can be used to eliminate/attenuate the liquid junction potential component in the pH measurements. Specifically, in FIG. 42C, microfluidic sensor 4100 can include reservoirs 4210a, 4210b, 4210c, 4210d, and 4210e each coupled to fluid cavity 408 via, respectively, openings 4212a, 4212b, 4212c, 4212d, and 4212e. Each reservoir can include a respective sensor terminal (e.g., one of sensor terminals 4124a-4214e) and can hold a 3M KCl solution and forms a pair of sensor terminals with one of sensor terminals 4102a-4102e in fluid cavity 408. As the KCl solution mixes with the fluid(s) in fluid cavity 408, each of pair sensor terminals (e.g., sensor terminals 4102a and 4214a, 4102b and 4214b, 4102c and 4214c, 4102d and 4214d, and 4102e and 4214e) can measure a potential difference representing the liquid junction potential of the fluid(s) at a particular location in fluid cavity 408. The measurement result can be used to remove/attenuate the liquid junction potential component in the pH measurements provided by sensor terminals 4102a-4102e as described above.

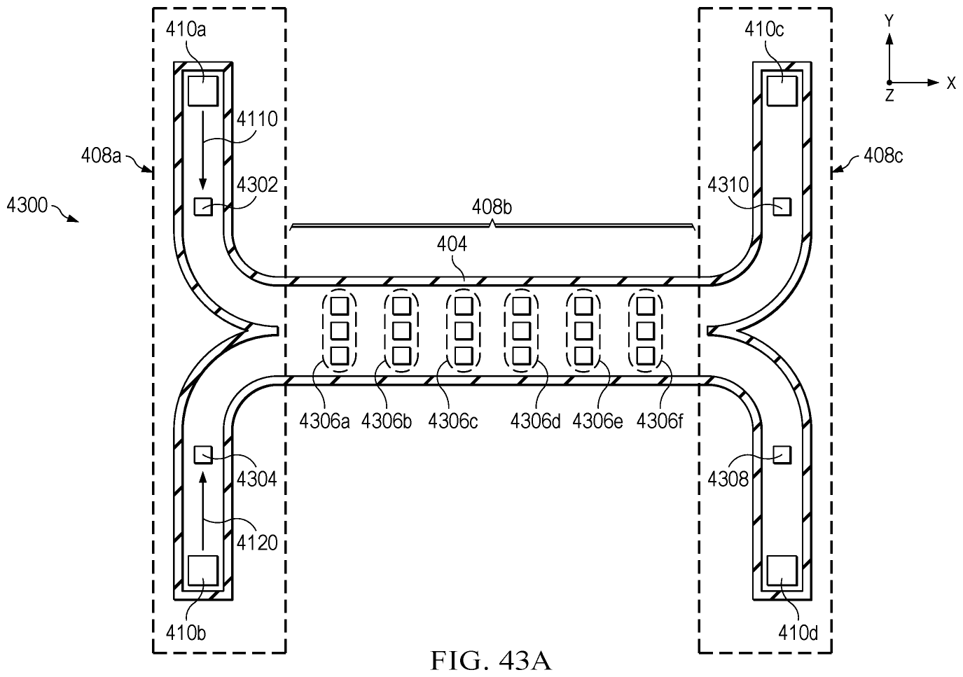

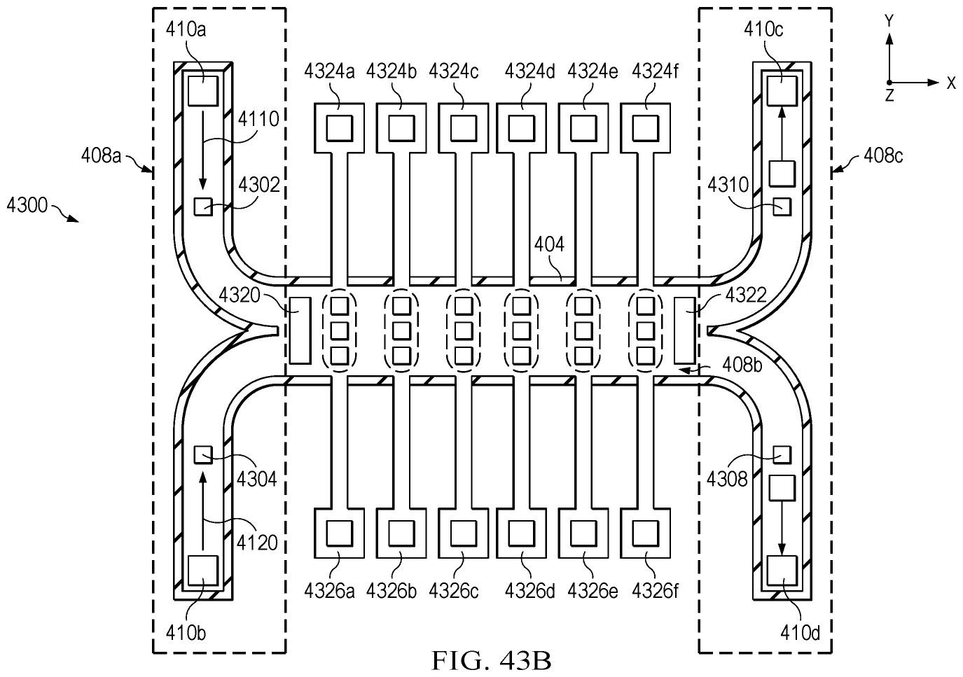

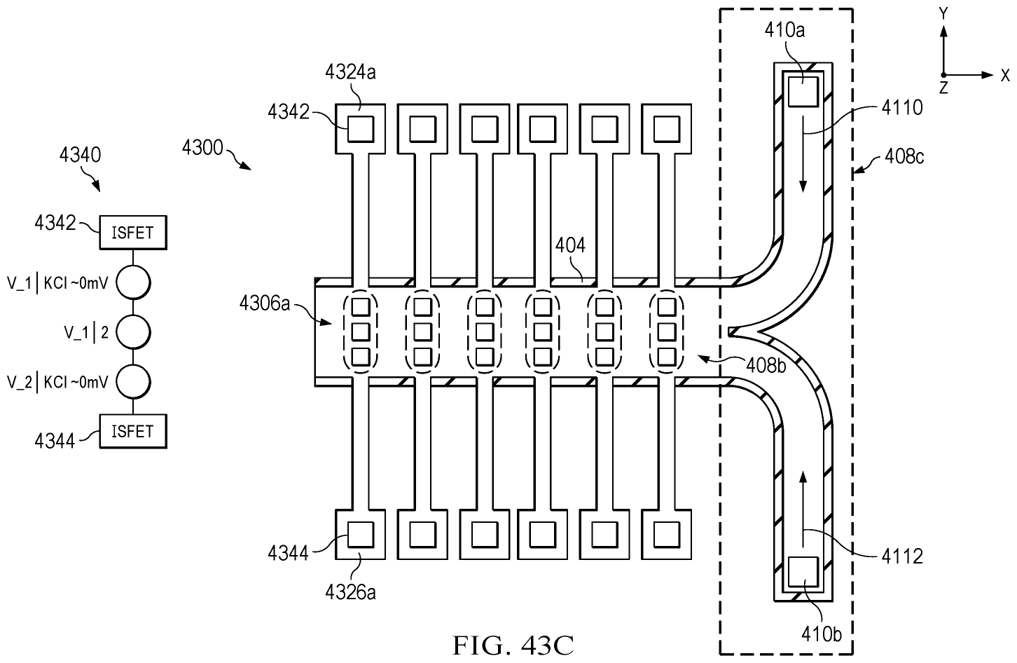

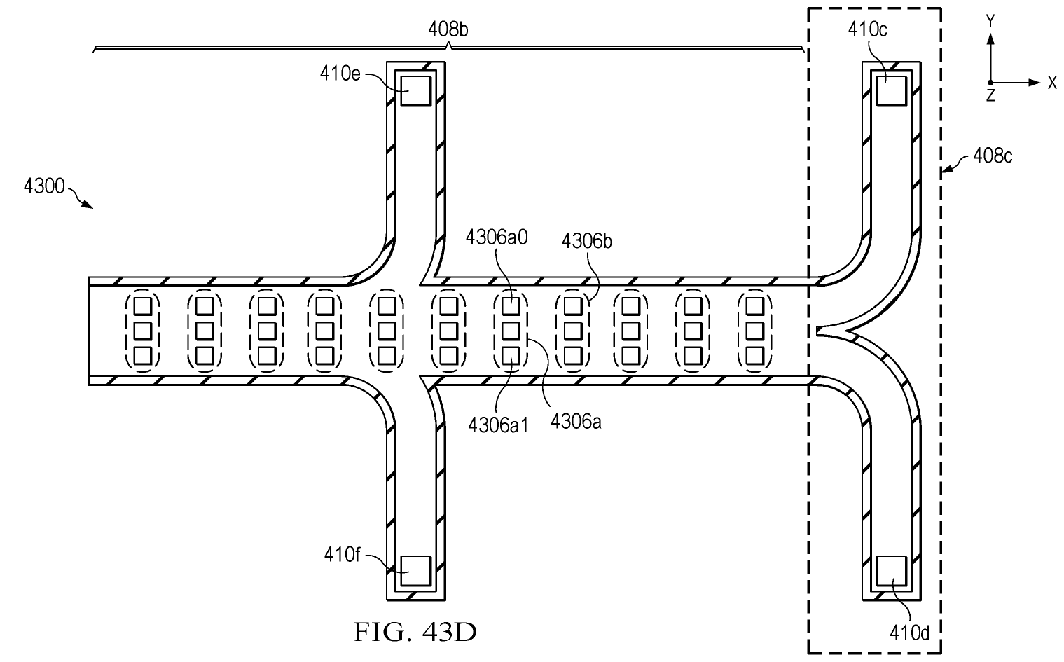

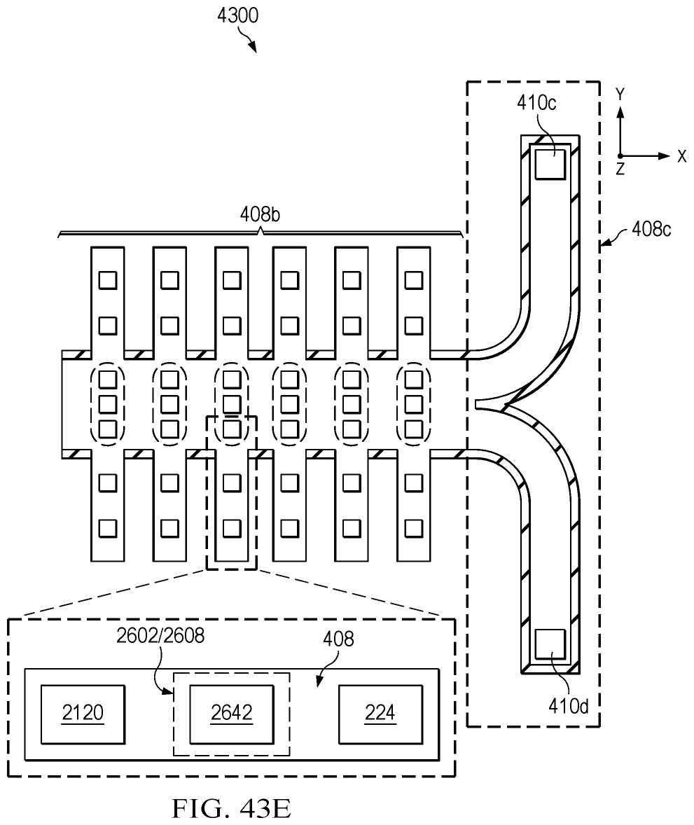

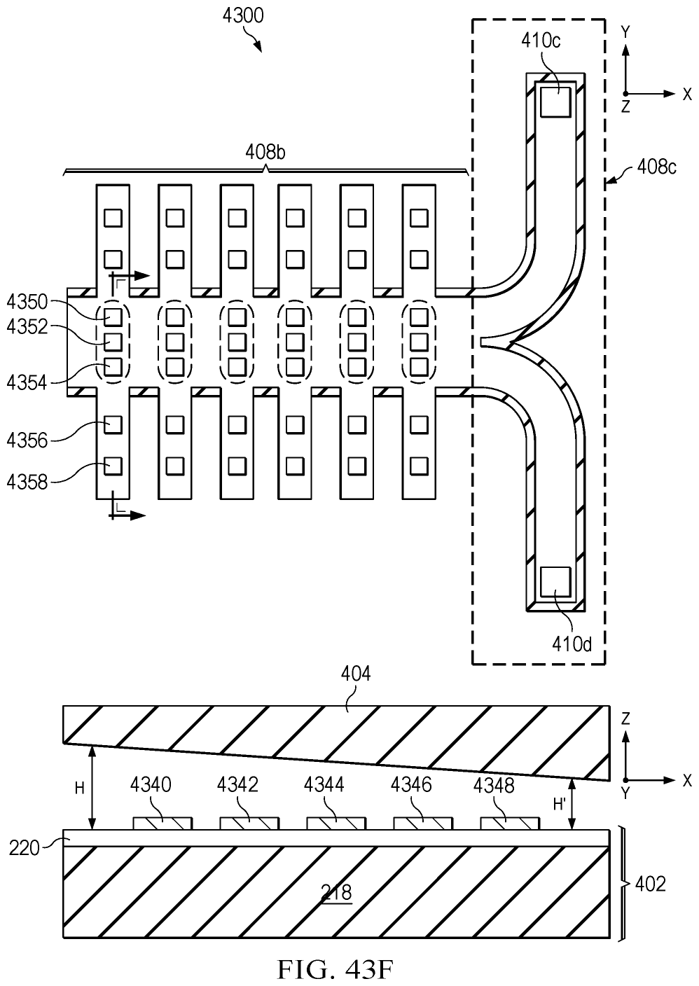

In some examples, a microfluidic sensor can include sensor terminals arranged in a two-dimensional array. Such arrangements allow spatiotemporal tracking of mixing (or reactions due to mixing) between two fluids. FIGS. 43A and 43B are schematics illustrating examples of microfluidic sensor 4300 including sensor terminals arranged in a two-dimensional array.

FIG. 43A illustrates a plan view of an example microfluidic sensor 4300. Microfluidic sensor 4300 can be an integrated circuit including fluidic structure 404 that encloses fluid cavity 408. Fluidic structure 404 can include openings 410a, 410b, 410c, and 410d. Openings 410a and 410b can extend to a branch portion 408a of fluid cavity 408, and openings 410c and 410d can extend to a branch portion 408c of fluid cavity 408. Fluid cavity 408 also includes a middle portion 408b coupled between branch portions 408a and 408c. Openings 410a and 410b can be inlets and opening 410c and 410d can be outlets. Opening 410a can receive a first fluid (e.g., fluid 4110), and opening 410b can receive a second fluid (e.g., fluid 4112). Branch portion 408a can separate the first and second fluids until they converge at middle portion 408b, and the first and second fluids can mix as they flow across middle portion 408b. The mixture can enter branch portion 408c and exit fluid cavity 408 via openings 410c and 410d.

Also, microfluidic sensor 4300 can include sensor terminals 4302, 4304, groups of sensor terminals 4306, such as groups 4306a, 4306b, 4306c, 4306d, 4306e, and 4306f, and sensor terminals 4308 and 4130. Sensor terminals 4302 and 4304 are in branch portion 408a, and sensor terminals 4308 and 4130 are in branch portion 408c. Sensor terminals 4302 can measure the pH of fluid 4110, and sensor terminal 4304 can measure the pH of fluid 4112, prior to the mixing of the fluids in middle portion 408b. Further, sensor terminals 4308 and 4310 can measure the pH of the mixed fluids as they exit through openings 410c and 410d.

Further, each group of sensor terminals 4306 can measure the pH values of the mixture along a first dimension (e.g., along the y-axis) of middle portion 430c. A group of sensor terminals can provide a pH gradient measurement indicating the relative buffer strength or a state of reaction between the two fluids at a particular location along a second dimension (e.g., along the x-axis) of middle portion 430c. As the fluids mix while propagating along the second dimension, the pH gradient may change due to, for example, different diffusion speeds of the fluids, reactions due to mixing of the fluids, and flow speed, etc. Accordingly, different groups of sensor terminals 4306 may output different pH gradient measurements that indicate a progress of mixing or a progress of a chemical reaction between the two fluids with respect to time.

In FIG. 43A, the mixing of two fluids can lead to a liquid junction potential at the junction between the two fluids. Accordingly, the potential difference ΔV between any two ISFETs inside of the middle portion 408b (e.g., between ISFETs coupled to sensor terminals 4306a) can include a pH component and a liquid junction potential component, as follows:

ΔV=b(S×ΔpH_{1/2}+V_{LJP,1/2}) (Equation 10)

In Equation 10, ΔpH_{1/2} can represent the pH component from the mixing of fluids 4110 (fluid 1) and 4120 (fluid 2), and V_{LJP1/2} can represent the liquid junction potential between the two fluids. Both ΔpH_{1/2} and V_{LJP1/2} vary along the second dimension, and V_{LJP1/2} can affect the accuracy of ΔV in representing the pH of the mixed fluids.

FIG. 43B illustrates an example of microfluidic sensor 4300 that provides liquid junction potential measurements as well as measurements of the ohmic drop potential. Referring to FIG. 43B, microfluidic sensor 4300 can include voltage/control terminals 4320 and 4322 on opposite sides of middle portion 408b. Microfluidic sensor 4300 can also include split-off reference channels containing reference buffer solution similar to examples described above (e.g., FIG. 26B). Each split-off reference channel includes a reservoir holding the reference buffer solution (for example, a solution containing 3M KCl) and a fluid conduit structure coupled between the reservoir and middle portion 408b, and a sensor terminal (and an ISFET) in the reservoir. In FIG. 43B, microfluidic sensor 4300 can include a pair of split-off reference channels 4324a-f and split-off channels 4326a-f. Each pair of split-off channels are on opposites sides of one group of sensor terminals 4306a-f (e.g., along the first dimension, the y-axis). For example, split-off reference channels 4324a and 4326a are on opposite sides of sensor terminals 4306a, split-off reference channels 4324b and 4326b are on opposite sides of sensor terminals 4306b, split-off channels 4324c and 4326c are on opposite sides of sensor terminals 4306c, split-off reference channels 4324d and 4326d are on two sides of sensor terminals 4306d, split-off reference channels 4324e and 4326e are on two sides of sensor terminals 4306e, and split-off reference channels 4324f and 4326f are on two sides of sensor terminals 4306f. In some examples, microfluidic sensor 4300 can include a valve between each split-off reference channel and middle portion 408b (e.g., valve 3302 of FIG. 33B), and the valve can be periodically opened or close to allow mixing of the fluid(s) in middle portion 408b with the KCl containing reference buffer solution, so that the junction potential between the fluids and the KCl containing reference buffer solution can be at zero.

Voltage/control terminals 4320 and 4322 can each be coupled to a voltage source to apply an electrical potential across middle portion 408b along the x axis. Also, the sensor terminals at the reservoirs of the split-off channels are in contact of the KCl containing reference buffer solution having a constant pH_{ref}. Accordingly, these sensor terminals can measure the electrical potentials at the junction between the split-off channels and middle portion 408b. The potential differences measured by the sensor terminals for each pair of split channels on two sides of middle portion 408b can have components representing the pH within middle portion 408b, and the ohmic drop between voltage/control terminals 4320 and 4322.

FIG. 43C illustrates a circuit model 4340 representing the electrical potentials between sensor terminals 4342 and 4344 of split-off channels 4324a and 4326a and across sensor terminals 4306a. Referring to circuit model 4340. ISFETs coupled to sensor terminals 4342 and 4344 can include a liquid junction potential between fluid 4110 and KCl of V_{1|KCl} (which is close to 0 mV), a potential V_{1/2} that reflects the electrical potential in middle portion 408b, and another liquid junction potential between fluid 4120 and KCl of V_{2|KCl} (which is also close to 0 mV). Sensor terminal 4342 can measure a potential of:

V1=b×SλpH_{Ref} (Equation 11)

And sensor terminal 4344 can measure a potential of:

V2=b×(V_{1/2}+S×pH_{Ref}) (Equation 12)

Since b is known, the potential difference V_{1/2} V_{IJP,1/2} can be obtained by the difference between V2 and V1. Since the ohmic drop potential depends on the location along the x axis within middle portion 408b, which is identical for opposite terminals such as 4324a and 4326a, there is no ohmic drop component in Equations 11 and 12.

Accordingly, the ohmic drop potential V_{Ohm} between two horizontally (i.e., along the x axis) arranged split-off reference channels such as 4324a and 4324b can be obtained by subtraction of their respective measured potentials, which will result in the potential difference V_{1/2}=V_{Ohm}, since no liquid junction component arises between horizontally arranged reference channels.

FIG. 43D illustrate another example of microfluidic sensor 4300. In FIG. 43D, microfluidic sensor 4300 can include additional inlets 410e and 410f on opposite sides of middle portion 408b. Each of inlets 410e and 410f can receive a KCl containing reference buffer solution, which can enter middle portion 408b from the opposite sides. Sensor terminals within each sensor terminal group (e.g., 4306a) on opposite sides of middle portion 408b along the y-axis (e.g., sensor terminal 4306a0 and 4306a1 in FIG. 43D) can sense a potential difference V_{1/2}−V_{IJP,1/2}. Also, sensor terminals in different sensor terminal groups (e.g., 4306a and 4306b) can provide a measurement of the ohmic drop potential V_{Ohm} as described above.

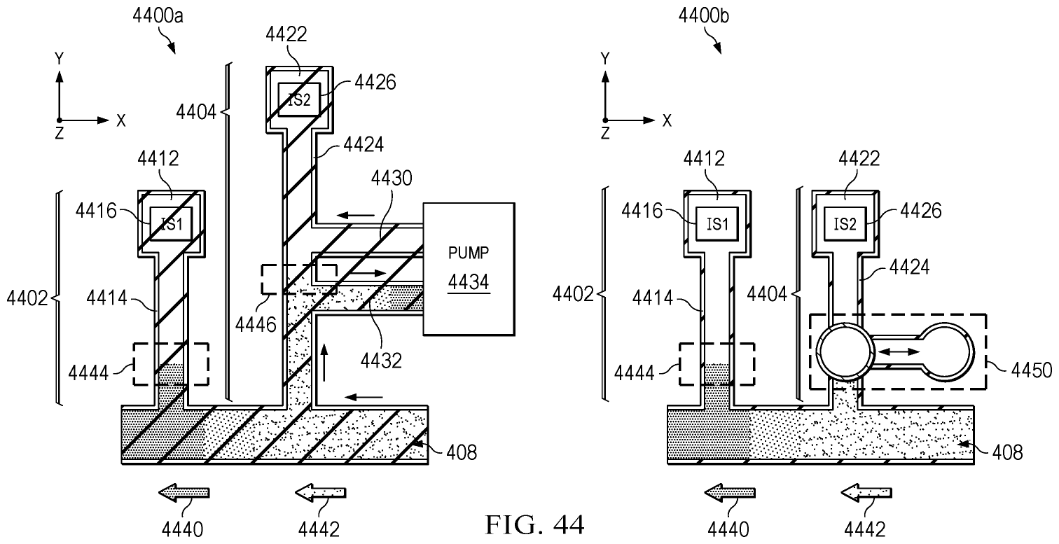

FIG. 43E and FIG. 43F illustrate additional examples of microfluidic sensor 4300 to measure (or provide an estimation of) ionic strength. Referring to FIG. 43E, microfluidic sensor 4300 can include a nanofluidic channel 2608 of FIGS. 26A-26C in each split-off channel and each split-off channel can include multiple sensor terminals similar to microfluidic sensor 2100b of FIG. 26C. For example, sensor terminal labelled “1” can correspond to sensor terminal 2120, sensor terminal labelled “2” can correspond to sensor terminal 2642, and sensor terminal labelled “3” can correspond to sensor terminal 224. If a measured potential difference between the ISFETs coupled to 2120, 2642, and 224 arises, this may indicate a low ionic strength. In some examples, as shown in FIG. 43F, the split-off channel may include multiple sensor terminals including sensor terminals 4350, 4352, 4354, 4356, and 4358, and the split-off channel height may decrease (e.g., from H to H') with distance from middle portion 408b. As soon as the Debye length is on the same order as the reduced channel height H', nanofluidic surface potentials will arise and the respective ISFET coupled to the sensor terminal underneath H' will show a non-zero potential deviation with regards to the potential of the previous, larger channel height. Since the Debye length d is directly correlated to the ionic strength I via d˜I^{-0.5}, such an arrangement can be used to measure the ionic strength. Additional 4-electrode impedance structures (omitted in the FIGS. 43 and 44 for brevity) can serve to do a conductivity measurement to further confirm the ionic strength measurement and give additional confidence in the measurement result.

FIG. 44 are schematics illustrating examples of a microfluidic sensor 4400 to support measurement of a liquid junction potential between two fluids, in a case where the two fluids are introduced to fluid cavity 408 sequentially. The fluids may be introduced into fluid cavity 408 sequentially to, for example, support differential sensing as described above. FIG. 44 illustrates a microfluidic sensor 4400a and a microfluidic sensor 4400b. Each of microfluidic sensors 4400a and 4400b can include split-off reference channels 4402 and 4404. Split-off reference channel 4402 includes a reservoir 4412 to hold a 3M KCl containing reference buffer solution, a fluid conduit structure 4414 coupled between reservoir 4412 and fluid cavity 408, and a sensor terminal 4416 in reservoir 4412. Also, split-off reference channel 4404 includes a reservoir 4422 to hold a 3M KCl containing reference buffer solution, a fluid conduit structure 4424 coupled between reservoir 4422 and fluid cavity 408, and a sensor terminal 4426 in reservoir 4422. Split-off reference channel 4402 may include a similar arrangement as described for 4404, but is omitted in FIG. 44 and the following figures showing similar arrangements for brevity.

In addition, microfluidic sensor 4400a includes openings 4430 and 4432 at fluid conduit structure 4424, and a pump 4434 coupled to openings 4430 and 4432. Cavity 408 of microfluidic sensor 4400 can first be filled with a first fluid 4440, followed by a second fluid 4442. After cavity 408 is filled with first fluid 4440, a liquid junction 4444 can form between the KCl containing reference buffer solution and first fluid 4440. When second fluid 4442 enters cavity 408 to displace or mix with first fluid 4440, ump 4434 can ump the KCl containing reference buffer solution into fluid conduit structure 4424 via opening 4430 and remove first fluid 4440 from fluid conduit structure 4424 via opening 4432. The pump action can create a liquid junction 4446 between the KCl containing reference buffer solution and second fluid 4442. Accordingly, the potential difference sensed by sensor terminals 4416 and 4426 in microfluidic sensor 4400a can represent the junction potential between first fluid 4440 and second fluid 4442. In some examples fluid conduit structure 4414 can also include a pump to perform similar operations as um 4434.

Also, microfluidic sensor 4400b includes a valve 4450 (e.g., valve 3302 of FIGS. 33B and 33C at fluid conduit structure 4424. When cavity 408 is filled with first fluid 4440, valve 4450 can be closed to disconnect fluid conduit structure 4424 and reservoir 4422 from cavity 408. First fluid 4440 can flow into fluid conduit structure 4414, and liquid junction 4444 between the KCl containing reference buffer solution and first fluid 4440 can be created in fluid conduit structure 4414. When second fluid 4442 enters cavity 408 to displace or mix with first fluid 4440 (and equilibrium is reached), valve 4450 can be opened, which allows second fluid 4442 to enter fluid conduit structure 4424, and liquid junction 4446 (not shown in microfluidic sensor 4400b can be created in fluid conduit structure 4424 between the KCl containing reference buffer solution and second fluid 4442. Accordingly, the potential difference sensed by sensor terminals 4416 and 4426 in microfluidic sensor 4400b can also represent the junction potential between first fluid 4440 and second fluid 4442. In some examples, fluid conduit structure 4424 can also include a pump or a valve to perform similar operations as valve 4450.

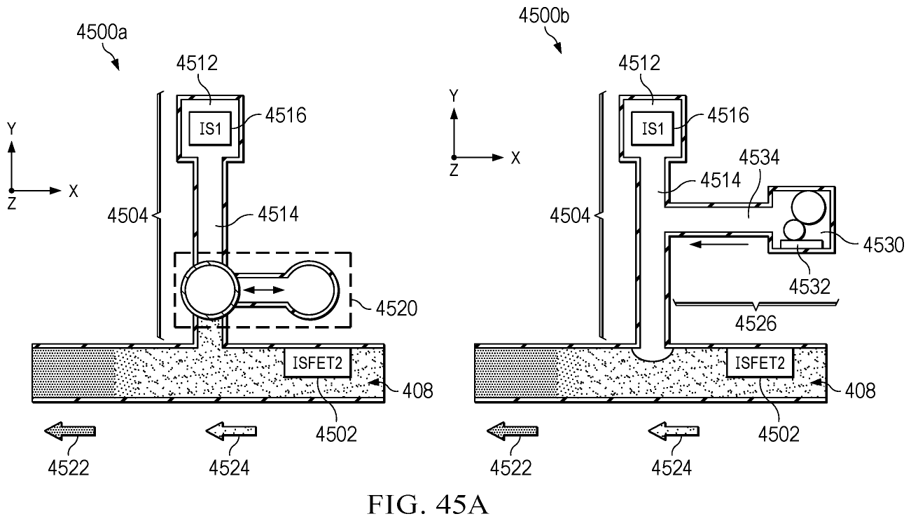

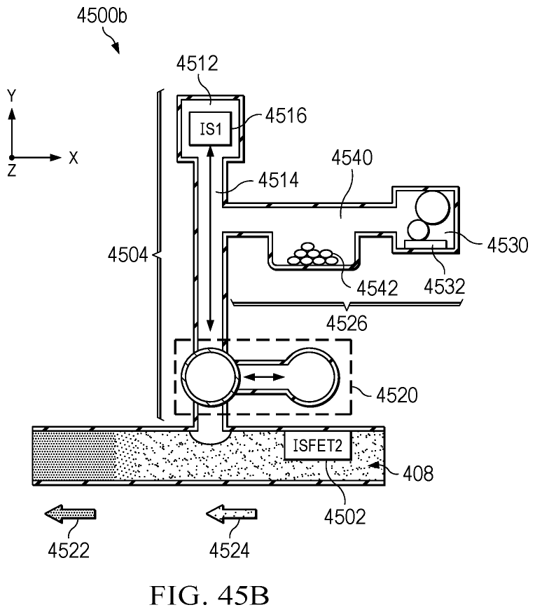

FIG. 45A and FIG. 45B are schematics illustrating examples of a microfluidic sensor 4500 to support elimination of a liquid junction potential between two fluids, in a case where the two fluids are introduced to fluid cavity 408 sequentially. The fluids may be introduced into fluid cavity 408 sequentially to, for example, support differential pH sensing as described above. To eliminate the liquid junction potential between the two fluids, microfluidic sensor 4500 can bring the fluid being measured/sensed mix with a KCl containing reference buffer solution to bring the liquid junction potential of the fluid to zero, and the liquid junction potential component in the pH measurement of the fluid can be eliminated or at least attenuated.

FIG. 45A illustrates a microfluidic sensor 4500a and a microfluidic sensor 4500b. Each of microfluidic sensors 4500a and 4500b includes fluid cavity 408, a sensor terminal 4502 in fluid cavity 408, and a split-off reference channel 4504. Split-off reference channel 4504 includes a reservoir 4512 to hold a 3M KCl containing reference buffer solution, a fluid conduit structure 4514 coupled between reservoir 4512 and fluid cavity 408, and a sensor terminal 4516 in reservoir 4512.

Microfluidic sensor 4500a also includes a valve 4520 (e.g., valve 3302 of FIGS. 33A and 33B) to control the release of the KCl solution into fluid cavity 408 from reservoir 4512. When a first fluid 4522 enters and fills fluid cavity 408, valve 4520 can be opened to release the KCl containing reference buffer solution into fluid cavity 408, and the KCl containing reference buffer solution mixes with first fluid 4522. The mixing can set the liquid junction potential of first fluid 4522 to zero, and a potential difference measured by sensor terminals 4502 and 4516 can represent, for example, the pH of first fluid 4522, with the liquid junction potential component eliminated or at least attenuated to improve the precision of the pH measurement. Also, as a second fluid 4524 enters fluid cavity 408, before second fluid 4524 displaces first fluid 4522 and equilibrium is reached, valve 4520 can be closed to op the KCl containing reference buffer solution from mixing with the fluids in fluid cavity 408. After second fluid 4524 displaces first fluid 4522 in fluid cavity 408 and equilibrium is reached, valve 4520 can be opened to release the KCl containing reference buffer solution into fluid cavity 408 and set the junction potential of second fluid 4524 to zero. A potential difference measured by sensor terminals 4502 and 4516 can then represent for example, the pH of second fluid 4524, with the liquid junction potential component also eliminated or at least attenuated to improve the precision of the pH measurement.

Also. Microfluidic sensor 4500b includes a pump 4526 including a reservoir 4530, a control terminal 4532 in reservoir 4530, and a fluid conduit structure 4534 coupled between reservoir 4530 and fluid conduit structure 4514. Reservoir 4530 can hold the KCl containing reference buffer solution. Control terminal 4532 can be coupled to a voltage source (not shown in the figure), and can start an electrolysis process to generate gas responsive to receiving a signal from the voltage source. The gas can force the KCl containing reference buffer solution out of reservoir 4530 through fluid conduit structures 4534 and 4514 into fluid cavity 408. Pump 4526 can be enabled to force the KCl containing reference buffer solution into fluid cavity 408 after first fluid 4522 fully fills fluid cavity 408 and reaches equilibrium, and after second fluid 4524 fully displaces (or mixes with) first fluid 4522 and reaches equilibrium. Pump 4526 can be disabled during other times.

Also, FIG. 45B illustrates a microfluidic sensor 4500c including both valve 4520 and pump 4526, and a salt container 4540 coupled between fluid conduit structure 4514 and reservoir 4530. Microfluidic sensor 4500c can also include KCl salt crystals 4542 in salt container 4540. The KCl salt crystals 4542 can dissolve so that the KCl containing reference buffer solution in reservoirs 4512 and 4530 are saturated. Such arrangements can allow precise pH measurement over a long time.

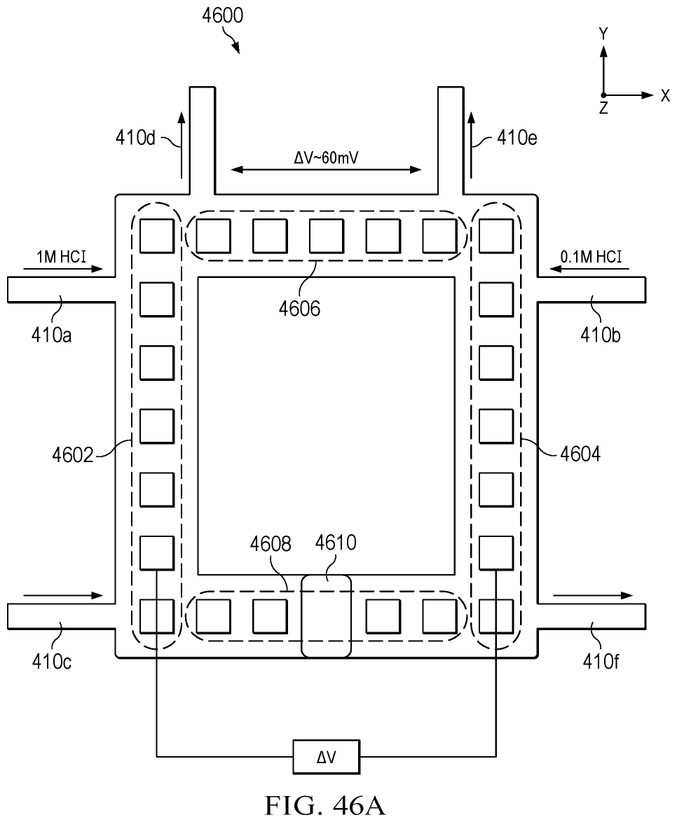

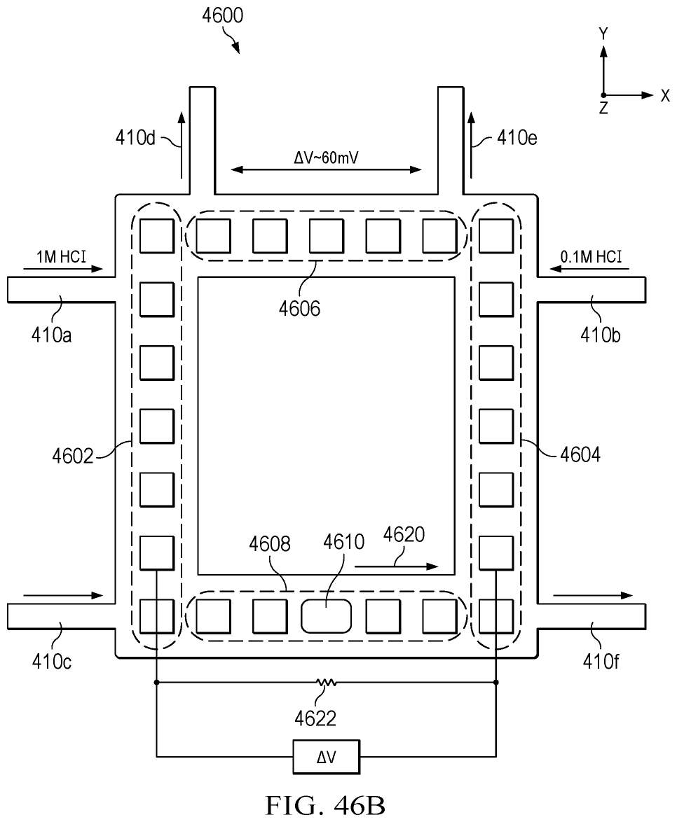

FIGS. 46A and 46B illustrate plan view of an example microfluidic sensor 4600. Microfluidic sensor 4600 can include components of microfluidic sensor 4300, such as fluid cavity 408 enclosed in fluidic structure 404, and openings 410a. 410b. 410c. 410d. 410e, and 410f. Fluid cavity 408 can be in the form a ring and include sensor terminals along the ring and between the openings. For example, sensor terminal group 4602 can be along art of the ring between openings 410a and 410c, sensor terminal group 4604 can be along part of the ring between openings 410b and 410f, sensor terminal group 4606 can be along part of the ring between openings 410d and 410e, and sensor terminal group 4608 can be along part of the ring between openings 410c and 410f.

Microfluidic sensor 4600 can provide a 2-dimensional gradient generator, which can be used to determine electrochemical properties of two unknown fluids, or of one unknown fluid. In the example of FIGS. 46A and 46B, different molar concentrations of a fluid, such as hydrochloric acid. (HCl) are introduced. As an example for the two unknown fluids, opening 410a can receive 1M HCL and opening 410b can receive 0.1M HCl. Opening 410c can receive a KCl containing reference buffer solution (e.g., 3M KCl). Also, openings 410d. 410e, and 410f can receive the outflow of the respective fluids. A concentration/diffusion gradient between the 1M HCl and the 0.1M HCl solution is formed across fluid cavity 408 between openings 410a and 410b. Also a concentration/diffusion gradient between the 1M HCl and the KCl buffer solution is formed across fluid cavity 408 between openings 410a and 410c. Further, a concentration/diffusion gradient between the 0.1M HCl and the KCl buffer solution is also formed across fluid cavity 408 between openings 410b and 410f.

Also, microfluidic sensor 4600 can include a valve 4610, which can be a bubble valve. Valve 4610 can be controlled to stop (or enable) ionic electric currents and block (or unblock) the flow of KCl containing reference buffer solution between openings 410c and 410f for short periods of time. During that time, the potential difference ΔV sensed by sensor terminal groups on two sides of valve 4610, such as sensor terminal groups 4602 and 4604, can be equal to the liquid junction potential between the two fluids; here in the example 1M and 0.1M HCl. The generation of the potential difference ΔV leads to formation of a liquid junction battery.

Also, referring to FIG. 46B, when valve 4610 is opened, the flow of KCl can resume, and the potential difference ΔV measured by sensor terminal groups 4602 and 4064 can decrease. The decrease of the potential difference can be due to an ionic current 4620 which can flow and decrease the potential due to the ohmic drop across the liquid unction battery. The ohmic drop is represented by resistor 4622 in FIG. 46B. The flow of current depends on the total conductivity of the fluids located across the cavity 408, and acts to equilibrate the system, which will change the gradient between openings 410a and 410b, and this change of potential (and in some cases, of pH) can be detected by sensor terminal group 4606 across the gradient between openings 410a and 410b. This change depends on properties such as ionic activities and ionic strength, and can give an indication as to the nature of the (difference between the) first two fluids. This allows study of various electrochemical properties of the two fluids (1M and 0.1M HCl) under a potential difference, as well as fingerprinting of an unknown fluid.

In some examples, a method of operating an example microfluidic sensor as described herein can include: receiving first and second electrical potential measurements from, respectively, a first sensor terminal and a second sensor terminal of a microfluidic sensor when the first and second sensor terminals are exposed to a first fluid; exposing the first sensor terminal to a second fluid at a second time; exposing the second sensor terminal to the second fluid at a third time after the second time by delaying a transportation of the second fluid to the second terminal by a restriction structure of the microfluidic sensor, receiving third and fourth electrical potential measurements from, respectively the first and second sensor terminals between the second and third times; and generating a pH measurement of the second fluid based on a difference between the second and fourth electrical potential measurements.

In some examples, the method further comprises applying an electrical potential to the first and second fluids via one of: a discrete reference electrode separate from the microfluidic sensor, or a voltage terminal on a surface of the microfluidic sensor.

In some examples, the first and second sensor terminals are in the restriction structure.

In some examples, the second sensor terminal is in a nanofluidic channel within the restriction structure.

In some examples, a method of operating an example microfluidic sensor as described herein can include: receiving a first electrical potential measurement from a first sensor terminal in a buffer solution, in which the first sensor terminal is in a first reservoir including the buffer solution, the first reservoir is coupled to a fluid cavity via a first connection structure, the fluid cavity is also coupled to a second reservoir including the buffer solution via a second connection structure, the microfluidic cavity includes a first fluid, and the first fluid mixes with the buffer solution and forms a first fluid and buffer liquid junction in the first and second connection structures enabling a second fluid to enter the second connection structure via the fluid cavity to mix with the buffer solution and to form a second fluid and buffer liquid junction in the second connection structure; receiving a second electrical potential measurement from a second sensor terminal in the second reservoir when the second fluid and buffer liquid junction is in the second connection structure; and genera ng an electrical potential representing a liquid junction potential between the first and second fluids.

In some examples, the method further comprises removing the first fluid from the second connections structure by a pump.

In some examples, the method further comprises blocking the first fluid from entering the second connections structure when the first fluid enters the fluid cavity.

In some examples, a method of operating an example microfluidic sensor as described herein can include: enabling a first fluid to enter a fluid cavity; releasing a buffer solution from a reservoir into the fluid cavity to mix with the first fluid; receiving first and second electrical potential measurements from, respectively, a first sensor terminal in the reservoir and a second sensor terminal in the fluid cavity; generating a first electrical potential difference based on the first and second electrical potential measurements; blocking the buffer solution from entering the fluid cavity; enabling a second fluid to enter the fluid cavity; releasing the buffer solution from the reservoir into the fluid cavity to mix with the second fluid; receiving third and fourth electrical potential measurements from, respectively, the first and second sensor terminals; generating a second electrical potential difference based on the third and fourth electrical potential measurements; and generating a pH measurement of the second fluid based on the first and second electrical potential differences to reduce a liquid junction potential component between the first and second fluids in the pH measurement.

In some examples, the blocking of the buffer solution is by a bubble pump.

In some examples, the reservoir is a first reservoir, and the method further comprises flowing the buffer solution through a second reservoir including salt crystals to saturate the buffer solution.

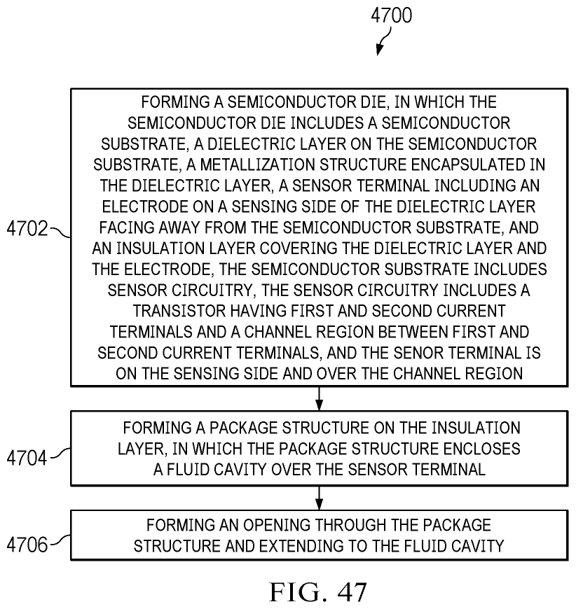

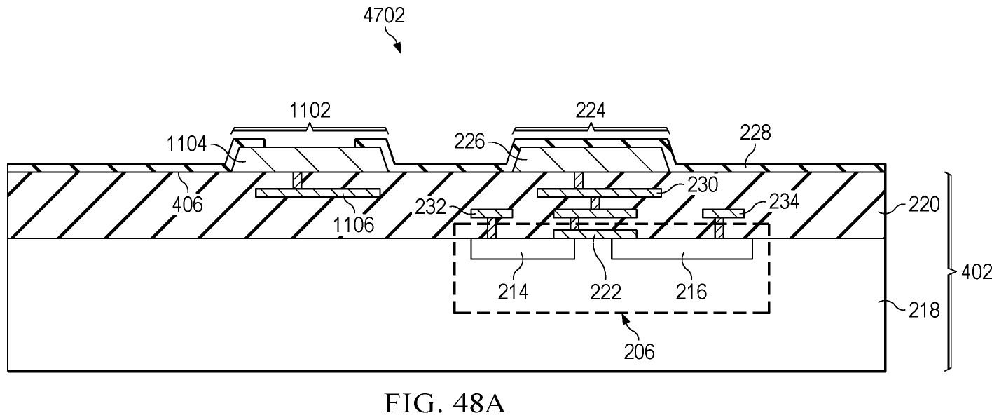

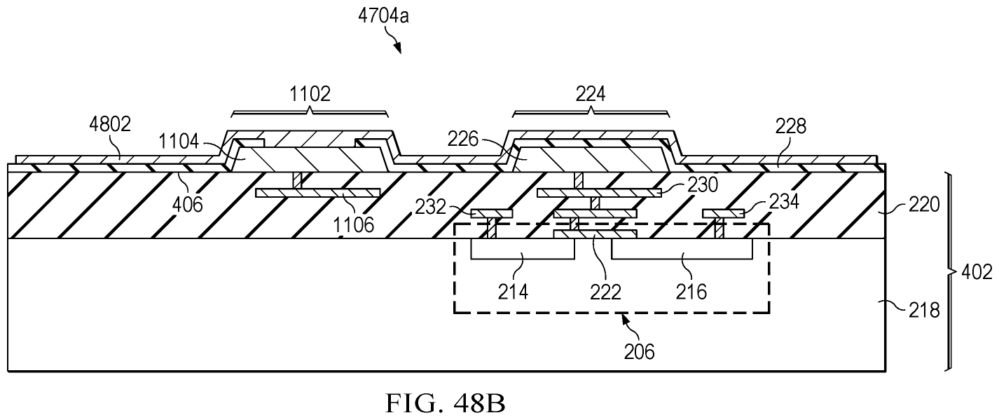

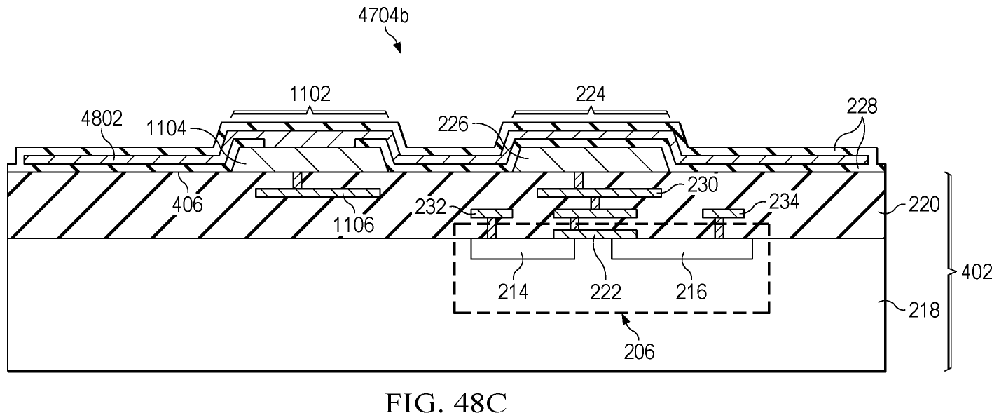

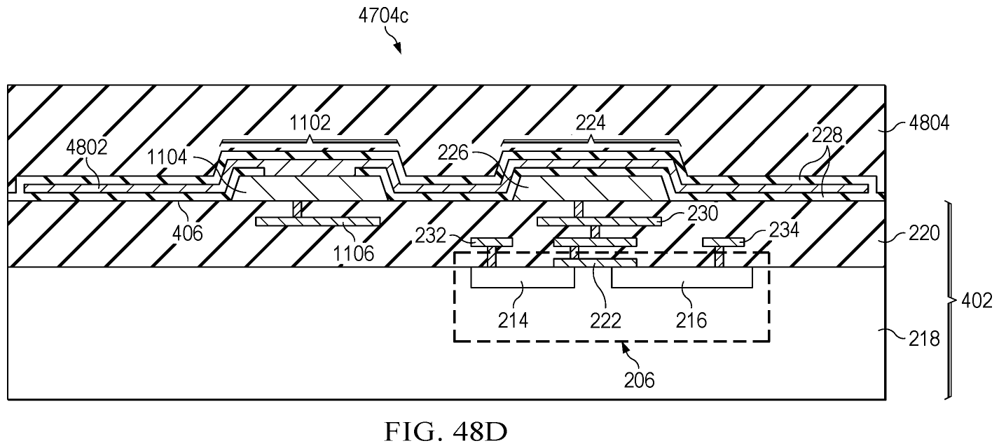

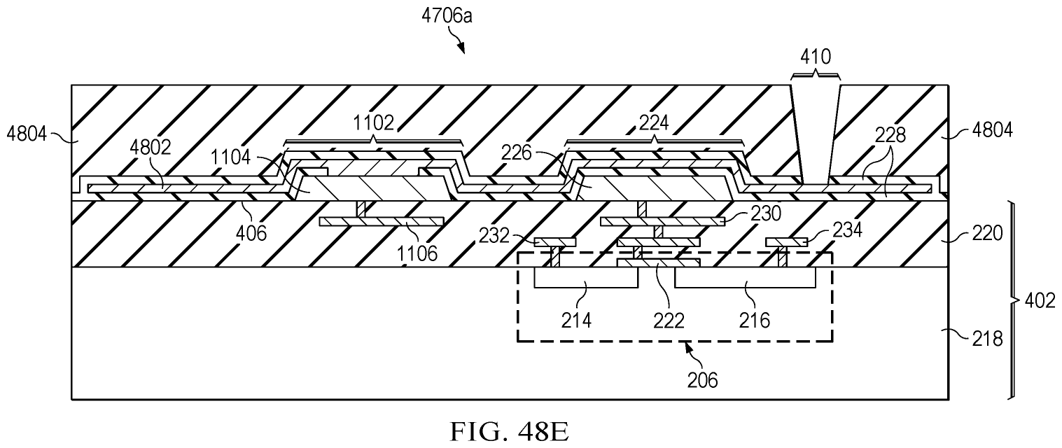

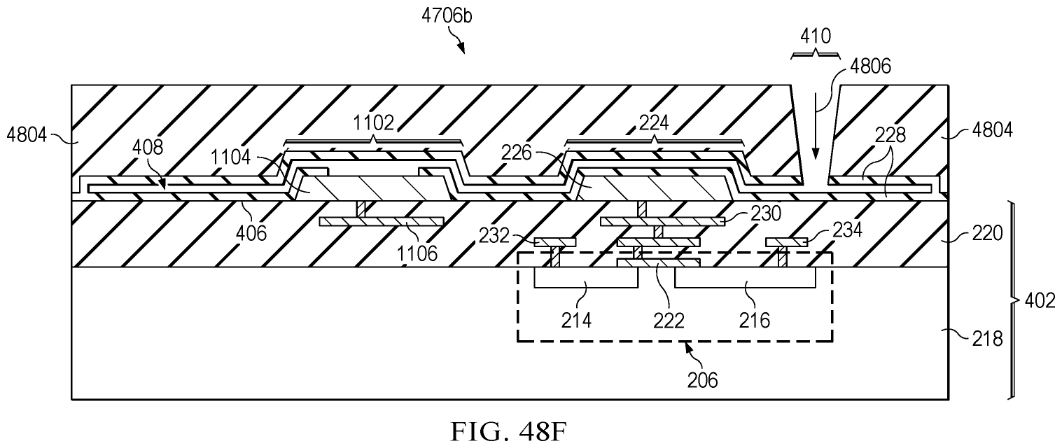

FIG. 47 illustrates a method of fabricating an integrated circuit microfluidic sensor, such as examples of microfluidic sensor illustrated in FIGS. 4 through 46. FIG. 47 illustrates a flowchart 4700 of the example method, and FIGS. 48A. 48B. 49A, and 49B are schematics illustrating various operations of the example method of FIG. 47.

Referring in FIG. 47 and FIG. 48A, in operation 4702, semiconductor die 402 is formed, in which semiconductor die 402 includes semiconductor substrate 218, dielectric layer 220 on the semiconductor substrate, a metallization structure encapsulated in the dielectric layer, an electrode on a sensing side of the dielectric layer facing away from the semiconductor substrate, and an insulation layer covering the dielectric layer and the electrode, the semiconductor substrate includes sensor circuitry, the sensor circuitry includes a transistor having first and second current terminals and a channel region between first and second current terminals, and the senor terminal is on the sensing side and over the channel region, and the sensor terminal is on the sensing side and over the channel region.

Referring to FIG. 48A, in operation 4702, semiconductor die 402 includes semiconductor substrate 218, and dielectric layer 220 on semiconductor substrate 218. The dielectric layer 220 has a sensing side 406 facing away from semiconductor substrate 218. Semiconductor die 402 includes one or more transistors configured as ISFETs, such as an EG-ISFET 206 including gate terminal 222, source terminal 214, and drain terminal 216, and channel region 217 between the drain and source terminals as shown in FIG. 2A. In some examples, semiconductor die 402 includes an OG-ISFET 206 as shown in FIG. 2B. Semiconductor die 402 also includes a metallization structure embedded (or surrounded) in dielectric laver 220 including interconnect 230, 232, and 234 coupled to the respective gate terminal 222 (in a case of EG-ISFET) drain terminal 214, and source terminal 216. Semiconductor die 402 also includes insulation layer 228 covering sensing side 406 of dielectric layer. Examples of insulation layer 228 can include SiO₂. Si₃N₄. Al₂O₃, and Ta₂O₅.

Semiconductor die 402 also includes one or more sensor terminals on sensing side 406, such as sensor terminal 224 including an electrode 226 covered by insulation layer 228. Electrode 226 can be platinum or other noble metals and can be coupled to gate terminal 222 via interconnect 230. In some examples, semiconductor die 402 can also include a voltage terminal on sensing side 406, such as voltage terminal 1102 including an electrode 1104 partially covered by insulation layer 228.

In some examples, as part of operation 4702, a metal layer (Platinum or other noble metals) can be formed on sensing side 406 of dielectric layer 220. The metal layer can be formed by various techniques, such as vacuum deposition (e.g., chemical vapor deposition and physical vapor deposition) and electroplating, followed by patterning of the metal laer (e.g., photolithography and selective etching) to form electrodes 226 and 1104 and to expose dielectric layer 220. Insulation laver 228 can be formed on the patterned metal layer and the exposed dielectric layer 220 using various techniques, such as thermal oxidation, chemical vapor deposition, etc. Insulation layer 228 can be further patterned to expose part of electrode 1104 to form voltage terminal 1102.

Referring again to FIG. 47, in operation 4704, fluidic structure 404 is formed on insulation laer 228, in which fluidic structure 404 encloses fluid cavity 408 over at least sensor terminal 224.

FIGS. 48B-F illustrate examples of sub-operations of operation 4704 to form fluidic structure 404. Referring to FIG. 48B, in sub-operation 4704a, a sacrificial metal layer 4802 can be formed on insulation layer 228, sensor terminal 224, and voltage terminal 1102. In some examples, sacrificial metal laver 4802 can include a Tungsten-Titanium (TiW) alloy. Sacrificial metal layer 4802 can also include a mixture of Chromium (Cr), Nickel (Ni), TiWn Al, Co, TiW, Al, Co, TIN, Ti, Si₃N₄, SiO₂, Pt, Cu, Ta, TaN, or Al₂O₃. Sacrificial metal layer 4802 can have a high etch rate to provide a high selectivity against other materials not to be etched inside fluid cavity 408.

Sacrificial metal layer 4802 can define the footprint and cross-sectional shape of fluid cavity 408. In some examples, multiple layers of sacrificial metal layer 4802 can be formed on insulation layer 228 to define different heights of fluid cavity 408. For example, one layer of sacrificial metal layer 4802 can define nanofluidic channel 2608 of FIG. 26A, and additional layers of sacrificial metal layer 4802 can define the microfluidic channels of the rest of fluid cavity 408. Sacrificial metal layer 4802 can be formed on insulation laer 228 using various techniques, such as vacuum deposition (e.g., evaporation chemical vapor deposition and physical vapor deposition) and electroplating. In some examples, to create chambers 3312 and 3322, sacrificial metal layer 4802 can be etched using an anisotropic etching operation to have a triangular/trapezoidal cross-sectional, which can define the recessed internal surfaces 3402 and 3404 of chambers 3312 and 3322.

In some examples, the sacrificial material can be deposited (electroplated. CVD, sputtered, etc.) into a pre-defined shape, such as a moat of Si₃N₄ or SiO₂. Sacrificial material can then be planarized. i.e. via CMP or etched back (where some material of the moat is also lost), or reflow in e.g. an oven for materials such as photoresist or spin on glass (SOG)., Later, the sacrificial material can be removed out of the moat.

Referring to FIG. 48C, in an optional sub-operation 4704b, another insulation layer 228 can be formed on sacrificial metal laer 4802, to cover the internal surface of fluid cavity 408 with insulation laer 228. As described above, such arrangements can provide a uniform wetting surface, which can reduce measurement error caused by Zeta potential difference due to the fluid being measured/sensed is in contact with two different wetting surfaces. In some examples insulation laver 228 can be formed by a passivation of sacrificial metal layer 4802.

Referring to FIG. 48D, in sub-operation 4704c, an insulation layer 4804 can be formed on sacrificial metal layer 4802 to form fluidic structure 404, and insulation layer 4804 defines fluid cavity 408. In some examples, insulation layer 4802 can be formed as a passivation layer by continuing the passivation of sacrificial metal layer 4802 as part of a wafer fabrication operation. In some examples, insulation layer 4802 can be formed as a, passivation layer including SiO₂. SiN₄, or a mixture of both. In some examples, insulation layer 4802 can be formed by chemical vapor deposition (CVD), spin coating, metal deposition (if a mixture of dielectric and metals), etc.

Referring again to FIG. 47, in operation 4706, opening 410 can be formed through fluidic structure 404 and extending into fluid cavity 408.

Referring to FIG. 48E and FIG. 48F, operation 4706 can include sub-operations 4706a and 4706b. In sub-operation 4706a, opening 410 can be formed through insulation layers 4804 and 228 to expose part of sacrificial metal layer 4802. Opening 410 can be formed by selectively etching (after photolithography, not shown) a particular location on insulation layer 4804. Photoresist is subsequently removed wet-chemically or via ashing. Also, in sub-operation 4706b, a reagent 4806 (e.g., hydrogen peroxide) can be provided via opening 410 to etch away sacrificial metal layer 4802 to form fluid cavity 408.

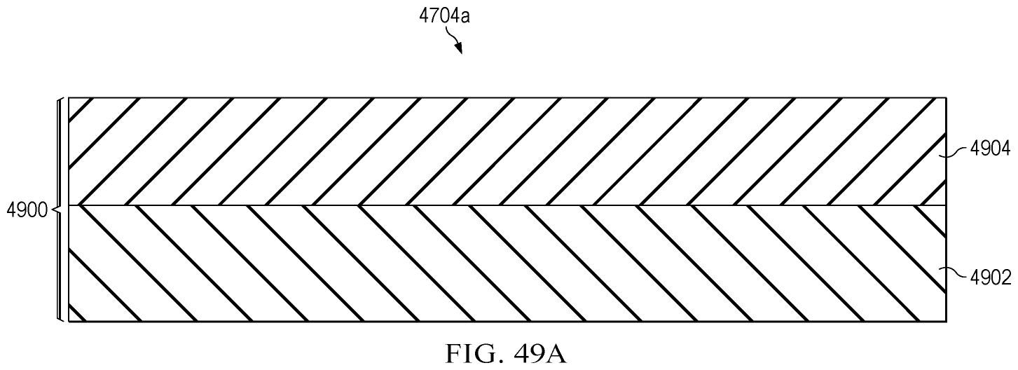

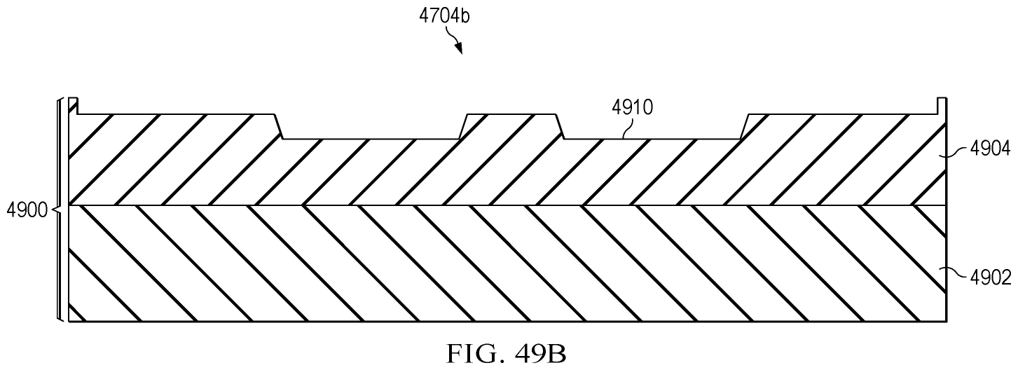

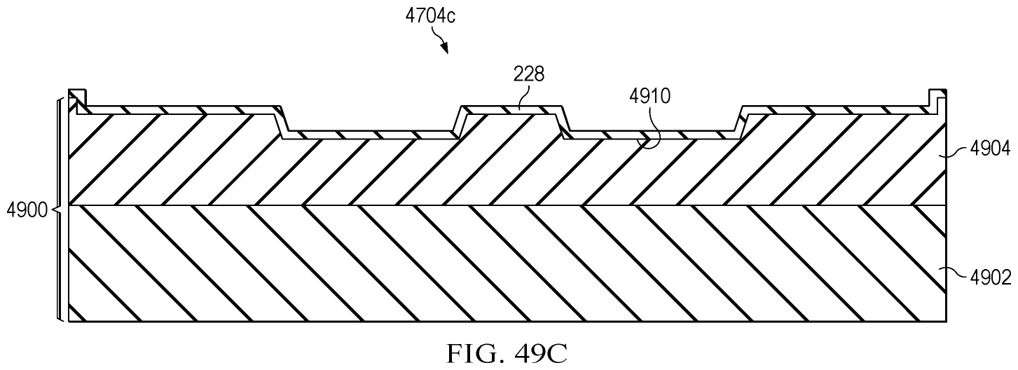

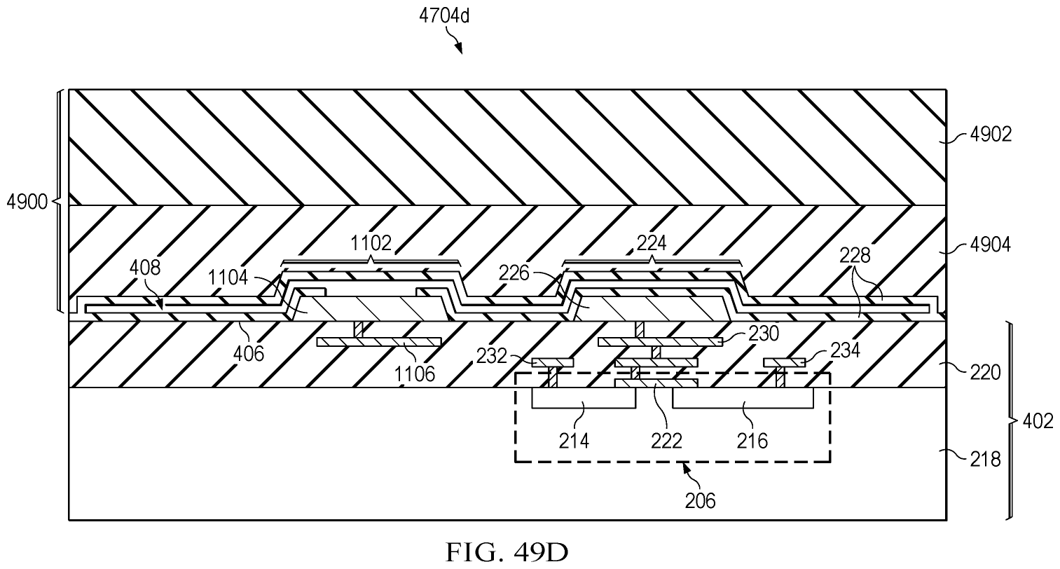

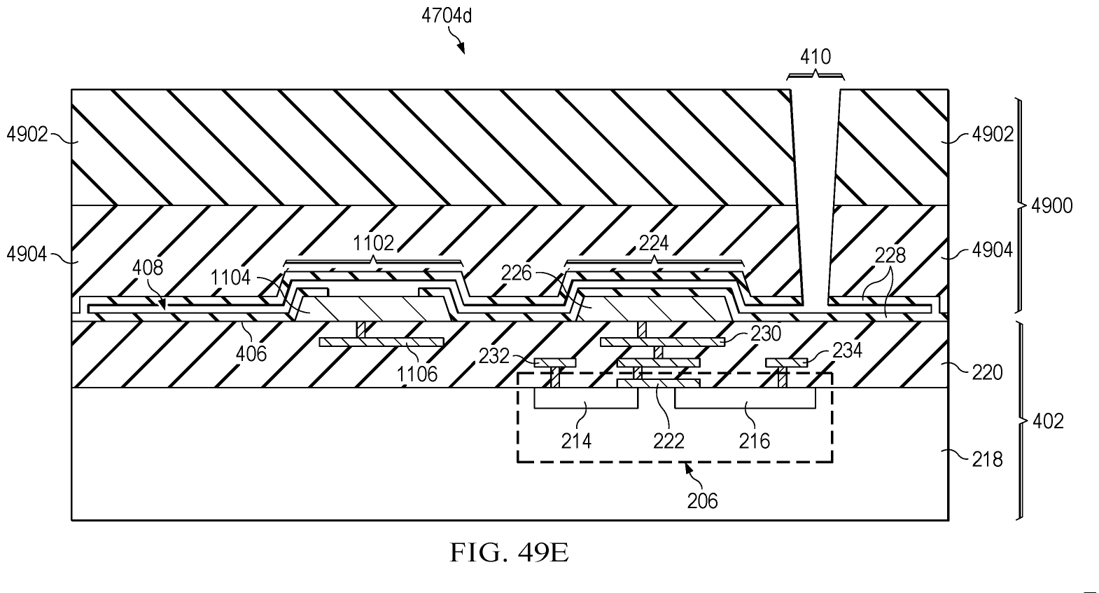

FIG. 49A-49E illustrate additional examples of sub-operations 4704 and 4706. Referring to FIG. 49A, in sub-operation 4706a, a semiconductor die 4900 having a substrate 4902 and an insulation layer 4904 can be formed. Insulation layer 4904 can be a, passivation layer and can include SiO₂. Si₃N₄, or a mixture of both.

Referring to FIG. 49B, in sub-operation 4706b, insulation layer 4904 can be etched to form an indented surface 4910. Indented surface 4910 can define the internal surfaces, footprints, and dimensions (height and width) of fluid cavity 408. Referring to FIG. 49C, in an optional sub-operation 4704c, insulation layer 228 can be formed on indented surface 4910 of insulation layer 4904 so that the internal surfaces of fluid cavity 408 can be covered with insulation layer 228.

Referring to FIG. 49D, in sub-operation 4704c, semiconductor die 4900 can be flipped and attached onto semiconductor die 402 from operation 4702, so that indented surface 4910 of semiconductor die 4900 faces sensing side 406 of semiconductor die 402. The space between indented surface 4910 and sensing side 406 can provide fluid cavity 408, and insulation layer 4904 can provide fluidic structure 404. In some examples, insulation layer 4904 can be bonded to insulation layer 228 by heating, or by anodic bonding.

Also, referring to FIG. 49E, in operation 4708, opening 410 can be formed through substrate 4902 and insulation layer 4904. Opening 410 can be formed by etching. In some examples, substrate 4902 can be removed from insulation layer 4904 by a polishing operation. Alternatively, opening was already formed as part of 4706a-c.

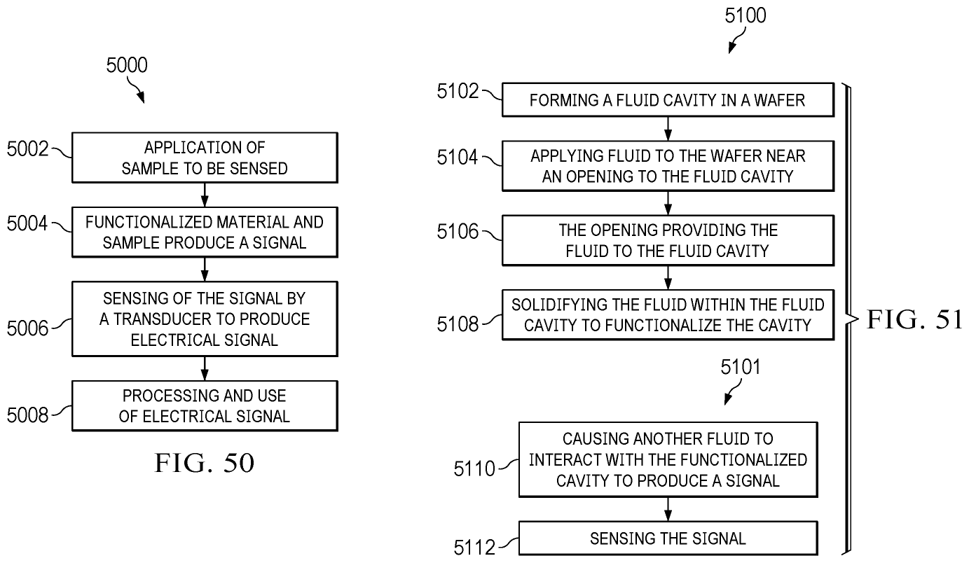

FIG. 50 is a flow diagram depicting an example process 5400 for sensing substances in functionalized fluid cavities. The process 50100 describes the general operation of the various sensor devices described herein. The process 500 includes the application of a sample to be sensed (5002). For example, such a sample may include DNA, an antigen or antibody, ions, specific enzymes, etc. The sample may be part of a fluid (i.e., a FUT). The FUT is applied to an exterior of the sensor device, as described below, and through capillary action the FUT enters a fluid cavity of the sensor device. The fluid cavity is functionalized, where the fluid cavity contains a functionalization material (e.g., a solid material) that interacts with the FUT to produce a signal indicative of (or due to) a state change (e.g., a physical state change, a biological state change, or a chemical state change) in the functionalization material and/or in the fluid cavity. In some examples, the functionalization material can form a recognition layer or a transducing layer. The signal can represent, for example, a pH change, a change in the amount/state of charge, a change in the potential, etc. The signal can be sensed by a sensor terminal within the fluid cavity. Accordingly, the process 5000 includes the FUT interacting with the functionalization material to produce a signal representing a state change in the functionalization material/fluid cavity that can be sensed by the sensor terminal of the sensor device (5004).

The process 5000 further includes sensing of the signal by the sensor terminal to produce an electrical signal that indicates one or more properties of the substance (5006). A transducer, for example, may be useful for this purpose. The process 5000 also includes the subsequent processing (e.g., amplification and quantization) and use of the electrical signal for any of a variety of purposes (108). For example, the electrical signal may indicate the presence and/or quantity of the substance and, based on that presence or quantity, an alert may be generated and presented to a user, or an action (e.g., a safety action, such as turning off a device or closing a valve) may be performed.

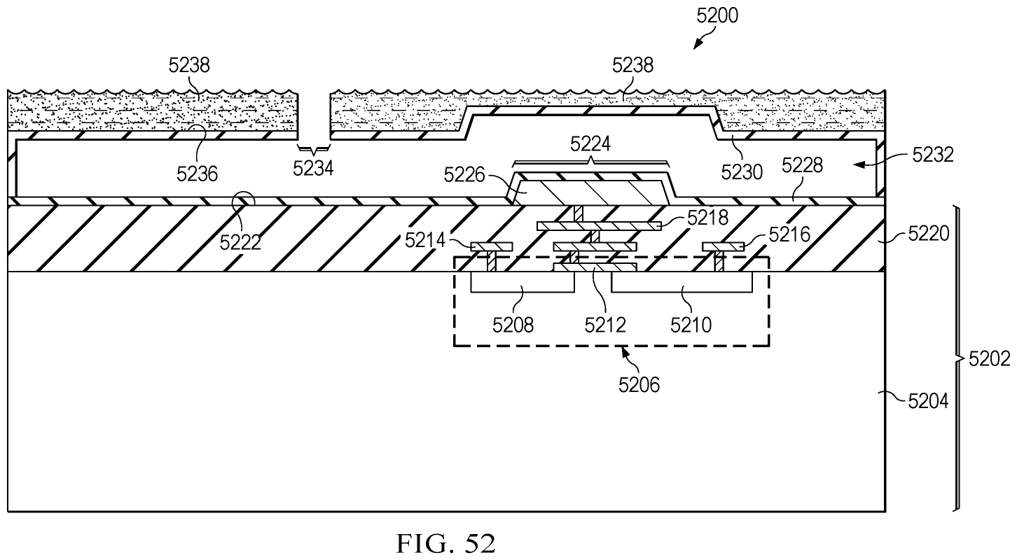

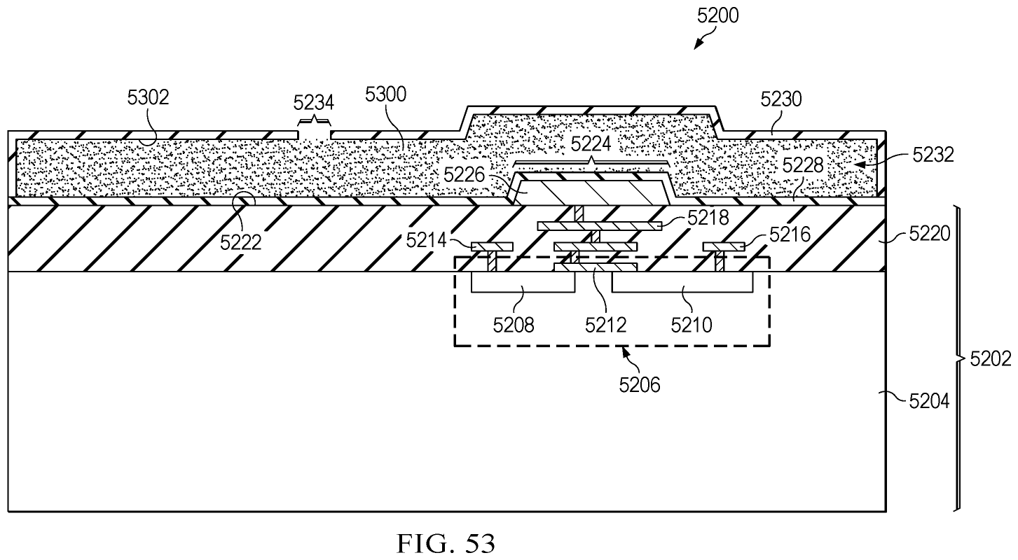

FIG. 51 includes flow diagrams depicting an example process 5100 for fabricating a sensor device with a functionalized fluid cavity, and an example process 5101 for operating the sensor device. FIGS. 52-53 are cross-sectional diagrams of example sensor devices at different stages of the fabrication. Accordingly, FIGS. 51-53 are now described in parallel.

The process 5100 includes forming a fluid cavity in a semiconductor (e.g., silicon) wafer (5102). The fluid cavity may be formed in the wafer during the wafer fabrication stage of manufacture, for example. The fluid cavity may be formed through the appropriate design of photomasks during photolithography to build structures within the wafer that form a cavity. HGT FIG. 52 depicts a sensor device 5200 including a semiconductor die 5202 which comprises a semiconductor substrate 5204. The semiconductor substrate 5204 includes a transistor 5206 having a source terminal 5208, a drain terminal 5210 and a gate terminal 5212. In some examples, transistor 5206 can include an ion-sensitive field effect transistor (ISFET), and gate terminal 5212 can be a floating gate terminal.

A network of metal interconnects 5214, 5216, and 5218, as part of a metallization structure, couples to the source, drain, and gate terminals 5208, 5210, and 5212. The network of metal interconnects 5214, 5216, 5218 is positioned within a dielectric layer 5220, which contacts the semiconductor substrate 5204 as shown. The dielectric layer 5220 has a sensing side 5222 on which a sensor terminal 5224 comprising an electrode 5226 covered by an insulation layer 5228 is positioned. The sensor terminal 5224 is configured to sense one or more properties of any type of substance, such as a biological or chemical substance. The sensor terminal 5224 may comprise a photosensitive element. In examples, the electrode 5226 is a noble metal electrode. In examples, the electrode 3262 can be part of an impedance structure including a bare or passivated electrode pair, or an interdigitated multi-structure. In examples, the electrodes can be part of a gas sensor.

The sensor device 5200 also includes a restriction/fluidic structure 5230 surrounding a fluid cavity 5232. An opening 5234 exposes the fluid cavity 5232 to an exterior of the sensor device 5200. The fluidic structure 5230 has an external surface 5236. In examples, the sensor device 5200 can include a pump or a valve in fluid cavity 5232 to drive a fluid into the channel. In examples, the pump can be in the form of a capillary pump, where fluid cavity 5232 can include a second opening (not shown in the figures), and the sensor device 5200 can include wicking elements at the second opening to act as a capillary pump. In examples where the sensor terminal comprises a photosensitive element, the fluid cavity 5232 may include a light source. In examples, the sensor device 5200 can include a heater in the fluid cavity 5232 (or proximate the fluid cavity 5232) to accelerate a reaction in the fluid cavity 5232 (e.g., between the functionalized cavity and a fluid, or other reactions). In examples, the sensor device 5200 can include physical restriction elements in the fluid cavity 5232, such as macroscopic filters, or having the opening 5234 of a specific size, to prevent penetration of certain molecules into the fluid cavity 5232.

Various examples of processes of forming a fluid cavity in a semiconductor wafer, fluid sensors, electrodes, pumps, valves, heaters, physical restriction elements, etc., are described in FIGS. 1-49E.

In examples, the external surface 5236, the internal walls of the opening 5234, and the internal walls of the fluid cavity 5232 are hydrophilic, where the walls are composed of or are coated with a hydrophilic material that facilitates movement of fluid along these surfaces. The hydrophilic material may have a relatively low contact angle (e.g., less than 60 degrees) for water. A functionalization material or a FUT applied to the external surface 5236, which may contain water, may move toward and into the opening 5234, and from the opening 5234 into the fluid cavity 5232, coating some or all internal walls of the fluid cavity 5232 and possibly filling part or all of the volume of the fluid cavity 5232. In examples, the internal walls of the opening 5234 and the internal walls of the fluid cavity 5232 are hydrophilic, but only a portion of the external surface 5236 (e.g., a predetermined radius from the opening 5234) is hydrophilic, while the remainder of the external surface 5236 is hydrophobic. In such examples, a functionalization material and/or FUT applied near the hydrophilic areas of the external surface 5236 can move toward the opening 5234 as described above, while the hydrophobic areas of the external surface 5236 can prevent or reduce flow of the functionalization material and/or FUT away from the opening 5234, thus causing more of the functionalization material and/or FUT to enter the fluid cavity 5232. In examples, the fluid cavity 5232 has a triangular cross-sectional shape, and in other examples, the fluid cavity 5232 has a rectangular cross-sectional shape.

In operation, a functionalization material enters the fluid cavity 5232 by way of the opening 5234. The functionalization material coats the internal walls of the fluid cavity 5232 and/or at least partially fills the fluid cavity 5232. The functionalization material may be solidified, for example by baking, critical point drying, storage at a certain (low or high) pressure or in a certain atmosphere, ultraviolet (UV) exposure, etc., to functionalize the fluid cavity 5232. The functionalization material may be in the form of a membrane (e.g., a permeable membrane, a non-wettable solid membrane), salt crystals, hydrogels, etc.

Subsequently, a FUT may enter the fluid cavity 5232 by way of the opening 5234 and may interact with the solid, functionalization material inside the fluid cavity 5232, to produce a signal indicative of (or due to) a state change (e.g., a physical state change, a biological state change, or a chemical state change) in the functionalization material and/or in the fluid cavity. The electrode 5226 senses one or more properties of the substance, such as its presence, quantity, etc. The transistor 3606 and the network of metal interconnects 5214, 5216, 5218 facilitate this sensing operation. The resulting electrical signal, which indicates one or more sensed properties of the substance, may be provided to circuitry formed in the semiconductor die 5202 for further processing, communication to other electronic devices, etc.

The process 5100 includes applying a fluid containing a functionalization material to the wafer near an opening to the fluid cavity (204). As FIG. 52 shows, a functionalization material 338 is applied to the external surface 5236 of the fluidic structure 5230. The functionalization material 338 (as well as FUTs) may be applied by any of a variety of techniques, such as the use of an applicator device. An application device may include a pen (e.g., a dropper) containing the functionalization material and having an open distal end through which the functionalization material may be expelled upon squeezing the pen. The application device may include a pen containing the functionalization material and having a brushed or sponged (e.g., felt-tip) distal end through which the functionalisation material may be expelled upon squeezing the pen or squeezing the brush or sponge, or any other suitable technique. In the event a brush or sponge is used, the brush or sponge may be less hydrophilic than the external surface 5236 to facilitate the successful wetting (i.e., the transfer of functionalization material from the brush or sponge to the external surface 5236) of the external surface 3362 with the functionalization material. Such pens may be held, controlled, and used to apply the functionalization material by robotic arms, for instance, although the pens may be manually operated by hand as well.

The process 5100 includes allowing the fluid to flow into the fluid cavity via the opening (206), such as by capillary action. The fluid may fully or partially fill the fluid cavity. The process 5100 includes solidifying the fluid to functionalize the fluid cavity 5232 (208), for example, by baking and/or storage at a certain (low or high) pressure, in a certain atmosphere, critical point drying, ultraviolet exposure, etc. FIG. 53 is identical to FIG. 52, except that the functionalization material 338 has entered the fluid cavity 3322 by way of the opening 3342. The functionalization material 338 has been solidified to form a membrane 5300 (which is also a functionalization material similar or identical to the functionalization material 338, but in a solidified form) in contact with the walls 402 of the fluid cavity 232.

The process 5101 includes causing another fluid (e.g., a FUT) to interact with the functionalized fluid cavity to generate a signal that may be sensed (210). For example, any of the pens described above may be useful to apply a FUT to the external surface 5236, causing the FUT to enter the fluid cavity 5232 by way of the opening 5234 (e.g., by capillary action). The FUT interacts with the membrane 5300 to produce a substance that is sensed by the sensor terminal 5224 to produce an electrical signal as described above (5112). Any and all types of interaction between the FUT and the membrane 5300 are contemplated and included in the scope of this disclosure, such as enzymatic reaction (which may cause, for example, a pH change, or H₂O₂ generation), redox reaction (e.g., where the measured signal is a current), measured charge due to covalent binding, potentiometric sensing via thermodynamic potentials across liquid-solid-boundary, capture of magnetic nanoparticles and subsequent magnetic field sensing, etc.

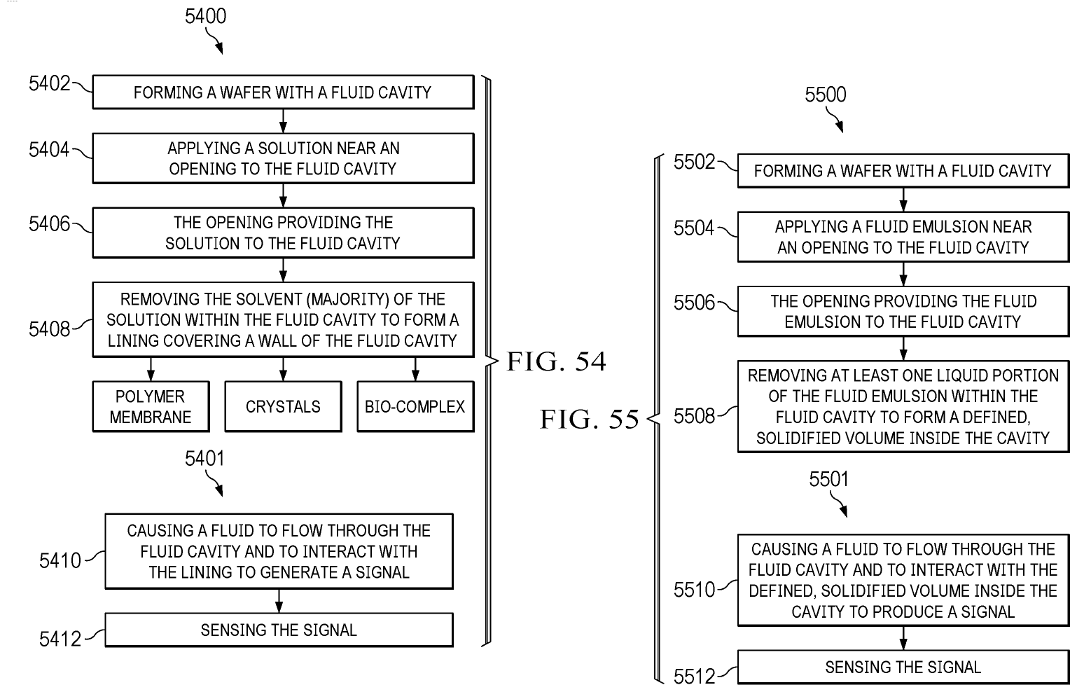

FIGS. 51-53 depict the formation of a membrane 5300 that fills at least part of the volume of the fluid cavity 5232. This membrane 5300 is a solid functionalization material which, upon interaction with a FUT, produces a signal due to a physical, biological, or chemical state change in the membrane, and/or locally in the FUT, with the signal being, e.g., a pH change, charge, or potential that can be sensed by the sensor terminal 5224. However, in some examples, other types of functionalization materials may be formed inside the fluid cavity 5232, such as crystals (e.g., salt crystals), a polymer lining, or a covalently bound bio-complex such as antibodies, single strand DNA, aptamers, etc., that coat the walls of the fluid cavity 5232 but do not fill most or all of the volume of the fluid cavity 5232. FIGS. 54-57 depict the formation of such functionalization materials that coat the walls of the fluid cavity 5232.

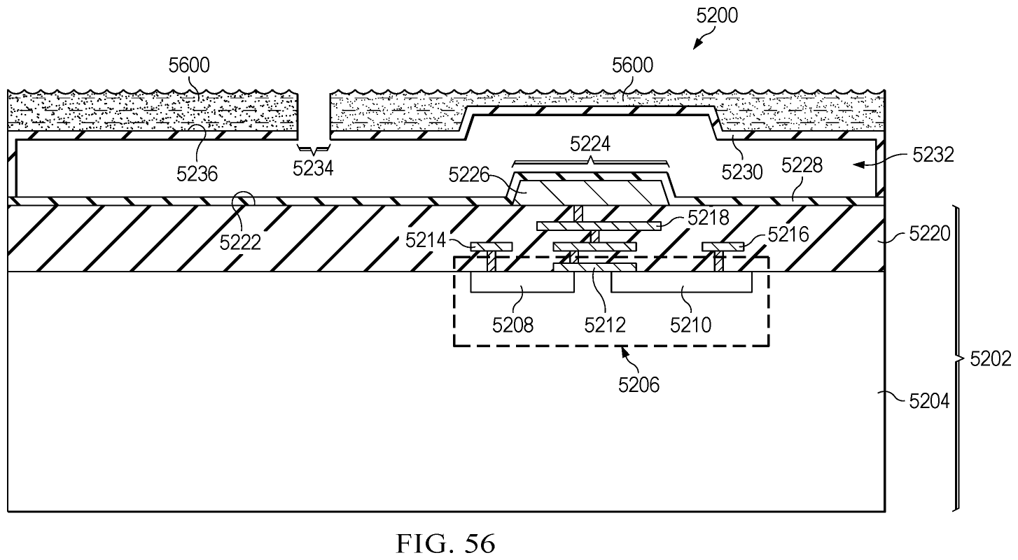

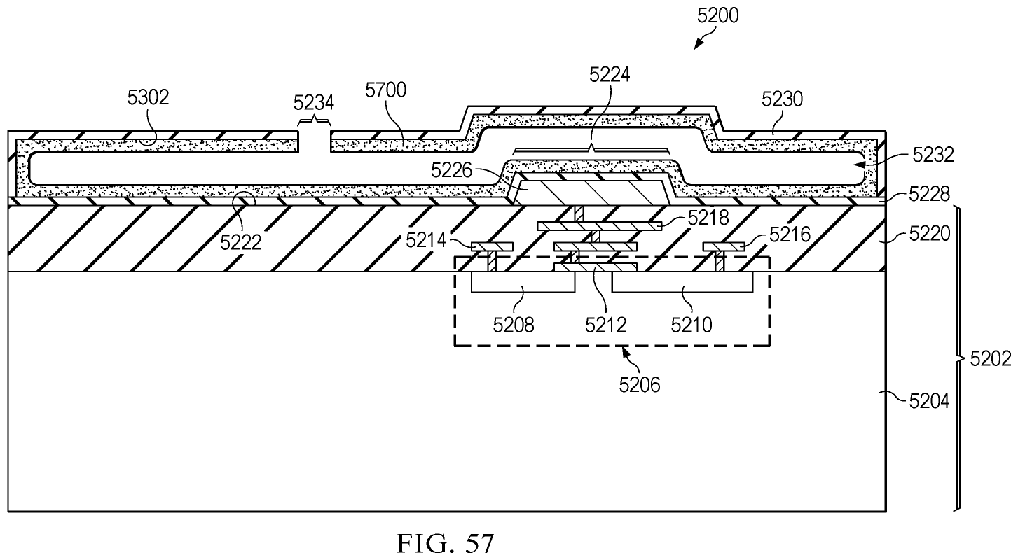

FIG. 54 and FIG. 55 are flow diagrams depicting example processes for fabricating a sensor device with a functionalized fluid cavity, and example processes for operating the sensor device. FIG. 56 is a cross-sectional diagram of an example sensor device having a fluid cavity that is being functionalized. FIG. 57 a cross-sectional diagram of another example sensor device having a functionalized fluid cavity. FIGS. 54-57 are now described in parallel.

FIG. 54 depicts processes 5400 and 5401. The process 5400 includes forming a semiconductor wafer having a fluid cavity (5402). This process is described above with reference to FIGS. 51 and 52, and thus is not repeated here. The process 5400 includes applying a solution containing a functionalization material (e.g., an electrolyte solution) near an opening to a fluid cavity (504). For example, the electrolyte solution may include water and salt. FIG. 56 is identical to FIG. 52, except that FIG. 56 depicts a solution 5400 applied to the external surface 5236. The opening 5234 provides the solution 5600 into the fluid cavity 5232 (5606), such as by capillary action. The process 5400 includes removal of a majority (or all) of the solvent from the solution within the fluid cavity to form a lining on the internal walls of the fluid cavity. For example, in a case where solution 5600 is an electrolyte solution including salt and water, the removal of the solvent (water) can include a dehydration operation. After the removal of the water, a lining of crystals (e.g., salt crystals) can be formed on the internal walls of the fluid cavity (5408). In some examples, the lining can include a polymer membrane or a bio-complex layer. The solvent removal operation may be performed by, for example, baking and/or storage at a certain (low or high) pressure, or in a certain atmosphere (gas), critical point drying, etc.

FIG. 57 depicts such a coating 5700 (i.e., a functionalized material) of crystals on walls of the fluid cavity 5232. The coating 5700 may encapsulate an empty region (e.g., a void full of air or another gas) or another functionalization material. The coating 5700 may be regular or irregular in thickness and distribution. The coating 7800 may cover all or only part of the walls of the fluid cavity 5232.

Referring back to FIG. 54, the process 501 includes causing a fluid (i.e., a FUT) to flow into the fluid cavity 5232 and to interact with the coating 7800 to generate a signal indicative of (or due to) a state change (e.g., a physical state change, a biological state change, or a chemical state change) in the functionalization material and/or in the fluid cavity (510). The FUT may be applied to the external surface 5236 as described above. Hydrophilic and/or hydrophobic surfaces may be useful to facilitate flow of the electrolyte solution and/or the FUT, as described above. The process 5401 includes sensing the signal to generate an electrical signal indicating such properties (512), such as by the sensor terminal 5224.

Referring to FIGS. 55-57, the process 5600 includes forming a semiconductor wafer having a fluid cavity (5502), as described above. The process 5500 includes applying a fluid emulsion, such as an emulsion of two immiscible liquids such as water and liquid polymer, or an emulsion of a fluid and a solid, near an opening to the fluid cavity (5504). In other examples, the fluid emulsion can include wax and oil, isopropyl alcohol (IPA) and silicone, water and metal nanoparticles (e.g., gold nanoparticles), etc.

FIG. 56 depicts such an emulsion 5600 applied to the external surface 5236. Although the numeral 500 refers to the electrolyte solution 5700 in the context of process 500, in the context of process 5500, the numeral 5600 refers to a fluid emulsion. The opening 5234 provides the fluid emulsion 5600 into the fluid cavity 5232 (5506). The process 5500 includes removing at least one liquid portion of the fluid emulsion with the fluid cavity to form a defined and solidified volume in the fluid cavity (e.g., a lining covering the internal walls of the fluid cavity, or a solid mass such as a bead that does not cover all of the internal walls of the fluid cavity). In one example, the removal of the liquid portion can include, for example, a dehydration operation described above to remove the water and baking the liquid polymer to form a solid polymer coating 800 covering internal walls of the fluid cavity 5232 (5508). In some examples, all parts of the fluid emulsion solidify, some are on the internal walls of the fluid cavity 5232, and some in one or more convex mass volumes as described above.

Although the numeral 5700 refers to the coating of crystals on the internal walls of the fluid cavity 5232 in context of the process 500, in the context of the process 5500, the numeral 800 can refer to the defined, solidified volume such as a solid polymer coating, a solid mass (e.g., a bead), etc., although in both instances, numeral 5700 refers to a functionalization material that functionalizes the fluid cavity 5232. The process 5601 includes causing a fluid (e.g., a FUT) to flow through the fluid cavity 5232 to interact with the defined, solidified volume (e.g., solid polymer coating 5700) to form a signal (5510) that can subsequently be sensed by the sensor terminal 5224 to produce an electrical signal indicating one or more properties of the substance.

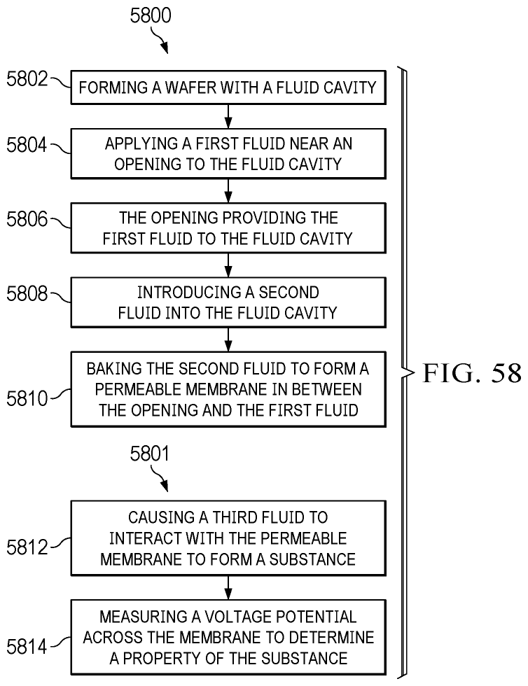

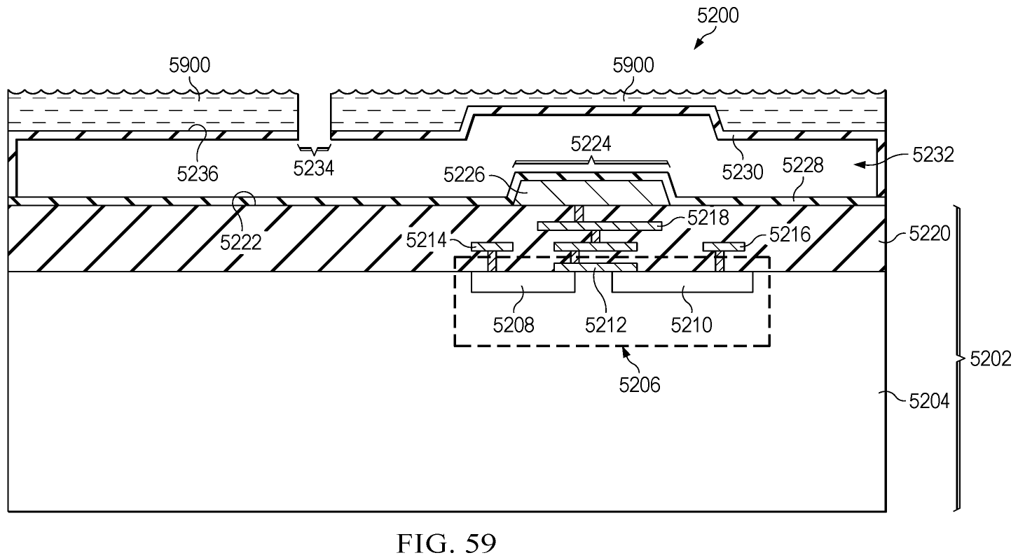

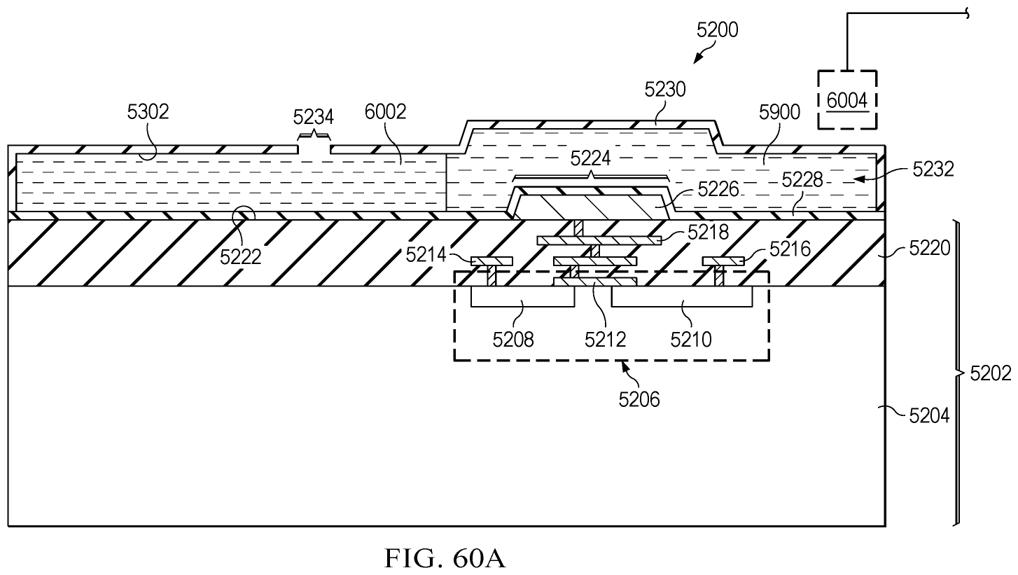

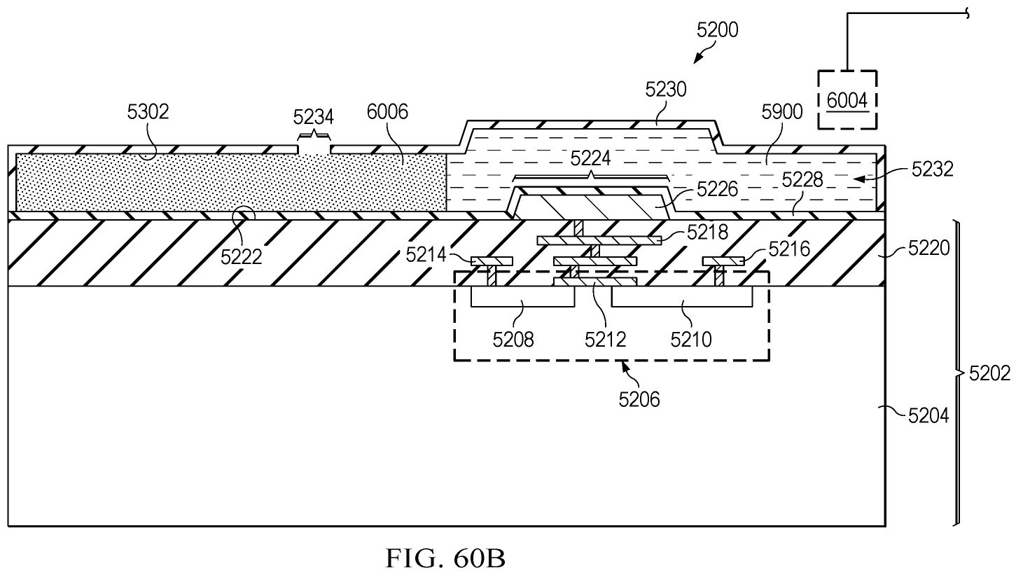

In some examples, a fluid cavity may contain multiple functionalization materials. FIG. 58 includes flow diagrams depicting an example process 5800 for fabricating a sensor device with a functionalized fluid cavity, and an example process 5801 for operating the sensor device. FIG. 59 is a cross-sectional diagram of an example sensor device having a fluid cavity that is being functionalized. FIGS. 60A-60B are cross-sectional diagrams of an example sensor device having a functionalized fluid cavity. Accordingly, FIGS. 58-60B are now described in parallel.

The process 5800 includes forming a semiconductor wafer having a fluid cavity (5802), as described above. The process 5800 includes applying a first fluid near an opening to the fluid cavity (904). FIG. 590 depicts the application of such a first fluid 5900 on the external surface 5236. The opening 5234 provides the first fluid 5900 into the fluid cavity 5232 (5806). The process 5800 includes introducing a second fluid into the fluid cavity 5232(5808). The second fluid 6002 may be provided to the fluid cavity 5232 in the same manner as the first fluid 5900, such as by applying the second fluid 6002 to the external surface 5236. In examples, the first fluid 5900 and the second fluid 6002 are immiscible, such that the introduction of the second fluid 6002 into the fluid cavity 5232 causes the first fluid 5900 to collect distal to the opening 5234. The sensor device 5200 may be oriented in specific directions (e.g., vertically) to facilitate separation of the first and second fluids 5900 and 6002 in a particular, desired manner within the fluid cavity 5232.

The process 900 includes baking the second fluid 6002 to form a permeable membrane (6006 in between the opening 5234 and the first fluid 5900 (5810). The process 5800 includes providing a third fluid (i.e., a FUT) into the fluid cavity 5232 such as by applying the third fluid to the external surface 5236. The third fluid enters the fluid cavity 5232 and interacts with the membrane 6006 to produce a substance (5812). The process 900 includes using the sensor terminal 5224 and a sensor terminal 5004 located outside of the fluid cavity 5232 to measure a voltage potential across the membrane 6006, which includes the substance formed by the interaction between the membrane 6006 and the FUT.

The voltage potential may indicate one or more properties of the substance. In examples, circuitry in the semiconductor die 5202 couples to and communicates with both the sensor terminals 5224 and 6004.

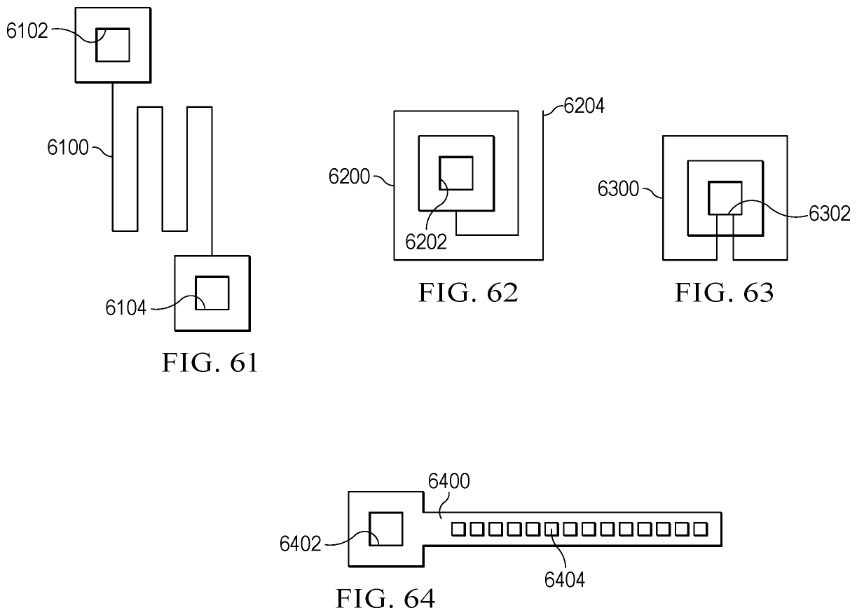

The fluid cavity 5232 may have various configurations. In examples, the fluid cavity 5232 has a length extending along the length of the sensor device 5200 and is at least partially covered by the fluidic structure 5230. However, in other examples, the fluid cavity 5232 has alternative configurations. FIGS. 61-64 depict various top view schematic diagrams of functionalized fluid cavities that may be included in example sensor devices 5200. For instance, FIG. 61 depicts a meander-shaped, elongated fluid cavity 6100, which can be in the form of a channel having multiple openings 6102 and 6104, each on an opposing end of the fluid cavity 6100. The width of the channel is not depicted in the figures but may reach from less than one micron up to 100 microns. Furthermore, the fluid cavity 6100 has a circuitous (i.e., non-linear) path between the openings 6102 and 6104. FIG. 62 depicts a fluid cavity 6200 that has an opening 6202 at one end and no opening elsewhere in the fluid cavity 6200. For example, a distal end 6204 of the fluid cavity 6200 does not have an opening. The fluid cavity 6200 has a spiral configuration. FIG. 63 shows a fluid cavity 6300 that originates and terminates at a common opening 6302. The fluid cavity 6300 has a looped structure. FIG. 64 depicts a fluid cavity 600 having an opening 6402 and smaller openings 6404. The purpose of these smaller openings is to provide a short diffusion length of the LOT towards the sensors which may be located underneath the smaller openings 604. The purpose of the large opening 602 is to receive the functionalization material in liquid state during manufacturing, where air may escape through the smaller openings 604. Various other fluid cavity architectures are contemplated and included in the scope of this disclosure.

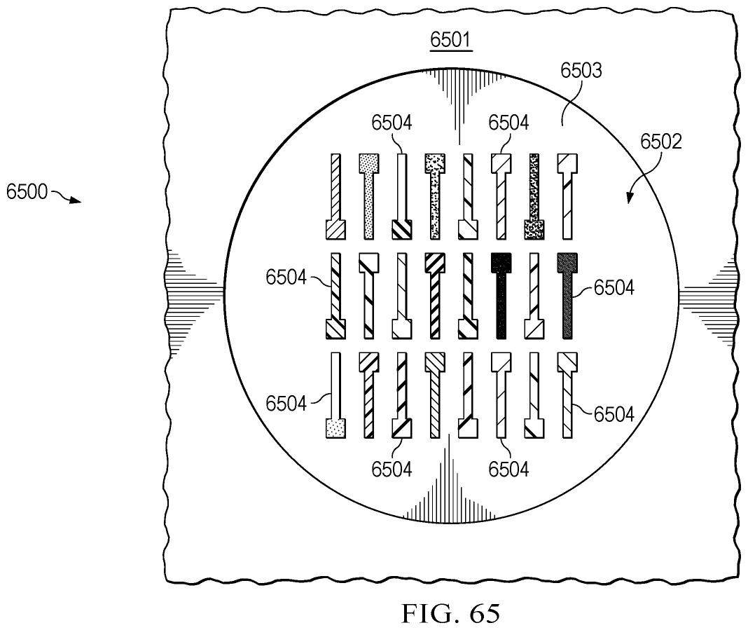

As described above, in some examples, sensor devices may include multiple fluid cavities, with each of the multiple fluid cavities having been functionalized in a different manner. For example, in a sensor device, a first fluid cavity may include a solid membrane, while a second fluid cavity may include walls coated with salt crystals. FIG. 65 is a top-down view of an example sensor device 6500 including a printed circuit board (PCB) 6501, a cavity 6502, a semiconductor die 6503, and multiple fluid cavities 6504 (e.g., 6504a, 6404b, and 6504c) formed in the semiconductor die 6503. A device side of the semiconductor die 6503 (i.e., a side in which circuitry is formed) faces the cavity 6502, and a non-device side of the semiconductor die 6503 faces away from the cavity 6502. The openings of the fluid cavities 6504 may be separated from each other by a minimum of 10 microns (typically more than 50 microns) in the horizontal plane, where the horizontal plane is parallel to the sensing side 5222. Each of the fluid cavities 6504 may have the properties of the other fluid cavities described herein. Each of the fluid cavities 6504 may be functionalized in a different manner.

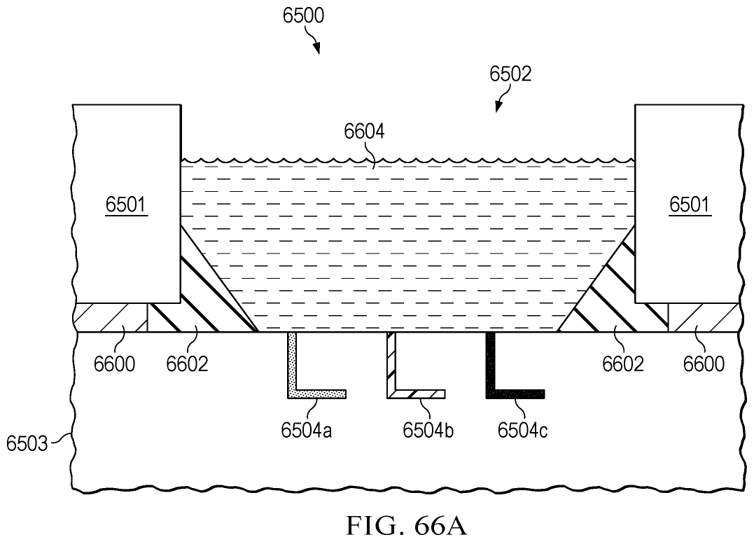

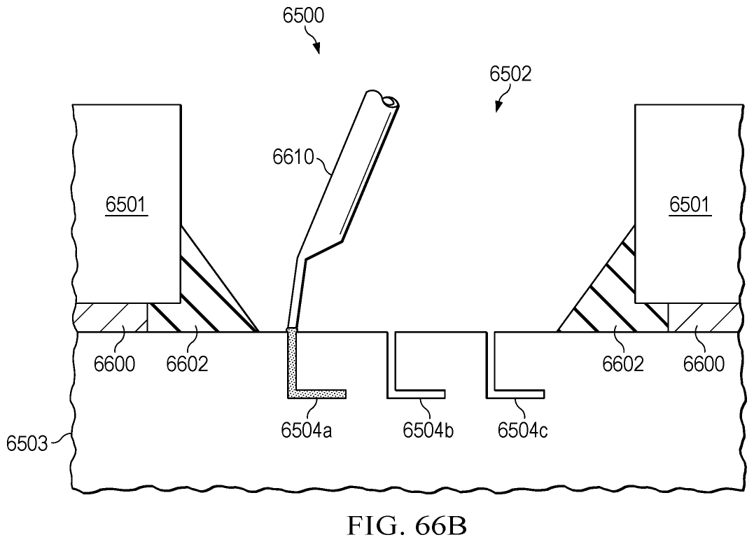

A FUT may be applied in the cavity 602, and the FUT may enter the different fluid cavities 6504. However, because each of fluid cavities 464 is functionalized in a different manner, a different signal representing a different state change in the respective functionalization material and/or fluid cavity will be produced (and subsequently sensed) in each fluid cavity 6504 when the FUT interacts with the functionalization material within that fluid cavity 6504, which can facilitate simultaneous performance of multiple (and different) tests/reactions involving the FUT while preventing/reducing cross-contamination. Such arrangements can accelerate the tests/reactions involving the FUT. FIG. 66A is a cross-sectional view of the example sensor device 6500 of FIG. 65. The PCB 6501 is coupled to the semiconductor die 6503 by way of a metal interconnect 6600, thereby establishing a communication pathway between the semiconductor die 6503 and the PCB 6501 (the PCB 6501 may further be coupled to other electronics that are not expressly shown here). A sealing apparatus 6602 (e.g., an epoxy guard ring) contacts the metal interconnect 6600 and protects the metal interconnect 6600 from a FUT 6604 in the cavity 6502. The FUT 6604 enters the fluid cavities 6504 as described above to interact with the functionalization materials stored in the fluid cavities 6404, thereby producing substances that can be sensed by the sensor terminals within the fluid cavities 6504. Circuitry within the semiconductor die 6503 receives signals generated by these sensor terminals and processes the signals as may be appropriate for a given application.

FIG. 66B illustrates an example technique of applying FUT 6604 into fluid cavities 6504. Referring to FIG. 66, the FUT 6604 can be applied directly into each of fluid cavities 6504a, 6504b, and 6504c by a felt tip pen 6610.

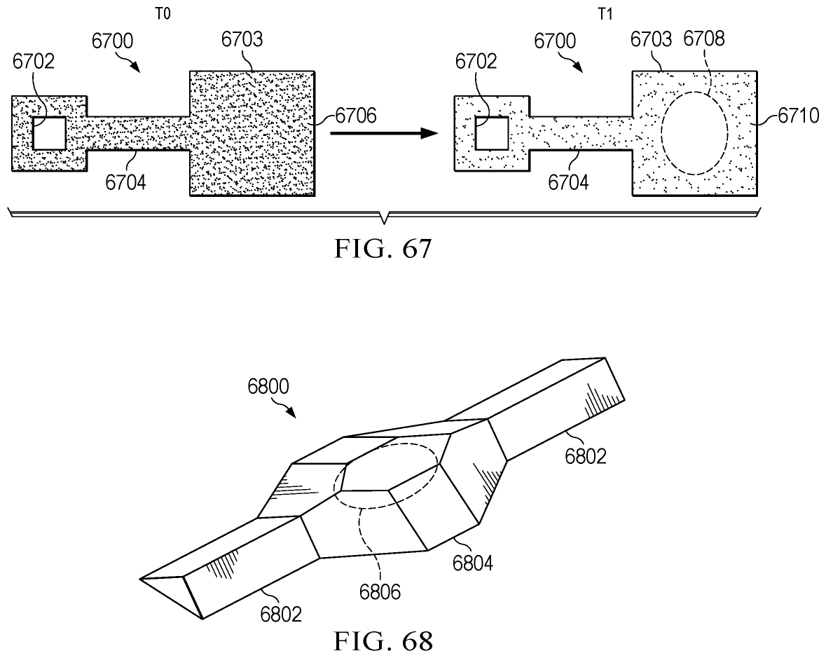

FIG. 67 includes schematic diagrams illustrating the functionalization of a cavity using a fluid emulsion, as described in process 600 of FIG. 6. Referring to FIG. 67, a fluid cavity 6700 terminates at an opening 6702 at one end and a chamber 6703 at the opposing end connected by a channel 6704. An emulsion 6706 is provided to the fluid cavity 6700 via the opening 6702 at time T0. The emulsion 6706 can include, for example, water-oil emulsion, wax and oil emulsion, IPA and silicone emulsion, pH buffer solutions, etc., where one material of the emulsion may have a greater affinity for the internal walls of the fluid cavity 6700 than the other material. At time TI, due to the difference in affinity, the materials of the emulsion separate and the material having lesser affinity can congregate in chamber 6703 as convex masses 6708, while the material having higher affinity, such as material 6710, can spread out in the fluid cavity 6700. The convex masses can be a functionalization material to react with a FUT, such as a liquid or a solid state material which is formed from an emulsion, for example oil, a pH buffer, or a polymer bead loaded with an enzyme or a DNA primer. In some example, the convex mass can include a buffer solution in a bubble. A sensor device including fluid cavity 6700 may include a heater proximate channel 6704 to heat up the emulsion and facilitate the flow of the emulsion into chamber 6703.

In some examples, the higher affinity material 6710 may thinly coat the walls of the fluid cavity 6700 and chamber 6703, with the material 6710 occupying the bulk of the volume of the fluid cavity 6700 and chamber 6703. The relationship between two or more materials sharing a fluid cavity may be determined based on various factors, such as the mixture ratio of the materials, the surface wettability of the materials relative to each other (e.g., if a fluid cavity has hydrophobic walls and contains a 10:1 emulsion of water to oil, the oil will cover the walls of the fluid cavity and will encapsulate the water), the viscosity of the materials, and the density of the materials.

The formation of encapsulated functionalization materials may be facilitated by specific geometric shapes of the fluid cavity in which the functionalization materials are deposited. FIG. 68 is a perspective view of an example functionalized fluid cavity 6800 having a specific geometric shape to facilitate the formation of an encapsulated, functionalization material. The fluid cavity 6800 has a triangular cross-section, as numerals 6802 and 6804 indicate. Consequently, in an emulsion with multiple functionalization materials, the least dense functionalization material will rise to the top of the fluid cavity 6800, forming a bubble 6806 comprising that functionalization material. Bubble 6806 can be an example of a pump or a flow control device to control flow of fluid in the fluid cavity 6800. In another instance, bubble 6806 may be liquid or solid state material which formed from an emulsion, such as oil, a pH buffer, or a polymer bead loaded with an enzyme or a DNA primer. In some examples, bubble 6806 can correspond to convex mass 6708 of FIG. 67.

In some examples, a method of fabricating an integrated circuit fluid sensor is provided. The method comprises forming a semiconductor die, in which the semiconductor die includes a semiconductor substrate, a dielectric layer on the semiconductor substrate, a metallization structure encapsulated in the dielectric layer, a sensor terminal including an electrode on a sensing side of the dielectric laver facing away from the semiconductor substrate, and an insulation layer covering the dielectric layer and the electrode, the semiconductor substrate includes sensor circuitry, the sensor circuitry includes a transistor having first and second current terminals and a channel region between the second current terminals, and the sensor terminal is on the sensing side and over the channel region. The method further comprises forming a fluidic structure on the insulation layer, in which the fluidic structure encloses a fluid cavity over the sensor terminal; and forming an opening through the fluidic structure and extending to the fluid cavity.

In some examples, the transistor includes a gate terminal separated from the channel region by the dielectric layer, and the gate terminal is coupled to the sensor terminal via the metallization structure.

In some examples, the insulation layer is a first insulation layer, and forming the fluidic structure includes: forming a sacrificial layer on the first insulation layer; patterning the sacrificial layer, and forming a second insulation layer on the patterned sacrificial layer as the fluidic structure.

In some examples, forming an opening through the fluidic structure comprises: forming the opening through the second insulation layer to expose art of the patterned sacrificial layer; providing reagent through the opening; and etching away the sacrificial layer using the reagent.

In some examples, the sacrificial laver includes a Tungsten-Titanium (TiW) alloy.

In some examples the insulation layer is a first insulation layer, the semiconductor die is a first semiconductor die, the semiconductor substrate is a first semiconductor substrate, and forming the fluidic structure includes: forming a second insulation layer on a first side of second semiconductor substrate of a second semiconductor die; patterning the second insulation layer to form an indented surface; orienting the second semiconductor die with respect to the first semiconductor die so that the indented surface faces the sensing side; and mounting the second insulation laer onto the first semiconductor die with the indented surface facing the sensing side, in which the second insulation layer forms the fluidic structure.

In some examples, forming an opening through the fluidic structure comprises: forming the opening from a second side of the second semiconductor die opposite to the first side through the second semiconductor substrate and the second insulation layer. And the method further comprises removing the second semiconductor substrate from the second insulation layer.

This description, the term “couple” may cover connections, communications, or signal paths that enable a functional relationship consistent with this description. For example, if device A generates a signal to control device B to perform an action; (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

A device that is “configured to” perform a task or function may be configured (e.g., programmed and/or hardwired) at a time of manufacturing by a manufacturer to perform the function and/or may be configurable (or reconfigurable) by a user after manufacturing to perform the function and/or other additional or alternative functions. The configuring may be through firmware and/or software programming of the device, through a construction and/or layout of hardware components and interconnections of the device, or a combination thereof.

In this description, unless otherwise stated, “about,” “approximately” or “substantially” preceding a parameter means being within +/−10 percent of that parameter. Modifications are possible in the described examples, and other examples are possible within the scope of the claims.

What is claimed is:

1. An integrated circuit (IC) device, comprising:
a semiconductor die including a semiconductor substrate, a dielectric layer on the semiconductor substrate, and a metallization structure in the dielectric layer, in which the semiconductor substrate includes sensor circuitry coupled to the metallization structure, the dielectric layer having a sensing side facing away from the semiconductor substrate;
an insulation layer on the sensing side;
a sensor terminal on the sensing side and coupled to the metallization structure; and
a restriction structure including an opening, in which the restriction structure encapsulates a fluid cavity on the sensing side, the sensor terminal is in the fluid cavity,
wherein the fluid cavity contains a finctionalization material, configured to interact with a fluid in the fluid cavity to produce a signal detectable by the sensor circuitry via the sensor terminal.

2. The IC device of claim 1, wherein the functionalization material comprises a permeable membrane.

3. The IC device of claim 1, wherein the functionalization material comprises crystals.

4. The IC device of claim 3, wherein the crystals include salt crystals.

5. The IC device of claim 1, wherein the functionalization material coats a wall of the fluid cavity such that the functionalization material encapsulates a void.

6. The IC device of claim 5, wherein the functionalization material is a first functionalization material, and the IC device includes a second functionalization material in the void.

7. The IC device of claim 1, wherein the functionalization material fills a first portion of the fluid cavity and another material is present in a second portion of the fluid cavity, the functionalization material exposed to the another material.

8. The IC device of claim 1, wherein the signal represents one of: a biological state change in at least one of the functionalization material or the fluid cavity, or a chemical state change in at least one of the functionalization material or the fluid cavity.

9. The IC device of claim 1, wherein a wall of the fluid cavity is hydrophilic.

10. The IC device of claim 1, wherein an external surface of the restriction structure is hydrophobic.

11. A method for manufacturing an integrated circuit (IC) device, comprising:
providing an IC device comprising:
a semiconductor die including a semiconductor substrate, a dielectric layer on the semiconductor substrate, and a metallization structure in the dielectric layer, in which the semiconductor substrate includes sensor circuitry coupled to the metallization structure, the dielectric layer having a sensing side facing away from the semiconductor substrate;
an insulation layer on the sensing side;
a sensor terminal on the sensing side and coupled to the metallization structure; and
a restriction structure including an opening, in which the restriction structure encapsulates a fluid cavity on the sensing side, and the sensor terminal is in the fluid cavity; and
forming a functionalization material in the fluid cavity, the functionalisation material configured to interact with a fluid in the fluid cavity to produce a signal detectable by the sensor terminal.

12. The method of claim 11, wherein the functionalization material is a permeable membrane.

13. The method of claim 11, wherein applying the functionalization material comprises:
applying a fluid to the fluid cavity; and
processing the fluid to produce the functionalization material.

14. The method of claim 13, wherein the fluid is an emulsion, and the processing includes evaporating a component of the emulsion.

15. The method of claim 14, wherein the functionalization material coats a surface of the fluid cavity.

16. The method of claim 13, wherein the processing includes baking the fluid.

17. An integrated circuit (IC) device, comprising:
a semiconductor die including a semiconductor substrate, a dielectric layer on the semiconductor substrate, and first and second metallization structures in the dielectric layer, in which the semiconductor substrate includes sensor circuitry coupled to the first and second metallization structures, the dielectric layer having a sensing side facing away from the semiconductor substrate;
first and second sensor terminals on the sensing side and coupled to the first and second metallization structures, respectively; and
a restriction structure including first and second openings, in which the restriction structure encapsulates first and second fluid cavities on the sensing side, respectively, the first and second sensor terminals are in the first and second fluid cavities, respectively, and the restriction structure is configured to allow a fluid to enter the first and second fluid cavities and reach the first and second sensor terminals through the first and second openings, respectively,
wherein the first fluid cavity contains a first functionalization material and the second fluid cavity contains a second functionalization material different from the first functionalization material, the first and second functionalization materials configured to interact with the fluid to produce first and second signals, respectively, the sensor circuitry configured to sense the first and second signals via the first and second sensor terminals, respectively.

18. The IC device of claim 17, wherein the first functionalization material includes at least one of: a solid, permeable membrane, or crystals.

19. The IC device of claim 17, wherein the first and second openings are separated by at least 10 microns in a horizontal plane, wherein the horizontal plane is parallel with the sensing side of the dielectric layer.

20. The IC device of claim 19, wherein the first sensor terminal comprises one of: a noble metal electrode, or a photosensitive element.

21. An integrated circuit, comprising:
a semiconductor die including a semiconductor substrate, a dielectric layer on the semiconductor substrate, and a metallization structure encapsulated in the dielectric layer, in which the semiconductor substrate includes sensor circuitry, the sensor circuitry includes a transistor having a first current terminal, a second current terminal, and a channel region between the first and second current terminals, and the dielectric layer has a sensing side facing away from the semiconductor substrate;
an insulation layer on the sensing side;
a sensor terminal on the sensing side and over the channel region;
a restriction structure including an opening which the restriction structure encapsulates a fluid cavity on the sensing side, the sensor terminal is in the fluid cavity, and the restriction structure is configured to allow a fluid to enter the fluid cavity and reach the sensor terminal through the opening by microfluidic diffusion; and
a controllable flow control device in the fluid cavity, in which the controllable flow control device is configured to control a movement of the fluid in the fluid cavity responsive to a signal.

22. The integrated circuit of claim 21, wherein:
the sensor terminal is a first sensor terminal;
the transistor is a first transistor,
the channel region is a first channel region;
the semiconductor die further includes a second transistor having a second channel region and a second sensor terminal on the sensing side over the second channel region; and
the second sensor terminal is either external to restriction structure, or in the fluid cavity and between the opening and the second sensor terminal.

23. The integrated circuit of claim 22, wherein the controllable flow control device includes a valve.

24. The integrated circuit of claim 23, wherein the valve is constructed as a bubble chamber, the bubble chamber having recessed internal surfaces configured to trap a bubble.

25. The integrated circuit of claim 23, wherein the valve is directly below the opening and the second sensor terminal, or between the first and second sensor terminals.

26. The integrated circuit of claim 23, wherein the valve includes a set of control terminals configured to block or unblock transportation of the fluid from the opening to at least one of the first or second sensor terminals.

27. The integrated circuit of claim 21, wherein the opening is a first opening through the restriction structure, and the restriction structure includes a second opening.

28. The integrated circuit of claim 27, wherein the fluid cavity includes a set of bubble chambers each having recessed internal surfaces configured to trap a bubble;
wherein the integrated circuit further includes a heater circuit in the dielectric layer below each respective bubble chamber, and
wherein the heater circuits and the set of bubble chambers provide a pump to transport the fluid in the fluid cavity by convection.

29. The integrated circuit of claim 28, further comprising a Tesla valve at one end of the set of bubble chambers, and the Tesla valve is part of the pump.

30. The integrated circuit of claim 27, further comprising a first voltage terminal and a second voltage terminal on the sensing side, a first voltage source coupled to the first voltage terminal via the metallization structure, and a second voltage source coupled to the second voltage terminal via the metallization structure; and
wherein each of the first and second voltage terminals include a respective metal surface at least partially covered by the insulation layer.

31. The integrated circuit of claim 30, wherein the second opening includes an osmotic structure.

32. The integrated circuit of claim 31, wherein the first voltage terminal is in the fluid cavity and proximate the second opening, the first and second voltage sources are DC voltage sources, and the first and second voltage terminals and the osmotic structure provide a DC electroosmotic pump.

33. The integrated circuit of claim 31, wherein the second voltage terminal is external to the fluid cavity.

34. The integrated circuit of claim 27, further comprising:
multiple sets of control terminals in the fluid cavity; and
a set of AC voltage sources, each AC voltage source coupled to a respective control terminal within each set of the multiple sets of control terminals,
wherein the set of AC voltage sources are configured to provide AC voltage signals having different phases.

35. The integrated circuit of claim 30, further comprising an AC voltage source coupled to the first voltage terminal, and the second voltage terminal is configured to measure an AC response.

36. The integrated circuit of claim 35, further comprising an ammeter coupled between the first and second voltage terminals.

37. The integrated circuit of claim 22, wherein the second sensor terminal is less than 250 micrometers (um) from the opening if in the fluid cavity and is less than 0.5 mm from the opening if external to the fluid cavity, and the first sensor terminal is more than 1 mm from the opening.

38. The integrated circuit of claim 21, wherein:
the fluid cavity includes a nanofluidic channel;
the semiconductor die further includes a second transistor having a second channel region and a second sensor terminal on the sensing side over the second channel region; and
the second sensor terminal in the nanofluidic channel.

39. The integrated circuit of claim 22, wherein:
the fluid cavity includes a nanofluidic channel;
the semiconductor die further includes a third transistor having a third channel region and a third sensor terminal on the sensing side over the third channel region; and
the third sensor terminal in the nanofluidic channel.

40. The integrated circuit of claim 21, wherein:
the fluid cavity is a first fluid cavity, the sensor terminal is a first sensor terminal, the transistor is a first transistor, the channel region is a first channel region; and
the restriction structure encapsulates a second fluid cavity and a connection structure coupled between the first and second fluid cavities on the sensing side;
the second fluid cavity includes a buffer solution having a known pH;
the semiconductor die further includes a second transistor having a second channel region; and
the integrated circuit further comprises a second sensor terminal over the second channel region in the second fluid cavity.

41. The integrated circuit of claim 40, wherein the first sensor terminal proximate a junction between the connection structure and the fluid cavity.

42. The integrated circuit of claim 40, wherein:
the connection structure is a first connection structure;
the restriction structure encapsulates a third fluid cavity and a second connection structure coupled between the first and third fluid cavities on the sensing side;
the third fluid cavity includes the buffer solution;
the semiconductor die further includes a third transistor having a third channel region; and
the integrated circuit further comprises a third sensor terminal over the third channel region in the third fluid cavity.

43. The integrated circuit of claim 42, wherein:
the opening is a first opening;
the second connection structure includes a second opening and a third opening; and
the integrated circuit further includes a pump coupled to the second and third openings, the pump configured to transport the buffer solution into the second connection structure through the second opening and to transport the fluid out of the second connection structure and the first fluid cavity through the third opening.

44. The integrated circuit of claim 43, wherein the pump is a first pump, the second connection structure includes a fourth opening and a fifth opening, and the integrated circuit further includes a second pump coupled to the fourth and fifth openings.

45. The integrated circuit of claim 42, wherein the second connection structure includes a valve coupled between the third fluid cavity and the first fluid cavity.

46. The integrated circuit of claim 45, wherein the valve is a first valve, and the first connection structure includes a second valve coupled between the second fluid cavity and the first fluid cavity.

47. The integrated circuit of claim 40, wherein the connection structure includes a valve.

48. The integrated circuit of claim 47, wherein the restriction structure further encapsulates a second fluid cavity coupled to the connection structure on the sensing side, and the second fluid cavity includes a salt crystal of the buffer solution.

49. The integrated circuit of claim 48, further comprising a pump coupled the second fluid cavity.

50. The integrated circuit of claim 40, wherein:
the fluid cavity includes a nanofluidic channel;
the semiconductor die further includes a third transistor having a third channel region and a third sensor terminal on the sensing side over the third channel region; and
the third sensor terminal in the nanofluidic channel.

51. The integrated circuit of claim 21, further comprising a particle filter in the fluid cavity between the opening and the sensor terminal.

52. The integrated circuit of claim 51, wherein the particle filter includes a restricted portion of the fluid cavity.

53. The integrated circuit of claim 51, wherein the particle filter includes a field effect terminal.

54. The integrate circuit of claim 51, wherein the particle filter includes a restricted portion of the fluid cavity and a field effect terminal in the restricted portion.

55. The integrate circuit of claim 51, wherein the particle filter is configured as part of a nanofluidic diode.

56. The integrate circuit of claim 27, wherein the sensor terminal is a first sensor terminal, the transistor is a first transistor, the channel region is a first channel region;
wherein the semiconductor die further includes multiple transistors having respective channel regions;
wherein the integrated circuit further comprises multiple sensor terminals over the respective channel regions in the fluid cavity, the multiple sensor terminals arranged along a first axis orthogonal to a second axis between the first and second openings; and
wherein a height of the fluid cavity decreases along the first axis.

57. The integrated circuit of claim 21, wherein:
the fluid cavity has a ring footprint;
the restriction structure includes first inlets and first outlets for a first fluid, second inlets and second outlets for a second fluid, and third inlets and third outlets for a third fluid,
the integrated circuit includes a first group of sensor terminals positioned along a first portion of the ring footprint between the first and third inlets, a second group of sensor terminals positioned along a second portion of the ring footprint between the first and second outlets, a third group of sensor terminals positioned along a third portion of the ring footprint between the second inlet and third outlet, and a fourth group of sensor terminals positioned along a fourth portion of the ring footprint between the third inlet and the third outlet; and
a valve in the fourth portion of the ring footprint to control a flow of the third fluid between the third inlet and the third outlet.

58. The integrated circuit of claim 21, wherein the restriction structure includes at least one of Silicon Oxide, Silicon Nitride, SU-8, Polyimide, Parylene, Aluminum Oxide, Tantalum Pentoxide, Hafnium Oxide, Zirconium Dioxide, Yttrium Oxide, Zinc Oxide, Tin Oxide, Manganese Dioxide, or Gallium Oxide.

59. The integrated circuit of claim 21, wherein the insulation layer includes at least one of:
silicon oxide, silicon nitride, aluminum oxide, tantalum pentoxide, hafnium oxide, zirconium dioxide, yttrium oxide, zinc oxide, tin oxide, manganese dioxide, or gallium oxide.

60. The integrated circuit of claim 21, wherein the transistor includes an open gate ion-sensitive field effect transistor (ISFET) or an extended gate ISFET.

61. The integrated circuit of claim 21, wherein the fluid cavity includes a functionalized fluidic cavity, and the controllable flow control device is in the functionalized fluid cavity.
